(19) United States
(12) Patent Application Publication
(10) Pub. No.: US 2026/0242282 A1
(43) Pub. Date: Aug. 20, 2026

(54) USE OF RECYCLED AGGREGATES IN A METHOD OF MAKING COMPOSITIONS TO PROMOTE MARINE-LIFE

(71) Applicant: Partanna Global, Inc., Rancho Sante Fee, CA (US)

(72) Inventor: Kevin Pang, Fuzhou City (CN)

(21) Appl. No.: 19/187,165

(22) Filed: Apr. 23, 2025

(30) Foreign Application Priority Data
Apr. 23, 2024 (WO) PCT/CN2024/089385
Apr. 7, 2025 (WO) PCT/CN2025/087614

(51) Int. Cl. C04B 18/167; A01G 24/10; C04B 7/12; C04B 7/14; C04B 7/26; C04B 9/06; C04B 20/00; C04B 22/00; C04B 28/02; C04B 28/08; C04B 28/10; C04B 103/10; C04B 111/00; C04B 111/10; C04B 111/74

(52) U.S. Cl. CPC C04B 18/167; A01G 24/10; C04B 7/12; C04B 7/14; C04B 7/26; C04B 9/06; C04B 20/0076; C04B 22/0033; C04B 28/021; C04B 28/08; C04B 28/10; C04B 2103/10; C04B 2111/00019; C04B 2111/10; C04B 2111/74

(57) ABSTRACT

The present disclosure relates to methods that transform high salinity brine into a non-toxic, CO₂-absorbing cementitious aggregate composition and a lower salinity water component which can each be recycled to the desalination facility, processed to produce fresh water, and/or added to a body of water without harming the local flora and fauna. The present disclosure provides methods comprising steps of: (a) combining (i) a high salinity brine, (ii) CO₂, and (iii) a natural pozzolan, man-made pozzolan, latently hydraulic material, and/or recycled aggregate or carbonated recycled aggregate; and (b) permitting the combination of step (a) to persist under conditions sufficient to transform the combination into a cementitious aggregate composition and reduced salinity water. An activator, which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO, can be added to the combination.

### CROSS-REFERENCE

This application claims priority to PCT/CN2024/089385, filed Apr. 23, 2024, and to PCT/CN2025/087614, filed Apr. 7, 2025. The contents of each of which is incorporated herein by reference in its entirety.

### BACKGROUND

Rapid urbanization and industrial expansion have spurred concrete production and demolition, culminating in the accumulation of construction and demolition waste (CDW). Simultaneously, there has been a substantial surge in the demand for natural aggregates (NA), prompting the exploitation of these resources and causing notable environmental disturbances. Consequently, the need for alternative construction materials has become increasingly pressing.

### BRIEF SUMMARY

The present disclosure demonstrates the influence of incorporating untreated/CO₂-pretreated recycled aggregate in reactive magnesia concrete (RMC) formulations. Through comprehensive microscopic characterizations, the phase composition, carbonation degree, pore structure, and interfacial transition zone (ITZ) characteristics were examined in both interior and exterior regions of specimens. The findings highlight that the use of recycled aggregate (RA) or carbonated recycled aggregate (CRA) contributes to greater strength in RMC formulations. This enhancement is attributed to internal curing and significantly increased channels for CO₂ diffusion within RA or CRA specimens, leading to improvements in the modulus, hardness, and microstructures of the interior region—the traditionally weaker part in RMC-based concrete. Furthermore, a robust linear correlation was observed between ITZ characteristics, porosity, and compressive strength of CO₂-cured specimens. Lastly, utilizing different grades of RA improves the performance of RMC-based concrete to varying degrees while reducing costs, thus potentially expanding the application of RA in practical RMC-based concrete scenarios, regardless of RA quality.

The present disclosure relates to methods that transform high salinity brine into a non-toxic, CO₂-absorbing aggregate cementitious composition and a lower salinity water component which can be recycled through the desalination plant, to create additional drinking water, or added to a body of water and without harming the local flora and fauna.

An aspect of the present disclosure is a method comprising steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and, optionally, an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO) and (b) permitting the combination obtained in step (a) to persist under conditions sufficient to transform the combination into a cementitious aggregate composition and a reduced salinity water component.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

A further aspect of the present disclosure is a method for providing substrate for aquatic flora and/or fauna attachment, the method comprising depositing a herein-disclosed cementitious aggregate composition into a natural or artificial body of water which comprises aquatic flora and/or fauna in need of an attachment.

Another aspect of the present disclosure is a cementitious aggregate composition obtained by any herein-disclosed method. The cementitious aggregate composition be used in any way that another cementitious aggregates can be used.

An additional aspect of the present disclosure is a shaped cementitious composition obtained by any herein-disclosed method. The shaped cementitious aggregate composition be used in any way that any cement can be used.

In an aspect, the present disclosure provides a method for providing substrate for aquatic flora and/or fauna attachment, the method comprising depositing any herein-disclosed shaped cementitious composition into a natural or artificial body of water which comprises aquatic flora and/or fauna in need of an attachment.

In embodiments, the combination obtained in step (a) is selected from:
A. (1) brine, (2) CO₂, and (3) a recycled aggregate (RA);
B. (1) brine, (2) CO₂, (3) a recycled aggregate (RA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
C. (1) brine, (2) CO₂, and (3) a carbonated recycled aggregate (CRA);
D. (1) brine, (2) CO₂, (3) carbonated recycled aggregate (CRA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
E. (1) brine, (2) CO₂, and (3) a natural pozzolan;
F. (1) brine, (2) CO₂, (3) a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
G. (1) brine, (2) CO₂, and (3) a man-made pozzolan;
H. (1) brine, (2) CO₂, (3) a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
I. (1) brine, (2) CO₂, and (3) a latently hydraulic material;
J. (1) brine, (2) CO₂, (3) a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
K. (1) brine, (2) CO₂, and (3) a recycled aggregate (RA) and a carbonated recycled aggregate (CRA);
L. (1) brine, (2) CO₂, (3) a recycled aggregate (RA) and carbonated recycled aggregate (CRA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
M. (1) brine, (2) CO₂, and (3) a recycled aggregate (RA) and a natural pozzolan;
N. (1) brine, (2) CO₂, (3) a recycled aggregate (RA) and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
O. (1) brine, (2) CO₂, and (3) a recycled aggregate (RA) and a man-made pozzolan;
P. (1) brine, (2) CO₂, (3) a recycled aggregate (RA) and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
Q. (1) brine, (2) CO₂, and (3) a recycled aggregate (RA) and a latently hydraulic material;
R. (1) brine, (2) CO₂, (3) a recycled aggregate (RA) and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
S. (1) brine, (2) CO₂, and (3) a recycled aggregate (RA), a natural pozzolan, and a man-made pozzolan;
T. (1) brine, (2) CO₂, (3) a recycled aggregate (RA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
U. (1) brine, (2) CO₂, and (3) a recycled aggregate (RA), a natural pozzolan, and a latently hydraulic material;
V. (1) brine, (2) CO₂, (3) a recycled aggregate (RA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
W. (1) brine, (2) CO₂, and (3) a recycled aggregate (RA), a man-made pozzolan, and a latently hydraulic material;
X. (1) brine, (2) CO₂, (3) a recycled aggregate (RA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
Y. (1) brine, (2) CO₂, and (3) a recycled aggregate (RA), a natural pozzolan, a man-made pozzolan, and a latently hydraulic material;
Z. (1) brine, (2) CO₂, (3) a recycled aggregate (RA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).
AA. (1) brine, (2) CO₂, and (3) a carbonated recycled aggregate (CRA) and a natural pozzolan;
BB. (1) brine, (2) CO₂, (3) a carbonated recycled aggregate (CRA) and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
CC. (1) brine, (2) CO₂, and (3) a carbonated recycled aggregate (CRA) and a man-made pozzolan;
DD. (1) brine, (2) CO₂, (3) a carbonated recycled aggregate (CRA) and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
EE. (1) brine, (2) CO₂, and (3) a carbonated recycled aggregate (CRA) and a latently hydraulic material;
FF. (1) brine, (2) CO₂, (3) a carbonated recycled aggregate (CRA) and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
GG. (1) brine, (2) CO₂, and (3) a carbonated recycled aggregate (CRA), a natural pozzolan, and a man-made pozzolan;
HH. (1) brine, (2) CO₂, (3) a carbonated recycled aggregate (CRA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
II. (1) brine, (2) CO₂, and (3) a carbonated recycled aggregate (CRA), a natural pozzolan, and a latently hydraulic material;
JJ. (1) brine, (2) CO₂, (3) a carbonated recycled aggregate (CRA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
KK. (1) brine, (2) CO₂, and (3) a carbonated recycled aggregate (CRA), a man-made pozzolan, and a latently hydraulic material;
LL. (1) brine, (2) CO₂, (3) a carbonated recycled aggregate (CRA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
MM. (1) brine, (2) CO₂, and (3) a carbonated recycled aggregate (CRA), a natural pozzolan, a man-made pozzolan, and a latently hydraulic material;
NN. (1) brine, (2) CO₂, (3) a carbonated recycled aggregate (CRA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).
OO. (1) brine, (2) CO₂, and (3) a recycled aggregate (RA), a carbonated recycled aggregate (CRA), and a natural pozzolan;
PP. (1) brine, (2) CO₂, (3) a recycled aggregate (RA), a carbonated recycled aggregate (CRA), and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
QQ. (1) brine, (2) CO₂, and (3) a recycled aggregate (RA), a carbonated recycled aggregate (CRA), and a man-made pozzolan;
RR. (1) brine, (2) CO₂, (3) a recycled aggregate (RA), a carbonated recycled aggregate (CRA), and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
SS. (1) brine, (2) CO₂, and (3) a recycled aggregate (RA), a carbonated recycled aggregate (CRA), and a latently hydraulic material;
TT. (1) brine, (2) CO₂, (3) a recycled aggregate (RA), a carbonated recycled aggregate (CRA), and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
UU. (1) brine, (2) CO₂, and (3) a recycled aggregate (RA), a carbonated recycled aggregate (CRA), a natural pozzolan, and a man-made pozzolan;
VV. (1) brine, (2) CO₂, (3) a recycled aggregate (RA), a carbonated recycled aggregate (CRA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
WW. (1) brine, (2) CO₂, and (3) a recycled aggregate (RA), a carbonated recycled aggregate (CRA), a natural pozzolan, and a latently hydraulic material;
XX. (1) brine, (2) CO₂, (3) a recycled aggregate (RA), a carbonated recycled aggregate (CRA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
YY. (1) brine, (2) CO₂, and (3) a recycled aggregate (RA), a carbonated recycled aggregate (CRA), a man-made pozzolan, and a latently hydraulic material;
ZZ. (1) brine, (2) CO₂, (3) a recycled aggregate (RA), a carbonated recycled aggregate (CRA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
AAA. (1) brine, (2) CO₂, and (3) a recycled aggregate (RA), a carbonated recycled aggregate (CRA), a natural pozzolan, a man-made pozzolan, and a latently hydraulic material; and
BBB. (1) brine, (2) CO₂, (3) a recycled aggregate (RA), a carbonated recycled aggregate (CRA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).

In some embodiments, the cementitious aggregate composition comprises the recycled aggregate (RA) and/or the carbonated recycled aggregate (CRA).

In various embodiments, the cementitious aggregate composition comprises the recycled aggregate (RA), the cementitious aggregate composition comprises the carbonated recycled aggregate (CRA), or the cementitious aggregate composition comprises the recycled aggregate (RA) and the carbonated recycled aggregate (CRA).

In numerous embodiments, a cementitious aggregate composition comprises a recycled aggregate (RA) and/or a carbonated recycled aggregate (CRA) has lower porosity, smaller maximum pore volume, a greater proportion of pores smaller than 0.2 mm, is denser specimen, has a reduced likelihood of pores developing into large cracks under the same load, has enhanced elasticity and hardness in the interior segment, elevated compressive strength, and/or deeper carbonation depth when compared to a comparable cementitious aggregate comprising a natural aggregate.

Any composition or method disclosed herein is applicable to any herein-disclosed composition or method. In other words, any aspect or embodiment described herein can be combined with any other aspect or embodiment as disclosed herein.

### BRIEF DESCRIPTION OF THE DRAWINGS

FIG. 1 shows sampling strategies for different microstructural characterizations.

FIG. 2A shows XRD patterns and FIG. 2B and FIG. 2C show pore structures parameters of RA or CRA obtained by MIP test.

FIG. 3A and FIG. 3B show compressive strength of specimens containing NA, RA and CRA cured in (a) air and (b) CO₂.

FIG. 4A to FIG. 4D XRD patterns in interior and FIG. 4E to FIG. 4H show XRD patterns in exterior regions of specimens after being air/CO₂-cured for 3 and 14 days.

FIG. 5A to FIG. 5D show contents of unhydrated MgO and uncarbonated brucite in interior/exterior regions of specimens after being air/CO₂-cured for 3 and 14 days.

FIG. 6A to FIG. 6H show TG-DTG curves in interior regions (FIG. 6A-FIG. 6D) or exterior regions (FIG. 6E-FIG. 6H) of specimens after being air/CO₂-cured for 3 and 14 days, with their carbonation degrees reveals in (FIG. 6I) and (FIG. 6J).

FIG. 7A to FIG. 7U 2D X-CT images of specimens after being air/CO₂-cured for 14 days.

FIG. 8A is a 3D reconstructed X-CT images of selected groups after being CO₂-cured for 14 days, and their total porosity (FIG. 8B), maximum pore volume (FIG. 8C) and cumulative pore size distribution derived from the 3D reconstructed images (FIG. 8D).

FIG. 9A shows pore size and FIG. 9B shows frequency distribution of New ITZ′ pore structure of concrete in final setting sampling strategies for different microstructural characterizations.

FIG. 10A to FIG. 10F shows contour maps and the frequency distribution of modulus in aggregates, ITZ's and paste of the selected groups. Note: NA-C-In and NA-C-Ex represent the interior and exterior regions of the I-CRA-C group, respectively. The same for the I-RA-C-In, I-RA-C-Ex, I-CRA-C-In and I-CRA-C-Ex groups.

FIG. 11A to FIG. 11F show contour maps of hardnesses and the frequency distribution of hardness in aggregates, ITZ′ and paste of the selected groups.

FIG. 12A shows distributions of moduli and FIG. 12B shows distribution of hardness along the X-axis of the selected groups.

FIG. 13A to FIG. 13C are schematic diagrams of evolution of ITZ′ and paste in RMC-based concrete containing RA (FIG. 13A), CRA (FIG. 13C) or NA (FIG. 13B) after being subjected to CO₂-curing.

FIG. 14A and FIG. 14B show cross-sectional morphology of NA-C and I-CRA-C after compression test.

FIG. 15A to FIG. 15C show correlation between 28 d strength of CO₂-cured specimen and porosity (FIG. 15A), elastic modulus of ITZ (FIG. 15B), and hardness of ITZ (FIG. 15C).

FIG. 16A to FIG. 16C show correlation between 28 d strength of air-cured specimen and MgO content (FIG. 16A), carbonation degree (FIG. 16B), and Correlation between 28 d strength of CO₂-cured specimen and carbonation degree in the interior region (FIG. 16C).

### DETAILED DESCRIPTION

### Introduction

Rapid urbanization and industrial expansion have spurred concrete production and demolition, culminating in the accumulation of construction and demolition waste (CDW). Simultaneously, there has been a substantial surge in the demand for natural aggregates (NA), prompting the exploitation of these resources and causing notable environmental disturbances. CDW has emerged as a sustainable solution by being repurposed as recycled aggregates (RA) to supplant NA. In contrast to the extraction of NA, the production of 1 ton of RA can potentially reduce CO₂ emissions by 23-28% and lower construction costs by 34-41%. Furthermore, based on their quality, recycled coarse aggregates were categorized into three grades, following the guidelines set forth in the Chinese standard GB/T 25177-2010 (the entire contents of which is herein incorporated by reference), thereby streamlining their practical application.

However, the qualities of RA are subpar compared to NA, primarily attributable to the presence of porous, old mortar adhering to them, along with multiple interfacial transition zones (ITZ). Consequently, the strength and durability of recycled concrete falls short of their natural counterparts. As a result, techniques for modifying RA properties have been devised, essentially categorized into two primary approaches: the removal or enhancement of adhered old mortar on RA. Notably, among the proposed methods, CO₂ pretreatment of RA enhances the qualities of adhered old mortar on RA. In the course of CO₂ pretreatment of RA, CO₂ reacts with compounds such as CSH and Ca(OH)₂, resulting in the production of CaCO₃ and silica gel. This reaction effectively seals cracks and enhances the quality of RA. This carbonation process leads to a reduction in the water absorption and crushing index loss of carbonated recycled aggregates (CRA), concomitant with an increase in apparent density and impermeability. Moreover, concrete incorporating CRA augments mechanical properties and enhanced durability. Pretreated RA then serves as internal CO₂ source for additional curing. Specifically, calcite at CRA surface dissolve slowly releases CO₃²⁻, which reacts with aluminate ions to form C₃A·CaCO₃·11H₂O, enhancing the RCA-paste interface bond in a physical interlocking way. Furthermore, accelerated carbonation technology effectively enhances the properties of RA and securely captures CO₂, thus contributing to the mitigation of the greenhouse effect.

Furthermore, the application of accelerated carbonation technology significantly enhances the mechanical performance of reactive magnesia cement (RMC). One of its hydration products, brucite, represents a mechanically weak phase that relies on carbonation for strength development. Consequently, during CO₂ curing, brucite undergoes a reaction with CO₂ to produce hydrated magnesium carbonates (HMCs) like nesquehonite, hydromagnesite, and dypingite, leading to the development of a dense interior structure and thereby enhancing the strength of RMC-based specimens. There have been limited studies addressing the incorporation of recycled aggregates into reactive magnesia cement (RMC) formulations. As described Advantages of utilizing recycled brick concrete aggregate (RBCA) and carbonated RBCA in RMC-based concrete under CO₂ curing, evident through their superior mechanical performance and enhanced microstructure have been described (see, e.g., C. Pan, et al., “Unlocking the role of recycled aggregates in the performance enhancement and CO₂ capture of reactive magnesia cement formulations”, Cement and Concrete Research, 168 (2023) 107148 and C. Pan, et al., “Performance buildup of reactive magnesia cement (RMC) formulation via using CO₂-strengthened recycled concrete aggregates (RCA)”, Journal of Building Engineering, 65 (2022) 105779, the entire contents of each of which is incorporated herein by reference). This outcome contrasts with the strength development in recycled concrete manufactured with OPC. However, due to the presence of porous and porous bricks, the water absorption rate of RBCA usually exceed the requirements of for III-RA (5-8%) in standard, let alone I-RA and II-RA, therefore affecting its large-scale application.

Nevertheless, considering the diversity in sources of recycled aggregates, it remains uncertain whether the utilization of different types or grades of recycled aggregates, contingent on their qualities, uniformly enhances the mechanical performance of RMC-based specimens. Concurrently, the interfacial transition zone (ITZ) is acknowledged as the most vulnerable segment of concrete, constituting the primary source of pores. Without wishing to be bound by theory, CO₂ may more effectively infiltrate the interconnected pores within both aged and recently developed ITZs, which also contain a substantial amount of Mg(OH)₂ (a weaker mineral phase) similar to OPC (where a considerable quantity of Ca(OH)₂ is present within ITZs) (see, e.g., C. Pan, et al., (2023) and C. Pan, et al., (2022)). Consequently, CO₂ reacts with Mg(OH)₂ to generate a range of HMCs characterized by substantial hardness and strength within the ITZs. Nevertheless, direct observation of the microstructural alterations in RMC-based concrete containing RA is still lacking, and as a result, the aforementioned hypothesis remains unverified.

The present disclosure employs Grade I, II, and III RA in the formulation of RMC-based concretes, facilitating a comprehensive examination of their macro-, meso-, and micro-properties. This disclosure expands the use of RA in RMC-based concrete. As disclosed herein, pre-CO₂ treated RA in RMC-based concrete was subjected to dual carbonation under CO₂ curing, and an evaluation of the efficacy of this enhanced RA in relation to the strength of RMC-based concrete was undertaken. Furthermore, an investigation into the correlation between compressive strength and microstructural changes (incorporating ITZ characteristics, porosity, and degrees of hydration/carbonation) was conducted, marking the first disclosure of this method. The present disclosure provides insights into variations in strength in RMC-based concrete, thus providing guidance for the utilization of RA in these binders.

### Advantages of the Present Disclosure

The present disclosure evidences that recycled aggregates (RA) and carbonated recycled aggregates (CRA) with different quality grades enhance the compressive strength and CO₂ capture capacity of CO₂-cured RMC based concrete. This disclosure provides for the upcycling of recycled aggregates (RA) and carbonated recycled aggregates (CRA) in RMC-based concrete on a large scale. The present disclosure discloses comprehensive investigation, involving microscopic characterizations, which analyzes the phase composition, carbonation degree, pore structure, and interfacial transition zone (ITZ) characteristics in both the interior and exterior regions of specimens. The key findings disclose here are as follows:
(1) Under air-curing conditions, the incorporation of RA and CRA in RMC formulations results in slightly higher strength than their NA counterparts, contributing to a more open and particulate microstructure. However, the utilization of RA and CRA reduces the effective water-to-cement ratio, leading to a denser concrete microstructure and superior strength in specimens with RA or CRA.
(2) Regardless of the grades of RA, the strength gain rates of RA-C and CRA-C groups remain higher than the NA-C group, attributed to the significantly greater channels for CO₂ diffusion within RA or CRA specimens. Specimens with CRA exhibit superior strength, potentially linked to the enhanced properties of old ITZs from RA. The use of Grade III RA in RMC-based concrete production can substantially reduce material costs without compromising mechanical properties, making it a practical choice.
(3) RA or CRA effectively improves pore structure features, contributing to higher compressive strength while causing fewer expansion cracks. Moreover, the interior regions containing RA or CRA demonstrate elevated modulus and hardness, confirming RA's or CRA's role in fortifying the microstructure and elucidating the enhancement in strength. This can be ascribed to the interior curing effect of RA or CRA and the augmented CO₂ diffusion paths. Carbonation degree analysis shows no significant difference between RA or CRA grades in RMC concrete.
(4) Analysis of the interfacial transition zone (ITZ) characteristics and porosity revealed a robust linear correlation with the compressive strength of specimens subjected to CO₂ curing. Furthermore, a discernible linear correlation between the degree of hydration/carbonation and strength was observed within air-cured groups with identical w/c ratios. Notably, this correlation was not evident in groups with divergent w/c ratios.

### Methods

An aspect of the present disclosure is a method comprising steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and (b) permitting the combination obtained in step (a) to persist under conditions sufficient to transform the combination into a cementitious aggregate composition and a reduced salinity water component.

Another aspect of the present disclosure is an in-line conversion method comprising steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and (b) applying pressure to the combination obtained in step (a) for an amount and duration sufficient to transform the combination into a cementitious aggregate composition and a reduced salinity water component, wherein the conditions in step (b) comprise applied pressure and wherein steps (a) and/or (b) occur in a pipeline.

An additional aspect of the present disclosure is an in-line conversion method comprising steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); (b) allowing the combination obtained in step (a) to persist for duration sufficient to transform the combination into a cementitious aggregate composition and a reduced salinity water component, wherein steps (a) and/or (b) occur in a pipeline.

Another aspect of the present disclosure is an in-line conversion method comprising steps of: (a) combining (i) a high salinity brine, (ii) CO₂, (iii) a natural pozzolan, a man-made pozzolan, a latently hydraulic material, and/or a recycled aggregate (RA) or a carbonated recycled aggregate (CRA), and (iv) an activator; and (b) applying pressure to the combination obtained in step (a) for an amount and duration sufficient to transform the combination into a cementitious aggregate composition and a reduced salinity water component, wherein the conditions in step (b) comprise applied pressure and wherein steps (a) and/or (b) occur in a pipeline.

A further aspect of the present disclosure is a tank precipitation method comprising steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and (b) permitting the combination obtained in step (a) to persist under conditions sufficient to transform the combination into a cementitious aggregate composition and a reduced salinity water component, wherein the conditions in step (b) does not comprise applied pressure and wherein steps (a) and/or (b) occur in a tank or basin.

In various tank precipitation methods, an activator is preferably included in the combination. In combinations comprising latently hydraulic material, an activator is preferably included in the combination.

In some embodiments, the high salinity brine is treated after step (a) to reduce the amount of sodium and chloride using a method known in the art (e.g., via a chloralkali process).

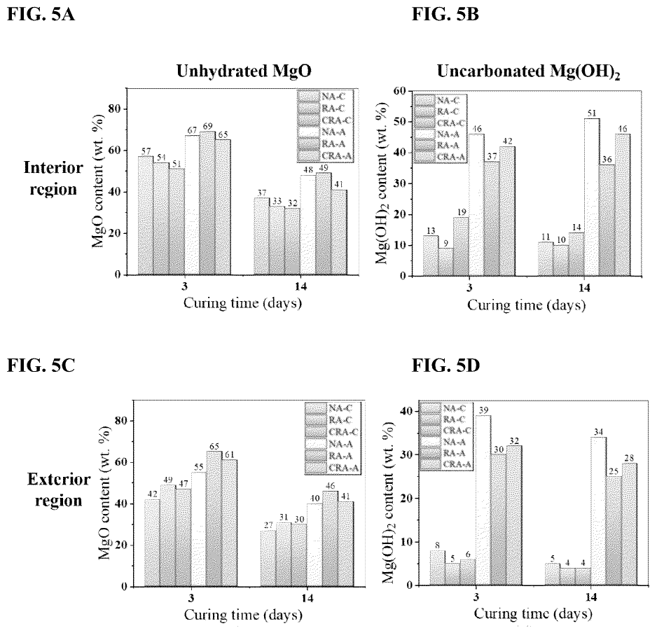

In some embodiments, the reduced salinity water component is further processed to extract sodium to produce additional fresh water. In addition to or in combination with or after the above-described processes, a chloralkali process (as illustrated in FIG. 5A to FIG. 5D) can more efficiently be performed, since, at least in part, because the sulphates and chlorides have already been removed. The extracted sodium may be isolated into a pure sodium product.

In several embodiments, the high salinity brine, CO₂, and the natural pozzolan, the man-made pozzolan, the latently hydraulic material, and/or the recycled aggregate (RA) or the carbonated recycled aggregate (CRA) are combined simultaneously.

In some embodiments, the high salinity brine, CO₂, and the natural pozzolan, the man-made pozzolan, the latently hydraulic material, and/or the recycled aggregate (RA) or the carbonated recycled aggregate (CRA) are combined sequentially with the high salinity brine and CO₂ combined first.

In various embodiments, the high salinity brine, CO₂, and the natural pozzolan, the man-made pozzolan, the latently hydraulic material, and/or the recycled aggregate (RA) or the carbonated recycled aggregate (CRA) are combined sequentially with the CO₂ and the pozzolan combined first.

In numerous embodiments, the high salinity brine, CO₂, and the natural pozzolan, the man-made pozzolan, the latently hydraulic material, and/or the recycled aggregate (RA) or the carbonated recycled aggregate (CRA) are combined sequentially with the high salinity brine and the pozzolan combined first.

In additional embodiments, the high salinity brine is obtained from a desalination facility, is natural seawater, or an industrial brine.

In several embodiments, the salt concentration of the high salinity brine is greater than or about equal to the salt concentration of seawater. In some cases, the salt comprises sodium chloride.

In embodiments, the salt concentration of the reduced salinity water component is less than or about equal to the salt concentration of seawater. In some cases, the salt comprises sodium chloride.

In some embodiments, the salt concentration of the reduced salinity water component is less than the high salinity brine. In various cases, the high salinity brine comprises water with a salt concentration (e.g., chloride, sulphate and sodium) higher than 50 parts per thousand. In some cases, the salt comprises sodium chloride.

In many embodiments, the brine of step (a) has reduced amounts of sodium, potassium, chloride, sulphate, magnesium, and/or calcium ions via chemical precipitation, electrochemical methods, ion selective membranes, reverse osmosis, and/or selective precipitation by pH. In some cases, the chemical precipitation comprises contacting the sodium, potassium, chloride, sulphate, magnesium, and/or calcium ions with lime (calcium hydroxide, Ca(OH)₂) or alum (aluminum sulfate, Al₂(SO₄)₃) which forms insoluble precipitates with the sodium, potassium, chloride, sulphate, magnesium, and/or calcium ions. In various cases, the chemical precipitation occurs before step (a) and/or during step (a).

In various embodiments, the reduced salinity water component is added to a natural or artificial body of water. In some cases, the reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In numerous embodiments, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

In additional embodiments, the method permits production by a desalination facility of a brine having a higher salt concentration relative to a method where the desalination facility produces brine as wastewater to be added to a natural or artificial body of water. In some cases, the relative salt concentration is up to 5-fold higher, e.g., about 1-fold, 2-fold, 3-fold, 4-fold, or about 5-fold and any range or value therebetween.

In several embodiments, the method permits production of more fresh water by a desalination facility relative to a method where the desalination facility produces brine as wastewater to be added to a natural or artificial body of water. In some cases, the amount of fresh water produced is up to 5-fold higher, e.g., about 1-fold, 2-fold, 3-fold, 4-fold, or about 5-fold and any range or value therebetween.

In embodiments, the steps (a) and/or (b) occurs in a location within the desalination facility, adjacent to the desalination facility, or downstream from the desalination facility. In some cases, step (a) and/or step (b) occurs in a pipeline within the desalination facility, adjacent to the desalination facility, or downstream from the desalination facility. In certain cases, the pressure in step (b) is applied to the pipeline utilizing a series of pipe reducers which creates pressure sufficient to make the conversion process (e.g., chemical reactions) more efficient. In various cases, a pipe reducer is a mechanical device used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

In some embodiments, the steps (a) and/or (b) occurs in a location distant from the desalination facility. In some cases, step (a) and/or step (b) occurs in a pipeline within the desalination facility, adjacent to the desalination facility, or downstream from the desalination facility. In certain cases, the pressure in step (b) is applied to the pipeline utilizing a series of pipe reducers. In various cases, a pipe reducer is a mechanical device used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

In embodiments, the pipeline is between about 12 inches and about 18 inches in diameter. In some cases, the diameter of the pipeline is greater than 18 inches, e.g., a diameter capable of discharging a million gallons (or more) per day.

In many embodiments, the steps (a) and/or (b) occurs in a location within the desalination facility, adjacent to the desalination facility, or downstream from the desalination facility and steps (a) and/or (b) occurs in a tank or basin.

In various embodiments, the steps (a) and/or (b) occurs in a location distant from the desalination facility and steps (a) and/or (b) occurs in a tank or basin.

In numerous embodiments, the pozzolan comprises silica (SiO₂), alumina (Al₂O₃), and/or iron oxide (Fe₂O₃).

In embodiments, the pozzolan is a natural pozzolan or a man-made pozzolan.

In additional embodiments, the pozzolan comprises or is obtained from one or more of volcanic rock (e.g., rhyolite, olivine, obsidian, pitchstone, pumice, basalt or trap, or andesite); volcanic ash; sedimentary clays or shales' calcined clays; rice husk ash; diatomaceous earth; metakaolin; and olivine.

In several embodiments, use of pozzolan avoids the problem of sourcing cementitious material that is used in standard concrete manufacturing. In some cases, avoiding the problem of sourcing cementitious material further reduces the amount of energy required and/or waste CO₂ produced relative to standard concrete manufacturing. Without wishing to be bound by theory, while standard cement manufacturing is responsible for about 10% of the world's CO₂ emissions.

In embodiments, the cementitious aggregate composition absorbs more carbon dioxide during its manufacture than is emitted.

In some embodiments, the cementitious aggregate composition absorbs and/or retains at least 0.04 kg CO₂ per kg of composition.

In any embodiment, the CO₂ is chemically reacted to form a crystalline form of carbon.

In various embodiments, the CO₂ is absorbed into the aggregate cementitious as a crystalline form of carbon. Thus, the CO₂ is permanently removed from the atmosphere.

In many embodiments, the CO₂ of step (a) is from industrial waste, from environmental sources, or from molecular capture. In some cases, the industrial waste relates to alcoholic fermentation or the burning of fossil fuels.

In various embodiments, the CO₂ of step (a) is provided in gaseous, solid, and/or as a supercritical fluid form or as a dissolved gas.

In numerous embodiments, the CO₂ of step (a) is incorporated into the cementitious aggregate composition as a carbonate.

In additional embodiments, step (a) further comprises adding an activator. In various cases, the activator may be any sodium, lithium or potassium salt or hydroxide and any alkali or alkali earth metal ions. In some cases, the activator is Mg(OH)₂, MgO, Ca(OH)₂, CaCO₃, Al₂(SO₄)₃, and/or CaO. In some cases, the activator, e.g., Mg(OH)₂, MgO, Ca(OH)₂ and/or CaO, are not obtained by a pyroclastic process.

The accelerant (e.g., activator) of cementitious aggregate compositions and cementitious aggregate mixtures described herein can comprise at least one accelerant selected from magnesium chloride (e.g., MgCl₂), magnesium sulfate (e.g., MgSO₄), magnesium nitrate (e.g., Mg(NO₃)₂), and a phosphate-based accelerant. In some embodiments, the accelerant and/or cementitious aggregate composition does not comprise magnesium sulfate. In some embodiments, the accelerant and/or cementitious aggregate composition does not comprise magnesium chloride. In some embodiments, the accelerant and/or cementitious aggregate composition does not comprise magnesium nitrate. In some embodiments, the accelerant and/or cementitious aggregate composition does not comprise a phosphate-based accelerant.

The cementitious aggregate compositions (e.g., shaped cementitious compositions) disclosed herein can comprise any amount or proportion of accelerant (e.g., at least one accelerant). The proportion can be calculated by the wet weight (e.g., the weight of the cementitious aggregate composition following the addition of a liquid such as water) or the dry weight (e.g., the weight of the cementitious aggregate composition prior to addition of a liquid such as water). The proportion by weight of the at least one accelerant can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of magnesium oxide (e.g., MgO) by weight of the cementitious aggregate composition. The proportion by weight of the at least one accelerant can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of the magnesium hydroxide (e.g., Mg(OH)₂) by weight of the cementitious aggregate composition. The proportion by weight of the at least one accelerant can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium oxide by weight of the cementitious aggregate composition. The proportion by weight of the at least one accelerant can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium hydroxide by weight of the cementitious aggregate composition.

The cementitious aggregate compositions (e.g., shaped cementitious aggregate compositions) described herein can comprise any amount or proportion of magnesium chloride (e.g., MgCl₂). The proportions can be calculated by the wet weight (e.g., the weight of the cementitious aggregate composition following the addition of a liquid such as water) or the dry weight (e.g., the weight of the cementitious aggregate composition prior to addition of a liquid such as water). The proportion by weight of magnesium chloride can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of magnesium oxide (e.g., MgO) by weight of the cementitious aggregate composition. The proportion by weight of magnesium chloride can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of the magnesium hydroxide (e.g., Mg(OH)₂) by weight of the cementitious aggregate composition. The proportion by weight of magnesium chloride can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium oxide by weight of the cementitious aggregate composition. The proportion by weight of magnesium chloride can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium hydroxide by weight of the cementitious aggregate composition.

The cementitious aggregate compositions (e.g., shaped cementitious aggregate compositions) described herein can comprise any amount or proportion of magnesium nitrate (e.g., Mg(NO₃)₂). The proportions can be calculated by the wet weight (e.g., the weight of the cementitious aggregate composition following the addition of a liquid such as water) or the dry weight (e.g., the weight of the cementitious aggregate composition prior to addition of a liquid such as water). The proportion by weight of magnesium nitrate can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of magnesium oxide (e.g., MgO) by weight of the cementitious aggregate composition. The proportion by weight of magnesium nitrate can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of the magnesium hydroxide (e.g., Mg(OH)₂) by weight of the cementitious aggregate composition. The proportion by weight of magnesium nitrate can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium oxide by weight of the cementitious aggregate composition. The proportion by weight of magnesium nitrate can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium hydroxide by weight of the cementitious aggregate composition.

The cementitious aggregate compositions (e.g., shaped cementitious aggregate compositions) described herein can comprise any amount or proportion of magnesium sulfate (e.g., MgSO₄). The proportions can be calculated by the wet weight (e.g., the weight of the cementitious aggregate composition following the addition of a liquid such as water) or the dry weight (e.g., the weight of the cementitious aggregate composition prior to addition of a liquid such as water). The proportion by weight of magnesium sulfate can be about 5% to about 145% (e.g., about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of magnesium oxide (e.g., MgO) by weight of the cementitious aggregate composition. The proportion by weight of magnesium sulfate can be about 5% to about 150% (e.g., about 10% to about 150%, about 5% to about 145%, about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145%) of the proportion of the magnesium hydroxide (e.g., Mg(OH)₂) by weight of the cementitious aggregate composition. The proportion by weight of magnesium sulfate can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium oxide by weight of the cementitious aggregate composition. The proportion by weight of magnesium sulfate can be about 0.1% to about 30% (e.g., about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25%) of the proportion of magnesium hydroxide by weight of the cementitious aggregate composition.

In some embodiments, the at least one accelerant comprises a phosphate-based accelerant, wherein a proportion by weight of the phosphate-based accelerant is 0.1% to 5% (e.g., 0.5%-5%, 1-5%, 1.5%-5%, 2%-5%, 2%-4.5%, 2%-4%, 2%-3.5%, 2.5%-5%, 2.5-4.5%, 2.5%-4%, 2.5%-3.5%, 2.5%-3%, 3%-3.5%, 3%-5%, 4%-5%, values between the foregoing ranges, etc.) of the proportion of magnesium oxide by weight of the cementitious aggregate composition. The proportions can be calculated by the wet weight (e.g., the weight of the cementitious aggregate composition following the addition of a liquid such as water) or the dry weight (e.g., the weight of the cementitious aggregate composition prior to addition of a liquid such as water). In some embodiments, the at least one accelerant comprises a phosphate-based accelerant, wherein a proportion by weight of the phosphate-based accelerant is 0.1% to 5% (e.g., 0.5%-5%, 1-5%, 1.5%-5%, 2%-5%, 2%-4.5%, 2%-4%, 2%-3.5%, 2.5%-5%, 2.5-4.5%, 2.5%-4%, 2.5%-3.5%, 2.5%-3%, 3%-3.5%, 3%-5%, 4%-5%, values between the foregoing ranges, etc.) of the proportion of magnesium hydroxide by weight of the cementitious aggregate composition. In some embodiments, the phosphate-based accelerant comprises sodium hexametaphosphate. In some embodiments, the phosphate-based accelerant is selected from sodium hexametaphosphate, any other alkali metal phosphates, and phosphoric acid.

In various tank precipitation methods, an activator is preferably included in the combination. In combinations comprising latently hydraulic material, an activator is preferably included in the combination.

In several embodiments, the cementitious aggregate composition forms particles of various shapes, sizes, and textures. In some cases, the particles have average sizes ranging from 0.0625 mm to about 40.0 mm in diameter. In various cases, the particles have generally rounded or oval shapes. The particles may comprise pores. In certain cases, the particles comprise more numerous pores per unit volume and/or larger average pores than a standard cement. In some cases, a standard cement has pores of 1.5 to 2.0 nm. The particles may be less dense per unit volume than a standard cement.

In embodiments, the particle has a diameter of about 0.0625 mm to about 40.0 mm. In embodiments the particle has a diameter of 0.0625 mm, 0.075 mm, 0.0825 mm, 0.0900 mm, 0.125 mm, 0.187 mm, 0.250 mm, 0.312 mm, 0.375 mm, 0.437 mm, 0.500 mm, 0.562 mm, 0.625 mm, 0.687 mm, 0.750 mm, 0.812 mm, 0.875, 0.937 mm, 1.00 mm, 1.0625 mm, 1.075 mm, 1.0825 mm, 1.0900 mm, 1.125 mm, 1.187 mm, 1.250 mm, 1.312 mm, 1.375 mm, 1.437 mm, 1.500 mm, 1.562 mm, 1.625 mm, 1.687 mm, 1.750 mm, 1.812 mm, 1.875, 1.937 mm, 2.00 mm, 2.0625 mm, 2.075 mm, 2.0825 mm, 2.0900 mm, 2.125 mm, 2.187 mm, 2.250 mm, 2.312 mm, 2.375 mm, 2.437 mm, 2.500 mm, 2.562 mm, 2.625 mm, 2.687 mm, 2.750 mm, 2.812 mm, 2.875, 2.937 mm, 3.00 mm, 3.0625 mm, 3.075 mm, 3.0825 mm, 3.0900 mm, 3.125 mm, 3.187 mm, 3.250 mm, 3.312 mm, 3.375 mm, 3.437 mm, 3.500 mm, 3.562 mm, 3.625 mm, 3.687 mm, 3.750 mm, 3.812 mm, 3.875, 3.937 mm, 4.00 mm, 4.0625 mm, 4.075 mm, 4.0825 mm, 4.0900 mm, 4.125 mm, 4.187 mm, 4.250 mm, 4.312 mm, 4.375 mm, 4.437 mm, 4.500 mm, 4.562 mm, 4.625 mm, 4.687 mm, 4.750 mm, 4.812 mm, 4.875, 4.937 mm, 5.00 mm, 5.0625 mm, 5.075 mm, 5.0825 mm, 5.0900 mm, 5.125 mm, 5.187 mm, 5.250 mm, 5.312 mm, 5.375 mm, 5.437 mm, 5.500 mm, 5.562 mm, 5.625 mm, 5.687 mm, 5.750 mm, 5.812 mm, 5.875, 5.937 mm, 6.00 mm, 6.50 mm, 7.00 mm, 7.50 mm, 8.00 mm, 8.50 mm, 9.00 mm, 9.50 mm, 10.0 mm, 10.5 mm, 11.0 mm, 11.5 mm, 12.0 mm, 12.5 mm, 13.0 mm, 13.5 mm, 14.0 mm, 14.5, mm, 15.0 mm, 15.5 mm, 16.0 mm, 16.5 mm, 17.0 mm, 17.5 mm, 18.0 mm, 18.5 mm, 19.0 mm, 19.5 mm, 20.0 mm, 21.5 mm, 22.0 mm, 22.5 mm, 23.0 mm, 23.5 mm, 24.0 mm, 24.5, mm, 25.0 mm, 25.5 mm, 26.0 mm, 26.5 mm, 27.0 mm, 27.5 mm, 28.0 mm, 28.5 mm, 29.0 mm, 29.5 mm, 30.0 mm, 30.5 mm, 31.0 mm, 31.5 mm, 32.0 mm, 32.5 mm, 33.0 mm, 33.5 mm, 34.0 mm, 34.5, mm, 35.0 mm, 35.5 mm, 36.0 mm, 36.5 mm, 37.0 mm, 37.5 mm, 38.0 mm, 38.5 mm, 39.0 mm, 39.5 mm, 40.0 mm; or values between the foregoing ranges including endpoints.

In embodiments, the cementitious aggregate composition comprises more CO₂ per gram than a standard cement. In some cases, the cementitious aggregate composition comprises up to 50% more CO₂ per gram than a standard cement.

In some embodiments, the cementitious aggregate composition comprises more calcium, silicon, aluminum, magnesium and/or iron per gram than a standard cement. In some cases, the cementitious aggregate composition comprises up to 50% more calcium, silicon, aluminum, magnesium and/or iron per gram than a standard cement.

In numerous embodiments, the density of the cementitious aggregate composition is from about 1000 g/cc to about 5000 g/cc, e.g., about 1000 g/cc, 1500 g/cc, 2000 g/cc, 2500 g/cc, 3000 g/cc, 3500 g/cc, 4000 g/cc, 4500 g/cc, or about 5000 g/cc. In some case the density is about 2500 g/cc.

In many embodiments, the standard cement comprises CaO, CaCO₃, SiO₂, Al₂O₃, Fe₂O₃, and CaSO₄·H₂O.

In various embodiments, the standard cement comprises a slaked or hydraulic dolomitic or calcareous lime blended with a natural or man-made pozzolanic or latently hydraulic material. In numerous embodiments, the standard cement, e.g., a standard hydrated cement, is a Portland Cement comprising cement clinker rather than pozzolan.

In additional embodiments, the cementitious aggregate composition is deposited into a natural or artificial body of water. In some cases, when deposited into the natural or artificial body of water, the cementitious aggregate composition remains where deposited or when deposited into the natural or artificial body of water, a portion of the cementitious aggregate composition is distributed away from the deposit site. In various cases, the cementitious aggregate composition is distributed away from the deposit site by water movement or currents, erosion, or animal activity. In numerous cases, the cementitious aggregate composition permits attachment by flora, e.g., algae, and/or fauna, e.g., coral. In many cases, the cementitious aggregate composition permits a preferred level of colonization by flora and/or fauna relative to a standard cement and/or the cementitious aggregate composition permits more plentiful attachment by flora and/or fauna relative to a standard cement.

In embodiments, the cementitious aggregate composition comprises any sodium, lithium or Potassium salt or hydroxide and any alkali or alkali earth metal ions and including Mg(OH)₂, MgO, Ca(OH)₂, CaCO₃, Al₂(SO₄)₃, CaO, CaSO₄·H₂O, SiO₂, Fe₂O₃, Al₂O₃ and/or Brucite.

In several embodiments, the cementitious aggregate composition comprises MgO. In some cases, the cementitious aggregate composition does not substantially comprise MgO obtained from a calcination reaction.

In some embodiments, step (b) produces exothermic heat. In some cases, the exothermic heat is transformable from thermal energy into electrical energy.

In many embodiments, the pressure in step (b) is from about ambient (1 bar) to about 250 bar. In various embodiments, the pressure in step (b) is from about 100 bar to about 250 bar. As examples, the pressure in about 101 bar, 102 bar, 103 bar, 104 bar, 105 bar, 106 bar, 107 bar, 108 bar, 109 bar, 110 bar, 111 bar, 112 bar, 113 bar, 114 bar, 115 bar, 116 bar, 117 bar, 118 bar, 119 bar, 120 bar, 121 bar, 122 bar, 123 bar, 124 bar, 125 bar, 126 bar, 127 bar, 128 bar, 129 bar, 130 bar, 131 bar, 132 bar, 133 bar, 134 bar, 135 bar, 136 bar, 137 bar, 138 bar, 139 bar, 140 bar, 141 bar, 142 bar, 143 bar, 144 bar, 145 bar, 146 bar, 147 bar, 148 bar, 149 bar, 150 bar, 151 bar, 152 bar, 153 bar, 154 bar, 155 bar, 156 bar, 157 bar, 158 bar, 159 bar, 160 bar, 161 bar, 162 bar, 163 bar, 164 bar, 165 bar, 166 bar, 167 bar, 168 bar, 169 bar, 170 bar, 171 bar, 172 bar, 173 bar, 174 bar, 175 bar, 176 bar, 177 bar, 178 bar, 179 bar, 180 bar, 181 bar, 182 bar, 183 bar, 184 bar, 185 bar, 186 bar, 187 bar, 188 bar, 189 bar, 190 bar, 191 bar, 192 bar, 193 bar, 194 bar, 195 bar, 196 bar, 197 bar, 198 bar, 199 bar, 200 bar, 101 bar, 202 bar, 203 bar, 204 bar, 205 bar, 206 bar, 207 bar, 208 bar, 209 bar, 210 bar, 211 bar, 212 bar, 213 bar, 214 bar, 215 bar, 216 bar, 217 bar, 218 bar, 219 bar, 220 bar, 221 bar, 222 bar, 223 bar, 224 bar, 225 bar, 226 bar, 227 bar, 228 bar, 229 bar, 230 bar, 231 bar, 232 bar, 233 bar, 234 bar, 235 bar, 236 bar, 237 bar, 238 bar, 239 bar, 240 bar, 241 bar, 242 bar, 243 bar, 244 bar, 245 bar, 246 bar, 247 bar, 248 bar, 249 bar, or about 250 bar, and any range or value therebetween.

In numerous embodiments, the pressure in step (b) is from about ambient (1 bar) to about 100 bar. As examples, the pressure is about 1 bar, 2 bar, 3 bar, 4 bar, 5 bar, 6 bar, 7 bar, 8 bar, 9 bar, bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 31 bar, 32 bar, 33 bar, 34 bar, 35 bar, 36 bar, 37 bar, 38 bar, 39 bar, 40 bar, 41 bar, 42 bar, 43 bar, 44 bar, 45 bar, 46 bar, 47 bar, 48 bar, 49 bar, 50 bar, 51 bar, 52 bar, 53 bar, 54 bar, 55 bar, 56 bar, 57 bar, 58 bar, 59 bar, 60 bar, 61 bar, 62 bar, 63 bar, 64 bar, 65 bar, 66 bar, 67 bar, 68 bar, 69 bar, 70 bar, 71 bar, 72 bar, 73 bar, 74 bar, 75 bar, 76 bar, 77 bar, 78 bar, 79 bar, 80 bar, 81 bar, 82 bar, 83 bar, 84 bar, 85 bar, 86 bar, 87 bar, 88 bar, 89 bar, 90 bar, 91 bar, 92 bar, 93 bar, 94 bar, 95 bar, 96 bar, 97 bar, 98 bar, 99 bar, or about 100 bar, and any range or value therebetween.

In various embodiments, the pressure in step (b) is greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. In various cases the pressure in step (b) is greater than 250 bar, 260 bar, 270 bar, 280 bar, 290 bar, 300 bar, 310 bar, 320 bar, 330 bar, 340 bar, 350 bar, 360 bar, 370 bar, 380 bar, 390 bar, 400 bar, 410 bar, 420 bar, 430 bar, 440 bar, 450 bar, 460 bar, 470 bar, 480 bar, 490 bar, 500 bar and any range or value therebetween. The pressure in step (b) may be greater than 500 bar, 510 bar, 520 bar, 530 bar, 540 bar, 550 bar, 560 bar, 570 bar, 580 bar, 590 bar, 600 bar, 610 bar, 620 bar, 630 bar, 640 bar, 650 bar, 660 bar, 670 bar, 680 bar, 690 bar, 700 bar, 710 bar, 720 bar, 730 bar, 740 bar, 750 bar, 760 bar, 770 bar, 780 bar, 790 bar, 800 bar, 810 bar, 820 bar, 830 bar, 840 bar, 850 bar, 860 bar, 870 bar, 880 bar, 890 bar, 900 bar, 910 bar, 920 bar, 930 bar, 940 bar, 950 bar, 960 bar, 970 bar, 980 bar, 990 bar, 1000 bar and any range or value therebetween.

In additional embodiments, the temperature of step (a) and/or step (b) is from about 1° C. to about 100° C. As examples, the temperature is about 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., or about 100° C., and any range or value therebetween. In various cases, heat is provided to achieve a temperature of greater than 100° C. and up to 3000° C.

In any embodiment, heat is applied to the mixture and/or the mixture is heated via an additional. The applied heat increases the rate of reaction and/or the extent of reaction and/or activates the latent hydraulic nature of some components. In several embodiments, the duration of step (b) is from about 1 minute to about 10 hours. As examples the duration is about 10 minutes, 20 minutes, 30 minutes, 40 minutes, 50 minutes, 60 minutes, 70 minutes, 80 minutes, 90 minutes, 2 hours, 3 hours, 4 hours, 5 hours, 6 hours, 7 hours, 8 hours, 9 hours, or about 10 hours, and any range or value therebetween.

In several embodiments, the duration of step (b) is from about 10 hours to about 10 days. As examples the duration is about 10 hours, 20 hours, 30 hours, 40 hours, 50 hours, 60 hours, 70 hours, 80 hours, 90 hours, 2 days, 3 days, 4 days, 5 days, 6 days, 7 days, 8 days, 9 days, or about 10 days, and any range or value therebetween.

In embodiments, the duration of step (b) is from about 1 minute to about 10 minutes. As examples the duration is about 1 minute, 2 minutes, 3 minutes, 4 minutes, 5 minutes, 6 minutes, 7 minutes, 8 minutes, 9 minutes, or about 10 minutes, and any range or value therebetween.

In numerous embodiments, the ratio (weight to weight or weight to volume or volume to volume) of the high salinity brine to the natural pozzolan, the man-made pozzolan, the latently hydraulic material, and/or the recycled aggregate (RA) or the carbonated recycled aggregate (CRA) varies from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In embodiments, the ratio (weight to weight or weight to volume or volume to volume) of the high salinity brine to CO₂ varies from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In some embodiments, the ratio (weight to weight or weight to volume or volume to volume) of the natural pozzolan, the man-made pozzolan, the latently hydraulic material, and/or the recycled aggregate (RA) or the carbonated recycled aggregate (CRA) to CO₂ varies from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In some embodiments, a filler material or another additive is added to the combination of step (a). In some cases, a filler material or another additive comprises sand, gravel, lightweight aggregate, recycled aggregate (RA), carbonated recycled aggregate (CRA), or crushed stone, and a combination thereof.

In embodiments, the ratio (weight to weight or weight to volume or volume to volume) of the aggregate to each of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In various embodiments, the ratio (weight to weight or weight to volume or volume to volume) of the aggregate to the combined weight or volume of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween. In many embodiments, the latently hydraulic material is a slag. In some cases, the slag is added in step (a) in addition to the added pozzolan. In alternate cases, the slag is added in step (a) instead of pozzolan. In some cases, the slag is added in step (a) instead of an activator.

In embodiments, the method further comprises isolating the cementitious aggregate composition from the reduced salinity water component or other liquid components. In some cases, the isolating comprises straining to capture the cementitious aggregate composition.

In various embodiments, the cementitious aggregate composition is molded into a shaped cementitious composition. Without wishing to be bound by theory, particles of the cementitious aggregate composition can stick to each other, thereby permitting the molding of the composition into shapes. In some case, molding may not require an additional binder to keep the molded shape and in other cases, molding may require an additional binder to keep the molded shape. In some cases, the shaped cementitious composition permits attachment by flora, e.g., algae, and/or fauna, e.g., coral, relative to a standard cement. In various cases, the shaped cementitious composition permits stronger attachment by flora and/or fauna relative to a standard cement and/or the shaped cementitious composition permits more plentiful attachment by flora and/or fauna relative to a standard cement. When molded, the shaped cementitious composition comprises gaps between particles of the aggregate such that the shaped cementitious composition has a more porous surface, is more porous throughout its volume, and is less dense than a standard cement. The gaps of a shaped cementitious composition may be up to 500 nm in diameter. Additionally, a shaped cementitious composition may have up to 85% of the volume being void (e.g., the sum of all gaps) whereas a standard cement may have about 40% of the volume being void.

The cementitious aggregate composition be used in any way that another cementitious aggregates can be used.

The shape of the shaped cementitious composition may be any shape capable of providing a substrate for aquatic flora and/or fauna attachment, as examples. The shape could be planar, circular, rounded, elongated, flat, rectangular, or any combination thereof. In some embodiments, the shape is pyramidal with closed surfaces. In other embodiments, the shape is pyramidal with open surfaces such that the shape comprises four bars or cylinders that form a square base and four bars or cylinders each originating at a corner of the square and converging to form the pyramid's apex.

The shaped cementitious aggregate composition be used in any way that any cement can be used.

In embodiments, the cementitious composition further comprises at least one filler material or other additive, the at least one filler or other additive can be pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

In some embodiments, the ratio (weight to weight or weight to volume or volume to volume) of the filler material or other additive to each of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In various embodiments, the ratio (weight to weight or weight to volume or volume to volume) of the filler material or other additive to the combined weight or volume of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

A further aspect of the present disclosure is a method for providing substrate for aquatic flora and/or fauna attachment, the method comprising depositing a herein-disclosed cementitious aggregate composition into a natural or artificial body of water which comprises aquatic flora and/or fauna in need of an attachment.

In some cases, when deposited into the natural or artificial body of water, the cementitious aggregate composition remains where deposited or when deposited into the natural or artificial body of water, a portion of the cementitious aggregate composition is distributed away from the deposit site. In various cases, the cementitious aggregate composition is distributed away from the deposit site by water movement or currents, erosion, or animal activity. In numerous cases, the cementitious aggregate composition permits attachment by flora, e.g., algae, and/or fauna, e.g., coral. In many cases, the cementitious aggregate composition permits a preferred level of colonization by flora and/or fauna relative to a standard cement and/or the cementitious aggregate composition permits more plentiful attachment by flora and/or fauna relative to a standard cement.

In an aspect, the present disclosure provides a method for providing substrate for aquatic flora and/or fauna attachment, the method comprising depositing any herein-disclosed shaped cementitious composition into a natural or artificial body of water which comprises aquatic flora and/or fauna in need of an attachment. In this aspect, the cementitious aggregate composition is molded into a shaped cementitious composition.

In embodiments, the shaped cementitious composition permits attachment by flora, e.g., algae, and/or fauna, e.g., coral, relative to a standard cement. In various cases, the shaped cementitious composition permits stronger attachment by flora and/or fauna relative to a standard cement and/or the shaped cementitious composition permits more plentiful attachment by flora and/or fauna relative to a standard cement.

In some embodiments, a filler material or another additive is added to the combination of step (a). In some cases, the filler material or the other additive comprises sand, gravel, lightweight aggregate, recycled aggregate (RA), carbonated recycled aggregate (CRA), or crushed stone, and a combination thereof.

In numerous embodiments, the ratio (weight to weight or weight to volume or volume to volume) of the aggregate to each of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In embodiments, the ratio (weight to weight or weight to volume or volume to volume) of the aggregate to the combined weight or volume of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween. In many embodiments, the latently hydraulic material is a slag. In some cases, the slag is added in step (a) in addition to the added pozzolan. In alternate cases, the slag is added in step (a) instead of pozzolan. In some cases, the slag is added in step (a) instead of an activator.

In embodiments, the method further comprises isolating the cementitious aggregate composition from the reduced salinity water component or other liquid components. In some cases, the isolating comprises straining to capture the cementitious aggregate composition. In various embodiments, the cementitious aggregate composition is molded into a shaped cementitious composition. Without wishing to be bound by theory, particles of the cementitious aggregate composition can stick to each other, thereby permitting the molding of the composition into shapes. In some case, molding may not require an additional binder to keep the molded shape and in other cases, molding may require an additional binder to keep the molded shape. In some cases, the shaped cementitious composition permits attachment by flora, e.g., algae, and/or fauna, e.g., coral, relative to a standard cement. In various cases, the shaped cementitious composition permits stronger attachment by flora and/or fauna relative to a standard cement and/or the shaped cementitious composition permits more plentiful attachment by flora and/or fauna relative to a standard cement. When molded, the shaped cementitious composition comprises gaps between particles of the aggregate such that the shaped cementitious composition has a more porous surface, is more porous throughout its volume, and is less dense than a standard cement. The gaps of a shaped cementitious composition may be up to 500 nm in diameter. Additionally, a shaped cementitious composition may have up to 85% of the volume being void (e.g., the sum of all gaps) whereas a standard cement may have about 40% of the volume being void.

The shape of the shaped cementitious composition may be any shape capable of providing a substrate for aquatic flora and/or fauna attachment. The shape could be planar, circular, rounded, elongated, flat, rectangular, or any combination thereof. In some embodiments, the shape is pyramidal with closed surfaces. In other embodiments, the shape is pyramidal with open surfaces such that the shape comprises four bars or cylinders that form a square base and four bars or cylinders each originating at a corner of the square and converging to form the pyramid's apex.

In many embodiments, the cementitious composition further comprises at least one filler material or other additive, the at least one filler or other additive can be pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

In some embodiments, the ratio (weight to weight or weight to volume or volume to volume) of the filler material or other additive to each of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween. In embodiments, the ratio (weight to weight or weight to volume or volume to volume) of the filler material or other additive to the combined weight or volume of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

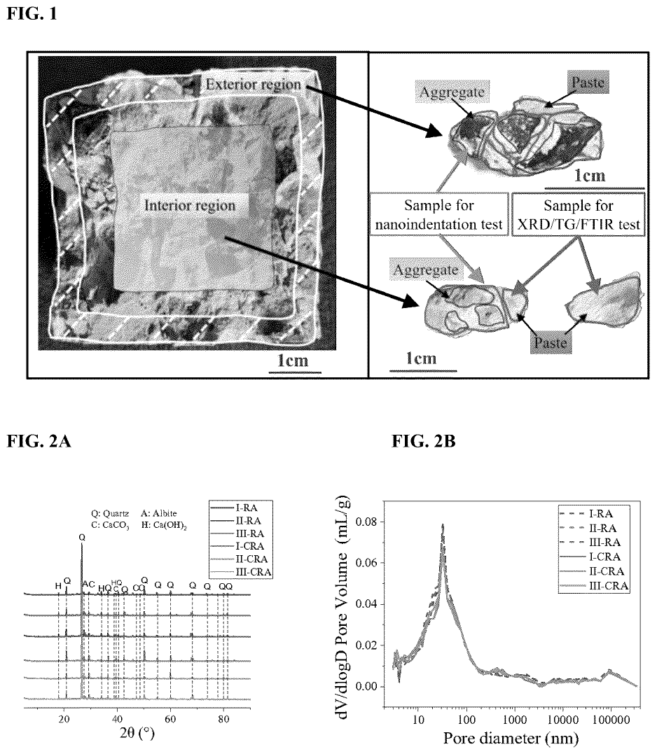

The methods, steps, and/or features thereof disclosed in FIG. 1 or FIG. 3 to FIG. 5 of PCT/US2024/013143 (the entire contents of which is incorporated by reference) may be incorporated into any of the herein-disclosed aspect or embodiment.

In various embodiments, a mixture which is transformed into a cementitious aggregate composition and a reduced salinity water component, may comprise one of the following combinations:
A. (1) brine, (2) CO₂, and (3) a recycled aggregate (RA);
B. (1) brine, (2) CO₂, (3) a recycled aggregate (RA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
C. (1) brine, (2) CO₂, and (3) a carbonated recycled aggregate (CRA);
D. (1) brine, (2) CO₂, (3) carbonated recycled aggregate (CRA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
E (1) brine, (2) CO₂, and (3) a natural pozzolan;
F. (1) brine, (2) CO₂, (3) a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
G. (1) brine, (2) CO₂, and (3) a man-made pozzolan;
H. (1) brine, (2) CO₂, (3) a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
I. (1) brine, (2) CO₂, and (3) a latently hydraulic material;
J. (1) brine, (2) CO₂, (3) a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
K. (1) brine, (2) CO₂, and (3) a recycled aggregate (RA) and a carbonated recycled aggregate (CRA);
L. (1) brine, (2) CO₂, (3) a recycled aggregate (RA) and carbonated recycled aggregate (CRA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
M. (1) brine, (2) CO₂, and (3) a recycled aggregate (RA) and a natural pozzolan;
N. (1) brine, (2) CO₂, (3) a recycled aggregate (RA) and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
O. (1) brine, (2) CO₂, and (3) a recycled aggregate (RA) and a man-made pozzolan;
P. (1) brine, (2) CO₂, (3) a recycled aggregate (RA) and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
Q. (1) brine, (2) CO₂, and (3) a recycled aggregate (RA) and a latently hydraulic material;
R. (1) brine, (2) CO₂, (3) a recycled aggregate (RA) and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
S. (1) brine, (2) CO₂, and (3) a recycled aggregate (RA), a natural pozzolan, and a man-made pozzolan;
T. (1) brine, (2) CO₂, (3) a recycled aggregate (RA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
U. (1) brine, (2) CO₂, and (3) a recycled aggregate (RA), a natural pozzolan, and a latently hydraulic material;
V. (1) brine, (2) CO₂, (3) a recycled aggregate (RA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
W. (1) brine, (2) CO₂, and (3) a recycled aggregate (RA), a man-made pozzolan, and a latently hydraulic material;
X. (1) brine, (2) CO₂, (3) a recycled aggregate (RA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
Y. (1) brine, (2) CO₂, and (3) a recycled aggregate (RA), a natural pozzolan, a man-made pozzolan, and a latently hydraulic material;
Z. (1) brine, (2) CO₂, (3) a recycled aggregate (RA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).
AA. (1) brine, (2) CO₂, and (3) a carbonated recycled aggregate (CRA) and a natural pozzolan;
BB. (1) brine, (2) CO₂, (3) a carbonated recycled aggregate (CRA) and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
CC. (1) brine, (2) CO₂, and (3) a carbonated recycled aggregate (CRA) and a man-made pozzolan;
DD. (1) brine, (2) CO₂, (3) a carbonated recycled aggregate (CRA) and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
EE (1) brine, (2) CO₂, and (3) a carbonated recycled aggregate (CRA) and a latently hydraulic material;
FF. (1) brine, (2) CO₂, (3) a carbonated recycled aggregate (CRA) and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
GG. (1) brine, (2) CO₂, and (3) a carbonated recycled aggregate (CRA), a natural pozzolan, and a man-made pozzolan;
HH. (1) brine, (2) CO₂, (3) a carbonated recycled aggregate (CRA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
II. (1) brine, (2) CO₂, and (3) a carbonated recycled aggregate (CRA), a natural pozzolan, and a latently hydraulic material;
JJ. (1) brine, (2) CO₂, (3) a carbonated recycled aggregate (CRA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
KK. (1) brine, (2) CO₂, and (3) a carbonated recycled aggregate (CRA), a man-made pozzolan, and a latently hydraulic material;
LL. (1) brine, (2) CO₂, (3) a carbonated recycled aggregate (CRA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
MM. (1) brine, (2) CO₂, and (3) a carbonated recycled aggregate (CRA), a natural pozzolan, a man-made pozzolan, and a latently hydraulic material;
NN. (1) brine, (2) CO₂, (3) a carbonated recycled aggregate (CRA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).
OO. (1) brine, (2) CO₂, and (3) a recycled aggregate (RA), a carbonated recycled aggregate (CRA), and a natural pozzolan;
PP. (1) brine, (2) CO₂, (3) a recycled aggregate (RA), a carbonated recycled aggregate (CRA), and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
QQ. (1) brine, (2) CO₂, and (3) a recycled aggregate (RA), a carbonated recycled aggregate (CRA), and a man-made pozzolan;
RR. (1) brine, (2) CO₂, (3) a recycled aggregate (RA), a carbonated recycled aggregate (CRA), and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
SS. (1) brine, (2) CO₂, and (3) a recycled aggregate (RA), a carbonated recycled aggregate (CRA), and a latently hydraulic material;
TT. (1) brine, (2) CO₂, (3) a recycled aggregate (RA), a carbonated recycled aggregate (CRA), and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
UU. (1) brine, (2) CO₂, and (3) a recycled aggregate (RA), a carbonated recycled aggregate (CRA), a natural pozzolan, and a man-made pozzolan;
VV. (1) brine, (2) CO₂, (3) a recycled aggregate (RA), a carbonated recycled aggregate (CRA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
WW. (1) brine, (2) CO₂, and (3) a recycled aggregate (RA), a carbonated recycled aggregate (CRA), a natural pozzolan, and a latently hydraulic material;
XX. (1) brine, (2) CO₂, (3) a recycled aggregate (RA), a carbonated recycled aggregate (CRA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
YY. (1) brine, (2) CO₂, and (3) a recycled aggregate (RA), a carbonated recycled aggregate (CRA), a man-made pozzolan, and a latently hydraulic material;
ZZ. (1) brine, (2) CO₂, (3) a recycled aggregate (RA), a carbonated recycled aggregate (CRA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
AAA. (1) brine, (2) CO₂, and (3) a recycled aggregate (RA), a carbonated recycled aggregate (CRA), a natural pozzolan, a man-made pozzolan, and a latently hydraulic material; or
BBB. (1) brine, (2) CO₂, (3) a recycled aggregate (RA), a carbonated recycled aggregate (CRA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).

In various tank precipitation methods, an activator is preferably included in the combination. In combinations comprising latently hydraulic material, an activator is preferably included in the combination.

Any method or method step disclosed herein is applicable to any other herein-disclosed method or method step. In other words, any aspect or embodiment described herein can be combined with any other aspect or embodiment as disclosed herein.

### Compositions

Another aspect of the present disclosure is a cementitious aggregate composition obtained by any herein-disclosed method.

In embodiments, the cementitious aggregate composition is obtained by a method comprising steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and (b) permitting the combination obtained in step (a) to persist under conditions sufficient to transform the combination into a reduced salinity water component and a cementitious aggregate composition.

In several embodiments, the high salinity brine, CO₂, and a natural pozzolan, a man-made pozzolan, a latently hydraulic material, and/or a recycled aggregate (RA) or a carbonated recycled aggregate (CRA) are combined simultaneously.

In some embodiments, the high salinity brine, CO₂, and a natural pozzolan, a man-made pozzolan, a latently hydraulic material, and/or a recycled aggregate (RA) or a carbonated recycled aggregate (CRA) are combined sequentially with the high salinity brine and CO₂ combined first.

In various embodiments, the high salinity brine, CO₂, and a natural pozzolan, a man-made pozzolan, a latently hydraulic material, and/or a recycled aggregate (RA) or a carbonated recycled aggregate (CRA) are combined sequentially with the CO₂ and the pozzolan combined first.

In numerous embodiments, the high salinity brine, CO₂, and a natural pozzolan, a man-made pozzolan, a latently hydraulic material, and/or a recycled aggregate (RA) or a carbonated recycled aggregate (CRA) are combined sequentially with the high salinity brine and the pozzolan combined first.

In additional embodiments, the high salinity brine is obtained from a desalination facility, is natural seawater, or an industrial brine.

In several embodiments, the salt concentration of the high salinity brine is greater than or about equal to the salt concentration of seawater. In some cases, the salt comprises sodium chloride.

In embodiments, the salt concentration of the reduced salinity water component is less than or about equal to the salt concentration of seawater. In some cases, the salt comprises sodium chloride.

In some embodiments, the salt concentration of the reduced salinity water component is less than the high salinity brine. In various cases, the high salinity brine comprises water with a salt concentration (e.g., chloride, sulphate and sodium) higher than 50 parts per thousand. In some cases, the salt comprises sodium chloride.

In many embodiments, the brine of step (a) has reduced amounts of sodium, potassium, chloride, sulphate, magnesium, and/or calcium ions via chemical precipitation, electrochemical methods, ion selective membranes, reverse osmosis, and/or selective precipitation by pH. In some cases, the chemical precipitation comprises contacting the sodium, potassium, chloride, sulphate, magnesium, and/or calcium ions with lime (calcium hydroxide, Ca(OH)₂) or alum (aluminum sulfate, Al₂(SO₄)₃) which forms insoluble precipitates with the sodium, potassium, chloride, sulphate, magnesium, and/or calcium ions. In various cases, the chemical precipitation occurs before step (a) and/or during step (a).

In various embodiments, the reduced salinity water component is added to a natural or artificial body of water. In some cases, the reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In numerous embodiments, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

In additional embodiments, the method permits production by a desalination facility of a brine having a higher salt concentration relative to a method where the desalination facility produces brine as wastewater to be added to a natural or artificial body of water. In some cases, the relative salt concentration is up to 5-fold higher, e.g., about 1-fold, 2-fold, 3-fold, 4-fold, or about 5-fold and any range or value therebetween.

In several embodiments, the method permits production of more fresh water by a desalination facility relative to a method where the desalination facility produces brine as wastewater to be added to a natural or artificial body of water. In some cases, the amount of fresh water produced is up to 5-fold higher, e.g., about 1-fold, 2-fold, 3-fold, 4-fold, or about 5-fold and any range or value therebetween.

In embodiments, the steps (a) and/or (b) occurs in a location within the desalination facility, adjacent to the desalination facility, or downstream from the desalination facility. In some cases, step (a) and/or step (b) occurs in a pipeline within the desalination facility, adjacent to the desalination facility, or downstream from the desalination facility. In certain cases, the pressure in step (b) is applied to the pipeline utilizing a series of pipe reducers. In various cases, a pipe reducer is a mechanical device used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

In some embodiments, the steps (a) and/or (b) occurs in a location distant from the desalination facility. In some cases, step (a) and/or step (b) occurs in a pipeline within the desalination facility, adjacent to the desalination facility, or downstream from the desalination facility. In certain cases, the pressure in step (b) is applied to the pipeline utilizing a series of pipe reducers.

In various cases, a pipe reducer is a mechanical device used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

In embodiments, the pipeline is between about 12 inches and about 18 inches in diameter. In many embodiments, the steps (a) and/or (b) occurs in a location within the desalination facility, adjacent to the desalination facility, or downstream from the desalination facility and steps (a) and/or (b) occurs in a tank or basin.

In various embodiments, the steps (a) and/or (b) occurs in a location distant from the desalination facility and steps (a) and/or (b) occurs in a tank or basin.

In numerous embodiments, the pozzolan comprises silica (SiO₂), alumina (Al₂O₃), and/or iron oxide (Fe₂O₃).

In embodiments, the pozzolan is a natural pozzolan or a man-made pozzolan.

In additional embodiments, the pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

In several embodiments, use of pozzolan avoids the problem of sourcing cementitious material that is used in standard concrete manufacturing. In some cases, avoiding the problem of sourcing cementitious material further reduces the amount of energy required and/or waste CO₂ produced relative to standard concrete manufacturing. Without wishing to be bound by theory, while standard cement manufacturing is responsible for about 10% of the world's CO₂ emissions.

In embodiments, the cementitious aggregate composition absorbs more carbon dioxide during its manufacture than is emitted.

In some embodiments, the cementitious aggregate composition absorbs and/or retains at least 0.04 kg CO₂ per kg of composition.

In any embodiment, the CO₂ is chemically reacted to form a crystalline form of carbon. In various embodiments, the CO₂ is absorbed into the aggregate cementitious as a crystalline form of carbon. Thus, the CO₂ is permanently removed from the atmosphere. In many embodiments, the CO₂ of step (a) is from industrial waste, from environmental sources, or from molecular capture. In some cases, the industrial waste relates to alcoholic fermentation or the burning of fossil fuels.

In various embodiments, the CO₂ of step (a) is provided in gaseous, solid, and/or as a supercritical fluid form or as a dissolved gas.

In numerous embodiments, the CO₂ of step (a) is incorporated into the cementitious aggregate composition as a carbonate. Without wishing to be bound by theory, when CO₂ reacts with calcium hydroxide (Ca(OH)₂), which is commonly present in cementitious systems, it can form calcium carbonate (CaCO₃). This reaction contributes to the hardening of the cementitious aggregate composition, making it more durable and cementitious in nature.

In additional embodiments, step (a) further comprises adding an activator. In various cases, the activator may be any sodium, lithium or potassium salt or hydroxide and any alkali or alkali earth metal ions. In some cases, the activator is Mg(OH)₂, MgO, Ca(OH)₂, CaCO₃, Al₂(SO₄)₃, and/or CaO.

In various tank precipitation methods, an activator is preferably included in the combination. In combinations comprising latently hydraulic material, an activator is preferably included in the combination.

In several embodiments, the cementitious aggregate composition forms particles of various shapes, sizes, and textures. In some cases, the particles have average sizes ranging from 0.0625 mm to about 40.0 mm in diameter. In various cases, the particles have generally rounded or oval shapes. The particles may comprise pores. In certain cases, the particles comprise more numerous pores per unit volume and/or larger average pores than a standard cement. The particles may be less dense per unit volume than a standard cement.

In embodiments, the particle has a diameter of about 0.0625 mm to about 40.0 mm. In embodiments the particle has a diameter of 0.0625 mm, 0.075 mm, 0.0825 mm, 0.0900 mm, 0.125 mm, 0.187 mm, 0.250 mm, 0.312 mm, 0.375 mm, 0.437 mm, 0.500 mm, 0.562 mm, 0.625 mm, 0.687 mm, 0.750 mm, 0.812 mm, 0.875, 0.937 mm, 1.00 mm, 1.0625 mm, 1.075 mm, 1.0825 mm, 1.0900 mm, 1.125 mm, 1.187 mm, 1.250 mm, 1.312 mm, 1.375 mm, 1.437 mm, 1.500 mm, 1.562 mm, 1.625 mm, 1.687 mm, 1.750 mm, 1.812 mm, 1.875, 1.937 mm, 2.00 mm, 2.0625 mm, 2.075 mm, 2.0825 mm, 2.0900 mm, 2.125 mm, 2.187 mm, 2.250 mm, 2.312 mm, 2.375 mm, 2.437 mm, 2.500 mm, 2.562 mm, 2.625 mm, 2.687 mm, 2.750 mm, 2.812 mm, 2.875, 2.937 mm, 3.00 mm, 3.0625 mm, 3.075 mm, 3.0825 mm, 3.0900 mm, 3.125 mm, 3.187 mm, 3.250 mm, 3.312 mm, 3.375 mm, 3.437 mm, 3.500 mm, 3.562 mm, 3.625 mm, 3.687 mm, 3.750 mm, 3.812 mm, 3.875, 3.937 mm, 4.00 mm, 4.0625 mm, 4.075 mm, 4.0825 mm, 4.0900 mm, 4.125 mm, 4.187 mm, 4.250 mm, 4.312 mm, 4.375 mm, 4.437 mm, 4.500 mm, 4.562 mm, 4.625 mm, 4.687 mm, 4.750 mm, 4.812 mm, 4.875, 4.937 mm, 5.00 mm, 5.0625 mm, 5.075 mm, 5.0825 mm, 5.0900 mm, 5.125 mm, 5.187 mm, 5.250 mm, 5.312 mm, 5.375 mm, 5.437 mm, 5.500 mm, 5.562 mm, 5.625 mm, 5.687 mm, 5.750 mm, 5.812 mm, 5.875, 5.937 mm, 6.00 mm, 6.50 mm, 7.00 mm, 7.50 mm, 8.00 mm, 8.50 mm, 9.00 mm, 9.50 mm, 10.0 mm, 10.5 mm, 11.0 mm, 11.5 mm, 12.0 mm, 12.5 mm, 13.0 mm, 13.5 mm, 14.0 mm, 14.5, mm, 15.0 mm, 15.5 mm, 16.0 mm, 16.5 mm, 17.0 mm, 17.5 mm, 18.0 mm, 18.5 mm, 19.0 mm, 19.5 mm, 20.0 mm, 21.5 mm, 22.0 mm, 22.5 mm, 23.0 mm, 23.5 mm, 24.0 mm, 24.5, mm, 25.0 mm, 25.5 mm, 26.0 mm, 26.5 mm, 27.0 mm, 27.5 mm, 28.0 mm, 28.5 mm, 29.0 mm, 29.5 mm, 30.0 mm, 30.5 mm, 31.0 mm, 31.5 mm, 32.0 mm, 32.5 mm, 33.0 mm, 33.5 mm, 34.0 mm, 34.5, mm, 35.0 mm, 35.5 mm, 36.0 mm, 36.5 mm, 37.0 mm, 37.5 mm, 38.0 mm, 38.5 mm, 39.0 mm, 39.5 mm, 40.0 mm; or values between the foregoing ranges including endpoints.

In embodiments, the cementitious aggregate composition comprises more CO₂ per gram than a standard cement. In some cases, the cementitious aggregate composition comprises up to 50% more CO₂ per gram than a standard cement.

In some embodiments, the cementitious aggregate composition comprises more calcium, silicon, aluminum, magnesium and/or iron per gram than a standard cement. In some cases, the cementitious aggregate composition comprises up to 50% more calcium, silicon, aluminum, magnesium and/or iron per gram than a standard cement.

In many embodiments, the standard cement comprises CaO, CaCO₃, SiO₂, Al₂O₃, Fe₂O₃, and CaSO₄·H₂O.

In various embodiments, the standard cement comprises a slaked or hydraulic dolomitic or calcareous lime blended with a natural or man-made pozzolanic or latently hydraulic material. In numerous embodiments, the standard cement, e.g., a standard hydrated cement, is a Portland Cement comprising cement clinker rather than pozzolan.

In additional embodiments, the cementitious aggregate composition is deposited into a natural or artificial body of water. In some cases, when deposited into the natural or artificial body of water, the cementitious aggregate composition remains where deposited or when deposited into the natural or artificial body of water, a portion of the cementitious aggregate composition is distributed away from the deposit site. In various cases, the cementitious aggregate composition is distributed away from the deposit site by water movement or currents, erosion, or animal activity. In numerous cases, the cementitious aggregate composition permits attachment by flora, e.g., algae, and/or fauna, e.g., coral. In many cases, the cementitious aggregate composition permits a preferred level of colonization by flora and/or fauna relative to a standard cement and/or the cementitious aggregate composition permits more plentiful attachment by flora and/or fauna relative to a standard cement.

In embodiments, the cementitious aggregate composition comprises any sodium, lithium or Potassium salt or hydroxide and any alkali or alkali earth metal ions and including Mg(OH)₂, MgO, Ca(OH)₂, CaCO₃, Al₂(SO₄)₃, CaO, CaSO₄·H₂O, SiO₂, Fe₂O₃, Al₂O₃ and/or Brucite.

In several embodiments, the cementitious aggregate composition comprises MgO. In some cases, the cementitious aggregate composition does not substantially comprise MgO obtained from a calcination reaction.

The cementitious aggregate composition be used in any way that another cementitious aggregates can be used.

In some embodiments, step (b) produces exothermic heat. In some cases, the exothermic heat is transformable from thermal energy into electrical energy.

In many embodiments, the pressure in step (b) is from about ambient (1 bar) to about 250 bar. In various embodiments, the pressure in step (b) is from about 100 bar to about 250 bar. As examples, the pressure in about 101 bar, 102 bar, 103 bar, 104 bar, 105 bar, 106 bar, 107 bar, 108 bar, 109 bar, 110 bar, 111 bar, 112 bar, 113 bar, 114 bar, 115 bar, 116 bar, 117 bar, 118 bar, 119 bar, 120 bar, 121 bar, 122 bar, 123 bar, 124 bar, 125 bar, 126 bar, 127 bar, 128 bar, 129 bar, 130 bar, 131 bar, 132 bar, 133 bar, 134 bar, 135 bar, 136 bar, 137 bar, 138 bar, 139 bar, 140 bar, 141 bar, 142 bar, 143 bar, 144 bar, 145 bar, 146 bar, 147 bar, 148 bar, 149 bar, 150 bar, 151 bar, 152 bar, 153 bar, 154 bar, 155 bar, 156 bar, 157 bar, 158 bar, 159 bar, 160 bar, 161 bar, 162 bar, 163 bar, 164 bar, 165 bar, 166 bar, 167 bar, 168 bar, 169 bar, 170 bar, 171 bar, 172 bar, 173 bar, 174 bar, 175 bar, 176 bar, 177 bar, 178 bar, 179 bar, 180 bar, 181 bar, 182 bar, 183 bar, 184 bar, 185 bar, 186 bar, 187 bar, 188 bar, 189 bar, 190 bar, 191 bar, 192 bar, 193 bar, 194 bar, 195 bar, 196 bar, 197 bar, 198 bar, 199 bar, 200 bar, 101 bar, 202 bar, 203 bar, 204 bar, 205 bar, 206 bar, 207 bar, 208 bar, 209 bar, 210 bar, 211 bar, 212 bar, 213 bar, 214 bar, 215 bar, 216 bar, 217 bar, 218 bar, 219 bar, 220 bar, 221 bar, 222 bar, 223 bar, 224 bar, 225 bar, 226 bar, 227 bar, 228 bar, 229 bar, 230 bar, 231 bar, 232 bar, 233 bar, 234 bar, 235 bar, 236 bar, 237 bar, 238 bar, 239 bar, 240 bar, 241 bar, 242 bar, 243 bar, 244 bar, 245 bar, 246 bar, 247 bar, 248 bar, 249 bar, or about 250 bar, and any range or value therebetween.

In numerous embodiments, the pressure in step (b) is from about ambient (1 bar) to about 100 bar. As examples, the pressure is about 1 bar, 2 bar, 3 bar, 4 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 31 bar, 32 bar, 33 bar, 34 bar, 35 bar, 36 bar, 37 bar, 38 bar, 39 bar, 40 bar, 41 bar, 42 bar, 43 bar, 44 bar, 45 bar, 46 bar, 47 bar, 48 bar, 49 bar, 50 bar, 51 bar, 52 bar, 53 bar, 54 bar, 55 bar, 56 bar, 57 bar, 58 bar, 59 bar, 60 bar, 61 bar, 62 bar, 63 bar, 64 bar, 65 bar, 66 bar, 67 bar, 68 bar, 69 bar, 70 bar, 71 bar, 72 bar, 73 bar, 74 bar, 75 bar, 76 bar, 77 bar, 78 bar, 79 bar, 80 bar, 81 bar, 82 bar, 83 bar, 84 bar, 85 bar, 86 bar, 87 bar, 88 bar, 89 bar, 90 bar, 91 bar, 92 bar, 93 bar, 94 bar, 95 bar, 96 bar, 97 bar, 98 bar, 99 bar, or about 100 bar, and any range or value therebetween.

In various embodiments, the pressure in step (b) is greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. In various cases the pressure in step (b) is greater than 250 bar, 260 bar, 270 bar, 280 bar, 290 bar, 300 bar, 310 bar, 320 bar, 330 bar, 340 bar, 350 bar, 360 bar, 370 bar, 380 bar, 390 bar, 400 bar, 410 bar, 420 bar, 430 bar, 440 bar, 450 bar, 460 bar, 470 bar, 480 bar, 490 bar, 500 bar and any range or value therebetween. The pressure in step (b) may be greater than 500 bar, 510 bar, 520 bar, 530 bar, 540 bar, 550 bar, 560 bar, 570 bar, 580 bar, 590 bar, 600 bar, 610 bar, 620 bar, 630 bar, 640 bar, 650 bar, 660 bar, 670 bar, 680 bar, 690 bar, 700 bar, 710 bar, 720 bar, 730 bar, 740 bar, 750 bar, 760 bar, 770 bar, 780 bar, 790 bar, 800 bar, 810 bar, 820 bar, 830 bar, 840 bar, 850 bar, 860 bar, 870 bar, 880 bar, 890 bar, 900 bar, 910 bar, 920 bar, 930 bar, 940 bar, 950 bar, 960 bar, 970 bar, 980 bar, 990 bar, 1000 bar and any range or value therebetween.

In additional embodiments, the temperature of step (a) and/or step (b) is from about 1° C. to about 100° C. As examples, the temperature is about 1° C., 2° C., 3° C., 4° C., 5° C., 6° C., 7° C., 8° C., 9º° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., or about 100° C., and any range or value therebetween.

In several embodiments, the duration of step (b) is from about 1 minute to about 10 hours. As examples the duration is about 10 minutes, 20 minutes, 30 minutes, 40 minutes, 50 minutes, 60 minutes, 70 minutes, 80 minutes, 90 minutes, 2 hours, 3 hours, 4 hours, 5 hours, 6 hours, 7 hours, 8 hours, 9 hours, or about 10 hours, and any range or value therebetween. In embodiments, the duration of step (b) is from about 1 minute to about 10 minutes. As examples the duration is about 1 minute, 2 minutes, 3 minutes, 4 minutes, 5 minutes, 6 minutes, 7 minutes, 8 minutes, 9 minutes, or about 10 minutes, and any range or value therebetween. In numerous embodiments, the ratio (weight to weight or weight to volume or volume to volume) of the high salinity brine to a natural pozzolan, a man-made pozzolan, a latently hydraulic material, and/or a recycled aggregate (RA) or a carbonated recycled aggregate (CRA) varies from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In various embodiments, the ratio (weight to weight or weight to volume or volume to volume) of the high salinity brine to CO₂ varies from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In embodiments, the ratio (weight to weight or weight to volume or volume to volume) of the natural pozzolan, the man-made pozzolan, the latently hydraulic material, and/or the recycled aggregate (RA) or the carbonated recycled aggregate (CRA) to CO₂ varies from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In some embodiments, a filler material or another additive is added to the combination of step (a). In some cases, the filler material or the other additive comprises sand, gravel, lightweight aggregate, recycled aggregate (RA), carbonated recycled aggregate (CRA), or crushed stone, and a combination thereof.

In numerous embodiments, the ratio (weight to weight or weight to volume or volume to volume) of the aggregate to each of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In embodiments, the ratio (weight to weight or weight to volume or volume to volume) of the aggregate to the combined weight or volume of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween. In many embodiments, the latently hydraulic material is a slag. In some cases, the slag is added in step (a) in addition to the added pozzolan. In alternate cases, the slag is added in step (a) instead of pozzolan. In some cases, the slag is added in step (a) instead of an activator.

In embodiments, the method further comprises isolating the cementitious aggregate composition from the reduced salinity water component or other liquid components. In some cases, the isolating comprises straining to capture the cementitious aggregate composition.

In various embodiments, the cementitious aggregate composition is molded into a shaped cementitious composition. Without wishing to be bound by theory, particles of the cementitious aggregate composition can stick to each other, thereby permitting the molding of the composition into shapes. In some case, molding may not require an additional binder to keep the molded shape and in other cases, molding may require an additional binder to keep the molded shape. In some cases, the shaped cementitious composition permits attachment by flora, e.g., algae, and/or fauna, e.g., coral, relative to a standard cement. In various cases, the shaped cementitious composition permits stronger attachment by flora and/or fauna relative to a standard cement and/or the shaped cementitious composition permits more plentiful attachment by flora and/or fauna relative to a standard cement. When molded, the shaped cementitious composition comprises gaps between particles of the aggregate such that the shaped cementitious composition has a more porous surface, is more porous throughout its volume, and is less dense than a standard cement. The gaps of a shaped cementitious composition may be up to 500 nm in diameter. Additionally, a shaped cementitious composition may have up to 85% of the volume being void (e.g., the sum of all gaps) whereas a standard cement may have about 40% of the volume being void.

The shape of the shaped cementitious composition may be any shape capable of providing a substrate for aquatic flora and/or fauna attachment. The shape could be planar, circular, rounded, elongated, flat, rectangular, or any combination thereof. In some embodiments, the shape is pyramidal with closed surfaces. In other embodiments, the shape is pyramidal with open surfaces such that the shape comprises four bars or cylinders that form a square base and four bars or cylinders each originating at a corner of the square and converging to form the pyramid's apex.

The shaped cementitious aggregate composition be used in any way that any cement can be used.

In many embodiments, the cementitious composition further comprises at least one filler material or other additive, the at least one filler or other additive can be pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

In some embodiments, the ratio (weight to weight or weight to volume or volume to volume) of the filler material or other additive to each of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween. In embodiments, the ratio (weight to weight or weight to volume or volume to volume) of the filler material or other additive to the combined weight or volume of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In another aspect, the present disclosure provides a cementitious aggregate composition comprising more CO₂ per gram and/or calcium, silicon, aluminum, magnesium and/or iron per gram than a standard cement. In some cases, the cementitious aggregate composition comprises up to 50% more CO₂ per gram than a standard cement. In various cases, the cementitious aggregate composition comprises up to 50% more calcium, silicon, aluminum, magnesium and/or iron per gram than a standard cement.

The cementitious aggregate composition is obtained by any herein-disclosed method, e.g., a method comprising steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and (b) permitting the combination obtained in step (a) to persist under conditions sufficient to transform the combination into a reduced salinity water component and a cementitious aggregate composition.

In some embodiments, the standard cement is a Portland Cement comprising cement clinker rather than a pozzolan.

In various embodiments, the standard cement comprises CaO, CaCO₃, SiO₂, Al₂O₃, Fe₂O₃, and CaSO₄·H₂O.

In many embodiments, the standard cement comprises a slaked or hydraulic dolomitic or calcareous lime blended with a natural or man-made pozzolanic or latently hydraulic material.

In numerous embodiments, the standard cement, e.g., a standard hydrated cement, is a Portland Cement comprising cement clinker rather than pozzolan.

In a further aspect, the present disclosure provides a cementitious aggregate composition comprising more numerous pores per unit volume and/or larger average pores than a standard cement. The cementitious aggregate composition is obtained by any herein-disclosed method, e.g., a method comprising steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and (b) permitting the combination obtained in step (a) to persist under conditions sufficient to transform the combination into a reduced salinity water component and a cementitious aggregate composition.

In some embodiments, the standard cement is a Portland Cement comprising cement clinker rather than a pozzolan.

In various embodiments, the standard cement comprises CaO, CaCO₃, SiO₂, Al₂O₃, Fe₂O₃, and CaSO₄·H₂O.

In many embodiments, the standard cement comprises a slaked or hydraulic dolomitic or calcareous lime blended with a natural or man-made pozzolanic or latently hydraulic material. In numerous embodiments, the standard cement, e.g., a standard hydrated cement, is a Portland Cement comprising cement clinker rather than pozzolan.

In an additional aspect, the present disclosure provides a cementitious aggregate composition that is less dense per unit volume than a standard cement. The cementitious aggregate composition is obtained by any herein-disclosed method, e.g., a method comprising steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and (b) permitting the combination obtained in step (a) to persist under conditions sufficient to transform the combination into a reduced salinity water component and a cementitious aggregate composition.

In some embodiments, the standard cement is a Portland Cement comprising cement clinker rather than a pozzolan.

In various embodiments, the standard cement comprises CaO, CaCO₃, SiO₂, Al₂O₃, Fe₂O₃, and CaSO₄·H₂O.

In many embodiments, the standard cement comprises a slaked or hydraulic dolomitic or calcareous lime blended with a natural or man-made pozzolanic or latently hydraulic material. In numerous embodiments, the standard cement, e.g., a standard hydrated cement, is a Portland Cement comprising cement clinker rather than pozzolan.

An additional aspect of the present disclosure is a shaped cementitious composition obtained by any herein-disclosed method. The cementitious aggregate composition is obtained by any herein-disclosed method, e.g., a method comprising steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and (b) permitting the combination obtained in step (a) to persist under conditions sufficient to transform the combination into a reduced salinity water component and a cementitious aggregate composition. The cementitious aggregate composition is molded into a shaped cementitious composition.

In various embodiments, the shaped cementitious composition permits attachment by flora, e.g., algae, and/or fauna, e.g., coral, relative to a standard cement. In various cases, the shaped cementitious composition permits stronger attachment by flora and/or fauna relative to a standard cement and/or the shaped cementitious composition permits more plentiful attachment by flora and/or fauna relative to a standard cement.

In some embodiments, a filler material or another additive is added to the combination of step (a). In some cases, the filler material or the other additive comprises sand, gravel, lightweight aggregate, recycled aggregate (RA), carbonated recycled aggregate (CRA), or crushed stone, and a combination thereof.

In numerous embodiments, the ratio (weight to weight or weight to volume or volume to volume) of the aggregate to each of the high salinity brine, CO₂, and t the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In embodiments, the ratio (weight to weight or weight to volume or volume to volume) of the aggregate to the combined weight or volume of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

In many embodiments, the latently hydraulic material is a slag. In some cases, the slag is added in step (a) in addition to the added pozzolan. In alternate cases, the slag is added in step (a) instead of pozzolan. In some cases, the slag is added in step (a) instead of an activator. In embodiments, the method further comprises isolating the cementitious aggregate composition from the reduced salinity water component or other liquid components. In some cases, the isolating comprises straining to capture the cementitious aggregate composition.

In various embodiments, the cementitious aggregate composition is molded into a shaped cementitious composition. Without wishing to be bound by theory, particles of the cementitious aggregate composition can stick to each other, thereby permitting the molding of the composition into shapes. In some case, molding may not require an additional binder to keep the molded shape and in other cases, molding may require an additional binder to keep the molded shape. In some cases, the shaped cementitious composition permits attachment by flora, e.g., algae, and/or fauna, e.g., coral, relative to a standard cement. In various cases, the shaped cementitious composition permits stronger attachment by flora and/or fauna relative to a standard cement and/or the shaped cementitious composition permits more plentiful attachment by flora and/or fauna relative to a standard cement. When molded, the shaped cementitious composition comprises gaps between particles of the aggregate such that the shaped cementitious composition has a more porous surface, is more porous throughout its volume, and is less dense than a standard cement. The gaps of a shaped cementitious composition may be up to 500 nm in diameter. Additionally, a shaped cementitious composition may have up to 85% of the volume being void (e.g., the sum of all gaps) whereas a standard cement may have about 40% of the volume being void.

The shape of the shaped cementitious composition may be any shape capable of providing a substrate for aquatic flora and/or fauna attachment. The shape could be planar, circular, rounded, elongated, flat, rectangular, or any combination thereof. In some embodiments, the shape is pyramidal with closed surfaces. In other embodiments, the shape is pyramidal with open surfaces such that the shape comprises four bars or cylinders that form a square base and four bars or cylinders each originating at a corner of the square and converging to form the pyramid's apex.

In many embodiments, the cementitious composition further comprises at least one filler material or other additive, the at least one filler or other additive is selected from the following: pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

In some embodiments, the ratio (weight to weight or weight to volume or volume to volume) of the filler material or other additive to each of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween. In embodiments, the ratio (weight to weight or weight to volume or volume to volume) of the filler material or other additive to the combined weight or volume of the high salinity brine, CO₂, and the natural pozzolan, the man-made pozzolan, the latently hydraulic material, and/or the recycled aggregate (RA) or the carbonated recycled aggregate (CRA) is from 1:100 to 100:1. As examples the ratio is about 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:51, 1:52, 1:53, 1:54, 1:55, 1:56, 1:57, 1:58, 1:59, 1:60, 1:61, 1:62, 1:63, 1:64, 1:65, 1:66, 1:67, 1:68, 1:69, 1:70, 1:71, 1:72, 1:73, 1:74, 1:75, 1:76, 1:77, 1:78, 1:79, 1:80, 1:81, 1:82, 1:83, 1:84, 1:85, 1:86, 1:87, 1:88, 1:89, 1:90, 1:91, 1:92, 1:93, 1:94, 1:95, 1:96, 1:97, 1:98, 1:99, 1:100, 100:1, 99:1, 98:1, 97:1, 96:1, 95:1, 94:1, 93:1, 92:1, 91:1, 90:1, 89:1, 88:1, 87:1, 86:1, 85:1, 84:1, 83:1, 82:1, 81:1, 80:1, 79:1, 78:1, 77:1, 76:1, 75:1, 74:1, 73:1, 72:1, 71:1, 70:1, 69:1, 68:1, 67:1, 66:1, 65:1, 64:1, 63:1, 62:1, 61:1, 60:1, 59:1, 58:1, 57:1, 56:1, 55:1, 54:1, 53:1, 52:1, 51:1, 50:1, 49:1, 48:1, 47:1, 46:1, 45:1, 44:1, 43:1, 42:1, 41:1, 40:1, 39:1, 38:1, 37:1, 36:1, 35:1, 34:1, 33:1, 32:1, 31:1, 30:1, 29:1, 28:1, 27:1, 26:1, 25:1, 24:1, 23:1, 22:1, 21:1, 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, or about 1:1 and any range or value therebetween.

The methods, steps, and/or features thereof disclosed in FIG. 1 or FIG. 3 to FIG. 5 of PCT/US2024/013143 (the entire contents of which is incorporated by reference) may be used to produce a composition of any herein-disclosed aspect or embodiment.

In various embodiments, a mixture which is transformed into a cementitious aggregate composition and a reduced salinity water component, may comprise one of the following combinations:
A. (1) brine, (2) CO₂, and (3) a recycled aggregate (RA);
B. (1) brine, (2) CO₂, (3) a recycled aggregate (RA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
C. (1) brine, (2) CO₂, and (3) a carbonated recycled aggregate (CRA);
D. (1) brine, (2) CO₂, (3) carbonated recycled aggregate (CRA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
E. (1) brine, (2) CO₂, and (3) a natural pozzolan;
F. (1) brine, (2) CO₂, (3) a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
G. (1) brine, (2) CO₂, and (3) a man-made pozzolan;
H. (1) brine, (2) CO₂, (3) a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
I. (1) brine, (2) CO₂, and (3) a latently hydraulic material;
J. (1) brine, (2) CO₂, (3) a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
K. (1) brine, (2) CO₂, and (3) a recycled aggregate (RA) and a carbonated recycled aggregate (CRA);
L. (1) brine, (2) CO₂, (3) a recycled aggregate (RA) and carbonated recycled aggregate (CRA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
M. (1) brine, (2) CO₂, and (3) a recycled aggregate (RA) and a natural pozzolan;
N. (1) brine, (2) CO₂, (3) a recycled aggregate (RA) and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
O. (1) brine, (2) CO₂, and (3) a recycled aggregate (RA) and a man-made pozzolan;
P. (1) brine, (2) CO₂, (3) a recycled aggregate (RA) and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
Q. (1) brine, (2) CO₂, and (3) a recycled aggregate (RA) and a latently hydraulic material;
R. (1) brine, (2) CO₂, (3) a recycled aggregate (RA) and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
S. (1) brine, (2) CO₂, and (3) a recycled aggregate (RA), a natural pozzolan, and a man-made pozzolan;
T. (1) brine, (2) CO₂, (3) a recycled aggregate (RA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
U. (1) brine, (2) CO₂, and (3) a recycled aggregate (RA), a natural pozzolan, and a latently hydraulic material;
V. (1) brine, (2) CO₂, (3) a recycled aggregate (RA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
W. (1) brine, (2) CO₂, and (3) a recycled aggregate (RA), a man-made pozzolan, and a latently hydraulic material;
X. (1) brine, (2) CO₂, (3) a recycled aggregate (RA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
Y. (1) brine, (2) CO₂, and (3) a recycled aggregate (RA), a natural pozzolan, a man-made pozzolan, and a latently hydraulic material;
Z. (1) brine, (2) CO₂, (3) a recycled aggregate (RA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).
AA. (1) brine, (2) CO₂, and (3) a carbonated recycled aggregate (CRA) and a natural pozzolan;
BB. (1) brine, (2) CO₂, (3) a carbonated recycled aggregate (CRA) and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
CC. (1) brine, (2) CO₂, and (3) a carbonated recycled aggregate (CRA) and a man-made pozzolan;
DD. (1) brine, (2) CO₂, (3) a carbonated recycled aggregate (CRA) and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
EE. (1) brine, (2) CO₂, and (3) a carbonated recycled aggregate (CRA) and a latently hydraulic material;
FF. (1) brine, (2) CO₂, (3) a carbonated recycled aggregate (CRA) and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
GG. (1) brine, (2) CO₂, and (3) a carbonated recycled aggregate (CRA), a natural pozzolan, and a man-made pozzolan;
HH. (1) brine, (2) CO₂, (3) a carbonated recycled aggregate (CRA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
II. (1) brine, (2) CO₂, and (3) a carbonated recycled aggregate (CRA), a natural pozzolan, and a latently hydraulic material;
JJ. (1) brine, (2) CO₂, (3) a carbonated recycled aggregate (CRA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
KK. (1) brine, (2) CO₂, and (3) a carbonated recycled aggregate (CRA), a man-made pozzolan, and a latently hydraulic material;
LL. (1) brine, (2) CO₂, (3) a carbonated recycled aggregate (CRA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
MM. (1) brine, (2) CO₂, and (3) a carbonated recycled aggregate (CRA), a natural pozzolan, a man-made pozzolan, and a latently hydraulic material;
NN. (1) brine, (2) CO₂, (3) a carbonated recycled aggregate (CRA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).
OO. (1) brine, (2) CO₂, and (3) a recycled aggregate (RA), a carbonated recycled aggregate (CRA), and a natural pozzolan;
PP. (1) brine, (2) CO₂, (3) a recycled aggregate (RA), a carbonated recycled aggregate (CRA), and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
QQ. (1) brine, (2) CO₂, and (3) a recycled aggregate (RA), a carbonated recycled aggregate (CRA), and a man-made pozzolan;
RR. (1) brine, (2) CO₂, (3) a recycled aggregate (RA), a carbonated recycled aggregate (CRA), and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
SS. (1) brine, (2) CO₂, and (3) a recycled aggregate (RA), a carbonated recycled aggregate (CRA), and a latently hydraulic material;
TT. (1) brine, (2) CO₂, (3) a recycled aggregate (RA), a carbonated recycled aggregate (CRA), and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
UU. (1) brine, (2) CO₂, and (3) a recycled aggregate (RA), a carbonated recycled aggregate (CRA), a natural pozzolan, and a man-made pozzolan;
VV. (1) brine, (2) CO₂, (3) a recycled aggregate (RA), a carbonated recycled aggregate (CRA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
WW. (1) brine, (2) CO₂, and (3) a recycled aggregate (RA), a carbonated recycled aggregate (CRA), a natural pozzolan, and a latently hydraulic material;
XX. (1) brine, (2) CO₂, (3) a recycled aggregate (RA), a carbonated recycled aggregate (CRA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
YY. (1) brine, (2) CO₂, and (3) a recycled aggregate (RA), a carbonated recycled aggregate (CRA), a man-made pozzolan, and a latently hydraulic material;
ZZ. (1) brine, (2) CO₂, (3) a recycled aggregate (RA), a carbonated recycled aggregate (CRA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
AAA. (1) brine, (2) CO₂, and (3) a recycled aggregate (RA), a carbonated recycled aggregate (CRA), a natural pozzolan, a man-made pozzolan, and a latently hydraulic material; or
BBB. (1) brine, (2) CO₂, (3) a recycled aggregate (RA), a carbonated recycled aggregate (CRA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).

In various cementitious aggregate compositions obtained by a tank precipitation method, an activator is preferably included in the combination.

Any composition or component thereof, or method for manufacturing a composition or component thereof, or reagent used in a method for manufacturing a composition or component thereof disclosed herein is applicable to any herein-disclosed composition, component, method or reagent. In other words, any aspect or embodiment described herein can be combined with any other aspect or embodiment as disclosed herein.

### Pozzolans

Without being bound by theory, particle size of the pozzolan(s) may affect reactivity of the material. For example, smaller particle size may provide increased reactivity. The pozzolan(s) may be provided at any particle size. In embodiments, at least about 90% of the particles of the pozzolan(s) fit through a mesh size of about #120 to about #1200. In embodiments, at least about 90% of the particles of the pozzolan(s) fit through a mesh size of about #120 to about #1000. In embodiments, at least about 90% of the particles of the pozzolan(s) fit through a mesh size of about #120 to about #800. In embodiments, at least about 90% of the particles of the pozzolan(s) fit through a mesh size of about #120 to about #600. In embodiments, at least about 90% of the particles of the pozzolan(s) fit through a mesh size of about #120 to about #400. In embodiments, at least about 90% of the particles of the pozzolan(s) fit through a mesh size of about #120 to about #325. In embodiments, at least about 90% of the particles of the pozzolan(s) fit through a mesh size of about #200 to about #1200. In embodiments, at least about 90% of the particles of the pozzolan(s) fit through a mesh size of about #200 to about #1000. In embodiments, at least about 90% of the particles of the pozzolan(s) fit through a mesh size of about #200 to about #800. In embodiments, at least about 90% of the particles of the pozzolan(s) fit through a mesh size of about #200 to about #700. In embodiments, at least about 90% of the particles of the pozzolan(s) fit through a mesh size of about #200 to about #600. In embodiments, at least about 90% of the particles of the pozzolan(s) fit through a mesh size of about #200 to about #500. In embodiments, at least about 90% of the particles of the pozzolan(s) fit through a mesh size of about #200 to about #400. In embodiments, at least about 90% of the particles of the pozzolan(s) fit through a mesh size of about #200 to about #325. Mesh size can be any value or subrange within the recited ranges.

In embodiments, at least about 95% of the particles of the pozzolan(s) fit through a mesh size of about #120 to about #1200. In embodiments, at least about 96% of the particles of the pozzolan(s) fit through a mesh size of about #120 to about #1200. In embodiments, at least about 97% of the particles of the pozzolan(s) fit through a mesh size of about #120 to about #1200. In embodiments, at least about 98% of the particles of the pozzolan(s) fit through a mesh size of about #120 to about #1200. In embodiments, at least about 99% of the particles of the pozzolan(s) fit through a mesh size of about #120 to about #1200. In embodiments, at least about 98% of the particles of the pozzolan(s) fit through a mesh size of about #120 to about #1000. In embodiments, at least about 98% of the particles of the pozzolan(s) fit through a mesh size of about #120 to about #800. In embodiments, at least about 98% of the particles of the pozzolan(s) fit through a mesh size of about #120 to about #600. In embodiments, at least about 98% of the particles of the pozzolan(s) fit through a mesh size of about #120 to about #400. In embodiments, at least about 98% of the particles of the pozzolan(s) fit through a mesh size of about #120 to about #325. In embodiments, at least about 98% of the particles of the pozzolan(s) fit through a mesh size of about #200 to about #1200. In embodiments, at least about 98% of the particles of the pozzolan(s) fit through a mesh size of about #200 to about #1000. In embodiments, at least about 98% of the particles of the pozzolan(s) fit through a mesh size of about #200 to about #800. In embodiments, at least about 98% of the particles of the pozzolan(s) fit through a mesh size of about #200 to about #700. In embodiments, at least about 98% of the particles of the pozzolan(s) fit through a mesh size of about #200 to about #600. In embodiments, at least about 98% of the particles of the pozzolan(s) fit through a mesh size of about #200 to about #500. In embodiments, at least about 98% of the particles of the pozzolan(s) fit through a mesh size of about #200 to about #400. In embodiments, at least about 98% of the particles of the pozzolan(s) fit through a mesh size of about #200 to about #325. Mesh size can be any value or subrange within the recited ranges.

A pozzolan (either natural or man-made) may be or is a silicious or silicious and aluminous material.

The cementitious aggregate compositions described herein (e.g., the shaped cementitious aggregate compositions) can comprise any proportion by weight of pozzolan in relation to the proportion of magnesium oxide (e.g., MgO) or magnesium hydroxide (e.g., Mg(OH)₂) by weight of the cementitious aggregate composition. The proportions can be calculated by the wet weight (e.g., the weight of the cementitious aggregate composition following the addition of a liquid such as water) or the dry weight (e.g., the weight of the cementitious aggregate composition prior to addition of a liquid such as water). The proportion of pozzolan by percentage weight can be about 30% to about 130% (e.g., about 30% to about 120%, about 30% to about 110%, about 30% to about 100%, about 30% to about 95%, about 30% to about 90%, about 30% to about 85%, about 30% to about 80%, about 30% to about 75%, about 30% to about 70%, about 30% to about 65%, about 30% to about 60%, about 30% to about 55%, about 30% to about 50%, about 30% to about 45%, about 30% to about 40%, about 30% to about 35%, about 35% to about 130%, about 40% to about 130%, about 45% to about 130%, about 50% to about 130%, about 55% to about 130%, about 60% to about 130%, about 65% to about 130%, about 70% to about 130%, about 75% to about 130%, about 80% to about 130%, about 85% to about 130%, about 90% to about 130%, about 95% to about 130%, about 100% to about 130%, about 110% to about 130%, about 120% to about 130%, about 95% to about 105%, about 90% to about 110%, about 85% to about 115%, about 80% to about 120%, or about 75% to about 125%) of the proportion of magnesium oxide (e.g., MgO) by percentage weight of the cementitious aggregate composition. The proportion of pozzolan by percentage weight can be about 30% to about 130% (e.g., about 30% to about 120%, about 30% to about 110%, about 30% to about 100%, about 30% to about 95%, about 30% to about 90%, about 30% to about 85%, about 30% to about 80%, about 30% to about 75%, about 30% to about 70%, about 30% to about 65%, about 30% to about 60%, about 30% to about 55%, about 30% to about 50%, about 30% to about 45%, about 30% to about 40%, about 30% to about 35%, about 35% to about 130%, about 40% to about 130%, about 45% to about 130%, about 50% to about 130%, about 55% to about 130%, about 60% to about 130%, about 65% to about 130%, about 70% to about 130%, about 75% to about 130%, about 80% to about 130%, about 85% to about 130%, about 90% to about 130%, about 95% to about 130%, about 100% to about 130%, about 110% to about 130%, about 120% to about 130%, about 95% to about 105%, about 90% to about 110%, about 85% to about 115%, about 80% to about 120%, or about 75% to about 125%) of the proportion of magnesium hydroxide (e.g., Mg(OH)₂) by percentage weight of the cementitious aggregate composition.

The sum of the proportions of magnesium oxide, magnesium hydroxide, and pozzolan can be any percentage by weight of the cementitious aggregate compositions described herein (e.g., the shaped cementitious aggregate compositions). The proportions or percentages can be calculated by the wet weight (e.g., the weight of the cementitious aggregate composition following the addition of a liquid such as water) or the dry weight (e.g., the weight of the cementitious aggregate composition prior to addition of a liquid such as water). The sum of the proportions of magnesium oxide, magnesium hydroxide, and pozzolan can be about 5% to about 90% (e.g., about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 90%, about 15% to about 90%, about 20% to about 90%, about 25% to about 90%, about 30% to about 90%, about 35% to about 90%, about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 85% to about 90%, about 45% to about 55%, about 40% to about 60%, about 35% to about 65%, about 30% to about 70%, about 25% to about 75%, about 20% to about 80%, about 15% to about 85%, about 10% to about 85%, or about 15% to about 50%) by weight of the cementitious aggregate composition. In several embodiments, the cementitious aggregate compositions (e.g., shaped cementitious aggregate compositions) described herein can comprise:
(a) magnesium oxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
wherein the at least one accelerant is about 5% to about 145% of the proportion of magnesium oxide by weight of the cementitious aggregate composition;
wherein the proportion of pozzolan by percent weight can be about 30% to about 130% (e.g., about 90% to about 110%) of the proportion of magnesium oxide by percentage weight of the cementitious aggregate composition; and
wherein the sum of the proportions of magnesium oxide and pozzolan is about 5% to about 90% (e.g., about 15% to about 50%) by weight of the cementitious aggregate composition. The cementitious aggregate composition can further comprise a recycled aggregate (RA) and/or a carbonated recycled aggregate (CRA).

In several embodiments, the cementitious aggregate compositions (e.g., shaped cementitious aggregate compositions) described herein can comprise:
(a) magnesium oxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
wherein the at least one accelerant is about 0.1% to about 30% of the proportion of magnesium oxide of the cementitious aggregate composition;
wherein the proportion of pozzolan by percent weight can be about 30% to about 130% (e.g., about 90% to about 110%) of the proportion of magnesium oxide by percentage weight of the cementitious aggregate composition; and
wherein the sum of the proportions of magnesium oxide and pozzolan is about 5% to about 90% (e.g., about 15% to about 50%) by weight of the cementitious aggregate composition. The cementitious aggregate composition can further comprise a recycled aggregate (RA) and/or a carbonated recycled aggregate (CRA).

In several embodiments, the cementitious aggregate compositions (e.g., shaped cementitious aggregate compositions) described herein can comprise:
(a) magnesium hydroxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant); wherein the at least one accelerant is about 5% to about 145% of the proportion of magnesium hydroxide by weight of the cementitious aggregate composition;
wherein the proportion of pozzolan by percent weight can be about 30% to about 130% (e.g., about 90% to about 110%) of the proportion of magnesium hydroxide by percentage weight of the cementitious aggregate composition; and
wherein the sum of the proportions of magnesium hydroxide and pozzolan is about 5% to about 90% (e.g., about 15% to about 50%) by weight of the cementitious aggregate composition. The cementitious aggregate composition can further comprise a recycled aggregate (RA) and/or a carbonated recycled aggregate (CRA).

In several embodiments, the cementitious aggregate compositions (e.g., shaped cementitious aggregate compositions) described herein can comprise:
(a) magnesium hydroxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
wherein the at least one accelerant is about 0.1% to about 30% of the proportion of magnesium hydroxide of the cementitious aggregate composition;
wherein the proportion of pozzolan by percent weight can be about 30% to about 130% (e.g., about 90% to about 110%) of the proportion of magnesium hydroxide by percentage weight of the cementitious aggregate composition; and
wherein the sum of the proportions of magnesium hydroxide and pozzolan is about 5% to about 90% (e.g., about 15% to about 50%) by weight of the cementitious aggregate composition. The cementitious aggregate composition can further comprise a recycled aggregate (RA) and/or a carbonated recycled aggregate (CRA).

In several embodiments, the cementitious aggregate compositions (e.g., shaped cementitious aggregate compositions) described herein can comprise:
(a) magnesium oxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
wherein the at least one accelerant is about 5% to about 145% of the proportion of magnesium oxide by weight of the cementitious aggregate composition;
wherein when the at least one accelerant comprises magnesium chloride or magnesium nitrate, a proportion by weight of MgCl₂ or Mg(NO₃)₂ is 0.1% to 30% of the proportion of magnesium oxide by weight of the cementitious aggregate composition,
wherein the proportion of pozzolan by percent weight can be about 30% to about 130% (e.g., about 90% to about 110%) of the proportion of magnesium oxide by percentage weight of the cementitious aggregate composition; and
wherein the sum of the proportions of magnesium oxide and pozzolan is about 5% to about 90% (e.g., about 15% to about 50%) by weight of the cementitious aggregate composition. The cementitious aggregate composition can further comprise a recycled aggregate (RA) and/or a carbonated recycled aggregate (CRA).

In several embodiments, the cementitious aggregate compositions (e.g., shaped cementitious aggregate compositions) described herein can comprise:
(a) magnesium oxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
wherein the at least one accelerant is about 0.1% to about 30% of the proportion of magnesium oxide of the cementitious aggregate composition;
wherein when the at least one accelerant comprises magnesium chloride or magnesium nitrate, a proportion by weight of MgCl₂ or Mg(NO₃)₂ is 0.1% to 30% of the proportion of magnesium oxide by weight of the cementitious aggregate composition.
wherein the proportion of pozzolan by percent weight can be about 30% to about 130% (e.g., about 90% to about 110%) of the proportion of magnesium oxide by percentage weight of the cementitious aggregate composition; and
wherein the sum of the proportions of magnesium oxide and pozzolan is about 5% to about 90% (e.g., about 15% to about 50%) by weight of the cementitious aggregate composition. The cementitious aggregate composition can further comprise a recycled aggregate (RA) and/or a carbonated recycled aggregate (CRA).

In several embodiments, the cementitious aggregate compositions (e.g., shaped cementitious aggregate compositions) described herein can comprise:
(a) magnesium hydroxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
wherein the at least one accelerant is about 5% to about 145% of the proportion of magnesium hydroxide by weight of the cementitious aggregate composition;
wherein when the at least one accelerant comprises magnesium chloride or magnesium nitrate, a proportion by weight of MgCl₂ or Mg(NO₃)₂ is 0.1% to 30% of the proportion of magnesium hydroxide by weight of the cementitious aggregate composition.
wherein the proportion of pozzolan by percent weight can be about 30% to about 130% (e.g., about 90% to about 110%) of the proportion of magnesium hydroxide by percentage weight of the cementitious aggregate composition; and wherein the sum of the proportions of magnesium hydroxide and pozzolan is about 5% to about 90% (e.g., about 15% to about 50%) by weight of the cementitious aggregate composition. The cementitious aggregate composition can further comprise a recycled aggregate (RA) and/or a carbonated recycled aggregate (CRA).

In several embodiments, the cementitious aggregate compositions (e.g., shaped cementitious aggregate compositions) described herein can comprise:
(a) magnesium hydroxide;
(b) a pozzolan (e.g., comprising one or both of slag cement and Class C fly ash);
(c) at least one accelerant (e.g., wherein the at least one accelerant comprises magnesium chloride, magnesium nitrate, magnesium sulfate, or a phosphate-based accelerant);
wherein the at least one accelerant is about 0.1% to about 30% of the proportion of magnesium hydroxide of the cementitious aggregate composition;
wherein when the at least one accelerant comprises magnesium chloride or magnesium nitrate, a proportion by weight of MgCl₂ or Mg(NO₃)₂ is 0.1% to 30% of the proportion of magnesium hydroxide by weight of the cementitious aggregate composition,
wherein the proportion of pozzolan by percent weight can be about 30% to about 130% (e.g., about 90% to about 110%) of the proportion of magnesium hydroxide by percentage weight of the cementitious aggregate composition; and
wherein the sum of the proportions of magnesium hydroxide and pozzolan is about 5% to about 90% (e.g., about 15% to about 50%) by weight of the cementitious aggregate composition. The cementitious aggregate composition can further comprise a recycled aggregate (RA) and/or a carbonated recycled aggregate (CRA).

### Natural Pozzolans

A natural pozzolan is a raw pozzolan that is found in natural deposits. In embodiments, the natural pozzolan is not calcined. A material is referred to as “calcined” when it has been heated below the temperature of fusion to alter its composition or physical state.

Natural pozzolans have been used to replace cement clinker in the production of Portland Cement. Cement clinker is a solid material produced by sintering limestone and aluminosilicate material comprising four mineral phases: two calcium silicates, alite (Ca₃Si) and belite (Ca₂Si), tricalcium aluminate (Ca₃Al) and calcium aluminoferrite (Ca₄AlFe). The clinker is ground to a fine powder and used as the binder, where a small amount of gypsum must be added to avoid the flash setting of the tricalcium aluminate (Ca₃Al₂O₆), the most reactive mineral phase (exothermic hydration reaction) in Portland clinker.

In contrast, the reactive chemical composition of pozzolans and natural pozzolans may comprise, but not limited to, silica (SiO₂), alumina (Al₂O₃), and iron oxide (Fe₂O₃). Natural pozzolans encompass a broad range of materials that include, but are not limited to, volcanic rock (rhyolite, obsidian, pitchstone, pumice, basalt or trap, and andesite) volcanic ash, sedimentary clays and shales, calcined clays, rice husk ash, diatomaceous earth, metakaolin and olivine.

Despite the advantages and historical use of natural pozzolans in the production of Portland cement-based concrete as clinker alternatives, there are several obstacles or disadvantages: the use of pozzolans may reduce the early strength of concrete, making such cements unsuitable for precast applications and potentially increasing construction times. They also may increase water demand during concrete production and can lower resistance to carbonation, which raises the risk of corrosion to carbon (black) steel reinforcement. However, the materials and methods described herein provide improved alternatives.

In embodiments, the natural pozzolan used in a composition or method provided herein is selected from rhyolite, obsidian, pitchstone, pumice, basalt, andesite, volcanic ash, sedimentary clay, shale, wollastanite, opaline shale, diatomaceous earth, olivine, and combinations thereof. In embodiments, the natural pozzolan includes rhyolite. In embodiments, the natural pozzolan includes obsidian. In embodiments, the natural pozzolan includes pitchstone. In embodiments, the natural pozzolan includes pumice. In embodiments, the natural pozzolan includes basalt. In embodiments, the natural pozzolan includes andesite. In embodiments, the natural pozzolan includes volcanic ash. In embodiments, the natural pozzolan includes sedimentary clay. In embodiments, the natural pozzolan includes shale. In embodiments, the natural pozzolan includes wollastanite. In embodiments, the natural pozzolan includes diatomaceous earth. In embodiments, the natural pozzolan includes opaline shale. In embodiments, the natural pozzolan includes olivine.

In embodiments, the natural pozzolan used in a composition or method provided expressly excludes one or more of the natural pozzolans listed herein.

### Natural Pozzolans: Volcanic Rock

Rhyolite is a silica-rich volcanic rock, which has a fine-grain or glassy in texture. It is formed from magma rich in silica that is extruded from a volcanic vent to cool quickly on the surface rather than slowly in the subsurface. The mineral composition of rhyolite comprises quartz, sanidine, and plagioclase, with minor amounts of hornblende and biotite. Chemically, the composition of rhyolite generally comprises SiO₂ and an alkali metal oxide, such as K₂O and Na₂O.

Obsidian is also formed from extruded lava from a volcano that cools rapidly with minimal crystal growth (i.e., glassy or fine-grained.) Like rhyolite, obsidian is extremely rich in SiO₂ at about 70 wt. % or more and also includes MgO and Fe₂O₃. While obsidian is used for manufacturing, the uses are typically for cutting and piercing tools.

Pitchstone is a volcanic glass similar to obsidian, formed when extruded lava rapidly cools. Pitchstone has a similar chemical composition to both rhyolite and obsidian, with the amount of SiO₂ ranging in the amount from about 70 wt. % to 75 wt. %. Pitchstone comprises minerals as quartz, alkali feldspar, and plagioclase, and in smaller amounts pyroxene and hornblende. Pumice is a porous volcanic rock created when super-heated, highly pressurized rock is violently ejected from a volcano. Pumice typically has a porosity of approximately 64%-85% by volume. The mineral composition of pumice includes feldspar, augite, hornblend, and zircon. Pumice mainly comprises SiO₂, Al₂O₃, and minor amounts of other oxides such as FeO, Fe₂O₃, Na₂O, and K₂O.

Basalt is a fine-grained, extrusive igneous rock formed from the rapid cooling of low-viscosity lava rich in magnesium and iron. While basalt has a relatively lower amount of SiO₂ compared to other common igneous rocks, basalt generally has a composition of 45-52 wt. % SiO₂, 2-5 wt. % total alkalis, 0.5-2.0 wt. % TiO₂, 5-14% wt. %, and 14 wt. % Al₂O₃. Basalt may include additional components, including (without limitation) calcium oxide and/or magnesium oxide. Andesite is a fine-grained volcanic rock that forms as a result of the rapid cooling and solidification of lava due to the eruption of arc volcanoes or oozing fissures. Andesite contains sodium-rich plagioclase feldspar (Na,Ca)[(Si,Al) AlSi₂]O₈ and may contain (usually <20%) hornblende amphibole, biotite, pyroxene and quartz minerals. In addition, andesite compositions include 52-63% silicon dioxide as well as an alkali oxide content (e.g., Na₂O, K₂O) ranging from 0 to 7% w/w. Andesite compositions are referred to respectively as low-silica or high-silica andesites when they contain either 52-57% or 57-63% SiO₂.

Olivine is a magnesium iron silicate found abundantly in the earth's upper mantel as a dense aggregate. Olivine is chemically represented as (Mg,Fe)₂SiO₄. Generally, olivine is abundant in low-silica mafic and ultramafic igneous rocks.

### Man-Made Pozzolans

Other materials may have pozzolanic activity, including some man-made materials. In some embodiments, the compositions and methods described herein may utilize pozzolans, including non-natural (e.g., man-made) pozzolans. In embodiments, man-made pozzolans are calcined materials. A material is referred to as “calcined” when it has been heated below the temperature of fusion to alter its composition or physical state. In embodiments, man-made pozzolans are recycled materials from industry (e.g., GGBFS).

Non-limiting examples of man-made pozzolans include metakaolin, fly ash (e.g., Class C fly ash), silica fume, ground glass (e.g., ground waste glass), slag (e.g. ground-granulated blast-furnace slag, blast-furnace slag, steel-furnace slag, basic-oxygen-furnace slag, electric-arc-furnace slag, ladle slag, copper slag, steel slag, iron slag, lead slag, nickel slag, zinc slag, aluminum slag, slag from other metals), burned organic matter residues (e.g., rice husk ash or rice hull ash), expanded clay, expanded shale, and calcine clay, and combinations thereof.

In embodiments, the man-made pozzolan used in a composition or method provided includes metakaolin. In embodiments, the man-made pozzolan includes fly ash. In embodiments, the man-made pozzolan includes silica fume. In embodiments, the man-made pozzolan includes burned organic matter residue. In embodiments, the man-made pozzolan includes ground glass. In embodiments, the man-made pozzolan includes ground waste glass. In embodiments, the man-made pozzolan includes slag. In embodiments, the man-made pozzolan includes ground-granulated blast-furnace slag. In embodiments, the man-made pozzolan includes blast-furnace slag. In embodiments, the man-made pozzolan includes steel-furnace slag. In embodiments, the man-made pozzolan includes basic-oxygen-furnace slag. In embodiments, the man-made pozzolan includes electric-arc-furnace slag. In embodiments, the man-made pozzolan includes ladle slag. In embodiments, the man-made pozzolan includes copper slag. In embodiments, the man-made pozzolan includes steel slag. In embodiments, the man-made pozzolan includes iron slag. In embodiments, the man-made pozzolan includes lead slag. In embodiments, the man-made pozzolan includes nickel slag. In embodiments, the man-made pozzolan includes zinc slag. In embodiments, the man-made pozzolan includes aluminum slag. In embodiments, the man-made pozzolan includes slag from other metals. In embodiments, the man-made pozzolan includes burned organic matter residues. In embodiments, the man-made pozzolan includes rice husk ash (rice hull ash). In embodiments, the man-made pozzolan includes expanded clay. In embodiments, the man-made pozzolan includes expanded shale. In embodiments, the man-made pozzolan includes calcine clay. In some embodiments, the cementitious aggregate composition comprises man-made pozzolan. In some embodiments, the man-made pozzolan comprises one or both of slag cement and fly ash. In some embodiments, the man-made pozzolan comprises one or both of slag cement and Class C fly ash. In some embodiments, the man-made pozzolan does not comprise Class F fly ash. In some embodiments, the cementitious aggregate compositions (e.g., the shaped cementitious aggregate compositions) described herein do not contain Class F fly ash.

In embodiments, the materials described herein may be chemically treated (e.g., with acid) prior to use. In embodiments, the materials described herein are not chemically treated prior to use.

In embodiments, the man-made pozzolan used in a composition or method provided expressly excludes one or more of the man-made pozzolans listed herein.

Where the term “pozzolan” is recited, it is to be understood that natural pozzolan, man-made pozzolan, or a mixture thereof is intended.

### Exemplary Clauses

The following clauses are provided as exemplary methods and compositions of this disclosure and do not limit the scope of the present disclosure.

Clause 1. A method comprising steps of:
(a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and
(b) permitting the combination obtained in step (a) to persist under conditions sufficient to transform the combination into a cementitious aggregate composition and a reduced salinity water component.

Clause 2. The method of Clause 1, wherein the conditions sufficient to transform the combination into a cementitious aggregate composition and a reduced salinity water component in step (b) comprise time and applied pressure.

Clause 3. The method of Clause 1, wherein the high salinity brine, CO₂, and the natural pozzolan, the man-made pozzolan, the latently hydraulic material, and/or the recycled aggregate (RA) or the carbonated recycled aggregate (CRA) are combined simultaneously.

Clause 4. The method of Clause 1, wherein the high salinity brine, CO₂, and the natural pozzolan, the man-made pozzolan, the latently hydraulic material, and/or the recycled aggregate (RA) or the carbonated recycled aggregate (CRA) are combined sequentially with the high salinity brine and CO₂ combined first.

Clause 5. The method of Clause 1, wherein the high salinity brine, CO₂, the natural pozzolan, the man-made pozzolan, the latently hydraulic material, and/or the recycled aggregate (RA) or the carbonated recycled aggregate (CRA) are combined sequentially with the CO₂ and the pozzolan combined first.

Clause 6. The method of Clause 1, wherein the high salinity brine, CO₂, and the natural pozzolan, the man-made pozzolan, the latently hydraulic material, and/or the recycled aggregate (RA) or the carbonated recycled aggregate (CRA) are combined sequentially with the high salinity brine and the pozzolan combined first.

Clause 7. The method of any one of Clauses 1 to 6, wherein the high salinity brine is obtained from a desalination facility, is natural seawater, or an industrial brine.

Clause 8. The method of any one of Clauses 1 to 7, wherein the salt concentration of the high salinity brine is greater than or about equal to the salt concentration of seawater.

Clause 9. The method of any one of Clauses 1 to 8, wherein the salt concentration of the reduced salinity water component is less than or about equal to the salt concentration of seawater.

Clause 10. The method of any one of Clauses 1 to 9, wherein the salt concentration of the reduced salinity water component is less than the high salinity brine.

Clause 11. The method of any one of Clauses 1 to 10, wherein the high salinity brine comprises water with a salt concentration (e.g., chloride, sulphate, and sodium) higher than 50 parts per thousand.

Clause 12. The method of any one of Clauses 1 to 11, wherein the method further comprises further adding an activator in step (a).

Clause 13. The method of Clause 12, wherein the activator is any sodium, lithium or potassium salt or hydroxide and any alkali or alkali earth metal ions.

Clause 14. The method of Clause 12 or Clause 13, wherein the activator is one or more of Mg(OH)₂, MgO, Ca(OH)₂, CaCO₃, Al₂(SO₄)₃, and CaO.

Clause 15. The method of any one of Clauses 1 to 12, wherein the brine of step (a) has reduced amounts of sodium, potassium, chloride, sulphate, magnesium, and/or calcium ions via chemical precipitation, electrochemical methods, ion selective membranes, reverse osmosis, and/or selective precipitation by pH.

Clause 16. The method of Clause 15, wherein the chemical precipitation comprises contacting the sodium, potassium, chloride, sulphate, magnesium, and/or calcium ions with lime (calcium hydroxide, Ca(OH)₂) or alum (aluminum sulfate, Al₂(SO₄)₃) which forms insoluble precipitates with the sodium, potassium, chloride, sulphate, magnesium, and/or calcium ions.

Clause 17. The method of Clause 15 or Clause 16, wherein the chemical precipitation occurs before step (a) and/or during step (a).

Clause 18. The method of any one of Clauses 1 to 12, wherein the reduced salinity water component is added to a natural or artificial body of water.

Clause 19. The method of Clause 18, wherein the reduced salinity water component does less harm to flora and/or fauna present in the natural or artificial body of water relative to the harm that would be caused when the high salinity brine is added to a natural or artificial body of water.

Clause 20. The method of Clause 19, wherein the reduced salinity water comprises less sulphates and chlorides than high salinity brine, which also are harmful to flora and/or fauna present in the natural or artificial body of water.

Clause 21. The method of any one of Clauses 1 to 19, wherein the reduced salinity water component is returned to the desalination plant for a further round of desalination into fresh water.

Clause 22. The method of any one of Clauses 1 to 19, wherein the reduced salinity water component is further processed to extract sodium and produce additional fresh water.

Clause 23. The method of Clause 22, wherein the process is more efficient since the sodium and chloride has substantially already been removed.

Clause 24. The method of any one of Clauses 7 to 21, wherein the method permits production by a desalination facility of a brine having a higher salt concentration relative to a method where the desalination facility produces brine as wastewater to be added to a natural or artificial body of water.

Clause 25. The method of Clause 24, wherein the relative salt concentration is up to 5-fold higher.

Clause 26. The method of any one of Clauses 7 to 24, wherein the method permits production of more fresh water by a desalination facility relative to a method where the desalination facility produces brine as wastewater to be added to a natural or artificial body of water.

Clause 27. The method of Clause 26, wherein the amount of fresh water produced is up to 5-fold higher.

Clause 28. The method of any one of Clauses 1 to 26, wherein the steps (a) and/or (b) occurs in a location within the desalination facility, adjacent to the desalination facility, or downstream from the desalination facility.

Clause 29. The method of any one of Clauses 1 to 26, wherein the steps (a) and/or (b) occurs in a location distant from the desalination facility.

Clause 30. The method of Clause 28 or Clause 29, wherein step (a) and/or step (b) occurs in a pipeline within the desalination facility, adjacent to the desalination facility, or downstream from the desalination facility.

Clause 31. The method of Clause 30, wherein the pressure in step (b) is applied to the pipeline utilizing a series of pipe reducers or another method, each of which creates pressure sufficient to make the conversion process (e.g., chemical reactions) more efficient.

Clause 32. The method of Clause 31, wherein a pipe reducer is a mechanical device used to reduce the diameter of a pipe, which creates pressure by restricting the flow of a fluid.

Clause 33. The method of Clause 31 or Clause 32, wherein the applied pressure further reduces the amount of energy required and/or waste CO₂ produced.

Clause 34. The method of Clause 28 or Clause 29, wherein steps (a) and/or (b) occurs in a tank or basin.

Clause 35. The method of Clause 34, wherein step (a) further comprises adding an activator.

Clause 36. The method of Clause 35, wherein the activator is any sodium, lithium or potassium salt or hydroxide and any alkali or alkali earth metal ions.

Clause 37. The method of Clause 35 or Clause 36, wherein the activator is one or more of Mg(OH)₂, MgO, Ca(OH)₂, CaCO₃, Al₂(SO₄)₃, and CaO.

Clause 38. The method of any one of Clauses 1 to 30, wherein the pozzolan comprises silica (SiO₂), alumina (Al₂O₃), and/or iron oxide (Fe₂O₃).

Clause 39. The method of any one of Clauses 1 to 38, wherein the pozzolan is a natural pozzolan or a man-made pozzolan.

Clause 40. The method of any one of Clauses 1 to 38, wherein the pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

Clause 41. The method of any one of Clauses 1 to 40, wherein use of pozzolan avoids the problem of sourcing cementitious material that is used in standard concrete manufacturing.

Clause 42. The method of Clause 41, wherein avoiding the problem of sourcing cementitious material further reduces the amount of energy required and/or waste CO₂ produced relative to standard concrete manufacturing.

Clause 43. The method of any one of Clauses 1 to 42, wherein the cementitious aggregate composition absorbs more carbon dioxide during its manufacture than is emitted.

Clause 44. The method of any one of Clauses 1 to 43, wherein the cementitious aggregate composition absorbs and/or retains at least 0.04 kg CO₂ per kg of composition.

Clause 45. The method of any one of Clauses 1 to 44, wherein the CO₂ is chemically reacted to form a crystalline form of carbon.

Clause 46. The method of any one of Clauses 1 to 44, wherein the CO₂ is absorbed into the cementitious aggregate composition as a crystalline form of carbon.

Clause 47. The method of any one of 1 to 44, wherein the CO₂ of step (a) is from industrial waste, from environmental sources, or from molecular capture.

Clause 48. The method of Clause 47, wherein the industrial waste relates to alcoholic fermentation or the burning of fossil fuels.

Clause 49. The method of any one of Clauses 1 to 48, wherein the CO₂ of step (a) is provided in gaseous, solid, and/or as a supercritical fluid form or as a dissolved gas.

Clause 50. The method of any one of Clauses 1 to 49, wherein the CO₂ of step (a) is incorporated into the cementitious aggregate composition as a carbonate.

Clause 51. The method of any one of Clauses 1 to 50, wherein step (a) further comprises adding an activator that is any sodium, lithium or potassium salt or hydroxide and any alkali or alkali earth metal ions.

Clause 52. The method of any one of Clauses 1 to 51, wherein step (a) further comprises adding Mg(OH)₂, MgO, Ca(OH)₂, and/or CaO.

Clause 53. The method of any one of Clauses 1 to 48, wherein the cementitious aggregate composition forms particles of various shapes, sizes, and textures.

Clause 54. The method of Clause 53, wherein the particles have average sizes ranging from 0.0625 mm to about 40.0 mm in diameter.

Clause 55. The method of Clause 53 or 54, wherein the particles have generally rounded or oval shape.

Clause 56. The method of Clause 55, wherein the particles are less dense per unit volume than a standard cement.

Clause 57. The method of any one of Clauses 41 to 56, wherein the cementitious aggregate composition comprises more CO₂ per gram than a standard cement.

Clause 58. The method of Clause 57, wherein the cementitious aggregate composition comprises up to 50% more CO₂ per gram than a standard cement.

Clause 59. The method of any one of Clauses 41 to 56, wherein the cementitious aggregate composition comprises more calcium, silicon, aluminum, magnesium and/or iron per gram than a standard cement.

Clause 60. The method of Clause 59, wherein the cementitious aggregate composition comprises up to 50% more calcium, silicon, aluminum, magnesium and/or iron per gram than a standard cement.

Clause 61. The method of any one of Clauses 41 to 60, wherein the standard cement comprises CaO, CaCO₃, SiO₂, Al₂O₃, Fe₂O₃, and CaSO₄·H₂O.

62. The method of any one of Clauses 41 to 61, wherein the standard cement comprises a slaked or hydraulic dolomitic or calcareous lime blended with a natural or man-made pozzolanic or latently hydraulic material.

Clause 63. The method of any one of Clauses 41 to 61, wherein the standard cement, e.g., a standard hydrated cement, is a Portland Cement comprising cement clinker rather than pozzolan.

Clause 64. The method of any one of Clauses 41 to 63, wherein the cementitious aggregate composition is deposited into a natural or artificial body of water.

Clause 65. The method of Clause 64, wherein when deposited into the natural or artificial body of water, the cementitious aggregate composition remains where deposited.

Clause 66. The method of Clause 64 or 65, wherein when deposited into the natural or artificial body of water, a portion of the cementitious aggregate composition is distributed away from the deposit site.

Clause 67. The method of Clause 66, wherein the cementitious aggregate composition is distributed away from the deposit site by water movement or currents, erosion, or animal activity.

Clause 68. The method of any one of Clauses 64 to 66, wherein the cementitious aggregate composition permits attachment by flora and/or fauna.

Clause 69. The method of Clause 68, where the fauna comprises coral.

Clause 70. The method of Clause 68, where the flora comprises algae.

Clause 71. The method of any one of Clauses 68 to 70, wherein the cementitious aggregate composition permits a preferred level of colonization by flora and/or fauna relative to a standard cement.

Clause 72. The method of any one of Clauses 68 to 70, wherein the cementitious aggregate composition permits more plentiful attachment by flora and/or fauna relative to a standard cement.

Clause 73. The method of any one of Clauses 1 to 72, wherein the cementitious aggregate composition comprises any sodium, lithium or potassium salt or hydroxide and any alkali or alkali earth metal ions and including Mg(OH)₂, MgO, Ca(OH)₂, CaCO₃, Al₂(SO₄)₃, CaO, CaSO₄·H₂O, SiO₂, Fe₂O₃, Al₂O₃ and/or Brucite.

Clause 74. The method of any one of Clauses 1 to 73, wherein the cementitious aggregate composition comprises MgO.

Clause 75. The method of any one of Clauses 1 to 73, wherein the cementitious aggregate composition does not substantially comprise MgO obtained from a calcination reaction.

Clause 76. The method of any one of Clauses 1 to 74, wherein step (b) produces exothermic heat.

Clause 77. The method of Clause 75, wherein the exothermic heat is transformable from thermal energy into electrical energy.

Clause 78. The method of any one of Clauses 2 to 77, wherein the pressure in step (b) is from about ambient (1 bar) to about 250 bar.

Clause 79. The method of any one of Clauses 2 to 78, wherein the pressure in step (b) is from about 100 bar to about 250 bar.

Clause 80. The method of any one of Clauses 2 to 78, wherein the pressure in step (b) is from about ambient (1 bar) bar to about 100 bar.

Clause 81. The method of any one of Clauses 2 to 80, wherein the temperature of step (a) and/or step (b) is from about 1° C. to about 100° C.

Clause 82. The method of any one of Clauses 2 to 80, wherein the duration of step (b) is from about 1 minute to about 10 hours.

Clause 83. The method of any one of Clauses 2 to 81, wherein the duration of step (b) is from about 1 minute to about 10 minutes.

Clause 84. The method of any one of Clauses 1 to 83, wherein an aggregate is added to the combination of step (a).

Clause 85. The method of Clause 84, wherein the aggregate comprises sand, gravel, lightweight aggregate, recycled aggregate (RA), carbonated recycled aggregate (CRA), or crushed stone, and a combination thereof.

Clause 86. The method of any one of Clauses 1 to 85, wherein the latently hydraulic material is a slag.

Clause 87. The method of Clause 86, wherein the slag is added in step (a) in addition to the added pozzolan.

Clause 88. The method of Clause 86, wherein the slag is added in step (a) instead of the activator.

Clause 89. The method of any one of Clauses 1 to 88, wherein the method further comprises isolating the cementitious aggregate composition from the reduced salinity water component or other liquid components.

Clause 90. The method of Clause 89, wherein the isolating comprises straining to capture the cementitious aggregate composition.

Clause 91. The method of any one of Clauses 1 to 53 or 84 to 90, wherein the cementitious aggregate composition is molded into a shaped cementitious composition.

Clause 92. The method of Clause 91, wherein the shaped cementitious composition permits more plentiful and/or stronger attachment by flora and/or fauna relative to a standard cement.

Clause 93. The method of Clause 92, where the fauna comprises coral.

Clause 94. The method of Clause 92, where the flora comprises algae.

Clause 95. The method of any one of Clauses 92 to 94, wherein the shaped cementitious composition permits stronger attachment by flora and/or fauna relative to a standard cement.

Clause 96. The method of any one of Clauses 91 to 94 wherein the shaped cementitious composition permits more plentiful attachment by flora and/or fauna relative to a standard cement.

Clause 97. The method of any one of Clauses 92 to 96, wherein the shape of the shaped cementitious composition is any shape capable of providing a substrate for aquatic flora and/or fauna attachment.

Clause 98. The method of any one of Clauses 92 to 97, wherein the shape is planar, circular, rounded, elongated, flat, rectangular, or any combination thereof.

Clause 99. The method of any one of Clauses 92 to 97, wherein the shape is pyramidal with closed surfaces.

Clause 100. The method of any one of Clauses 92 to 99, wherein the shape is pyramidal with open surfaces such that the shape comprises four bars or cylinders that form a square base and four bars or cylinders each originating at a corner of the square and converging to form the pyramid's apex.

Clause 101. The method of any one of Clauses 1 to 100, wherein heat is applied to the mixture.

Clause 102. The method of Clause 101, wherein the heat increases the rate of reaction and/or the extent of reaction.

Clause 103. The method of Clauses 101 or 102, wherein the heat activates the latent hydraulic nature of some components.

Clause 104. The method of any one of Clauses 101 to 103, wherein the heat provides a temperature of greater than 100° C. and up to 3000° C.

Clause 105. The method of any one of Clauses 1 to 100, wherein the combination obtained in step (a) is selected from the group consisting of:
A. (1) brine, (2) CO₂, and (3) a recycled aggregate (RA);
B. (1) brine, (2) CO₂, (3) a recycled aggregate (RA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
C. (1) brine, (2) CO₂, and (3) a carbonated recycled aggregate (CRA);
D. (1) brine, (2) CO₂, (3) carbonated recycled aggregate (CRA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
E. (1) brine, (2) CO₂, and (3) a natural pozzolan;
F. (1) brine, (2) CO₂, (3) a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
G. (1) brine, (2) CO₂, and (3) a man-made pozzolan;
H. (1) brine, (2) CO₂, (3) a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
I. (1) brine, (2) CO₂, and (3) a latently hydraulic material;
J. (1) brine, (2) CO₂, (3) a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
K. (1) brine, (2) CO₂, and (3) a recycled aggregate (RA) and a carbonated recycled aggregate (CRA);
L. (1) brine, (2) CO₂, (3) a recycled aggregate (RA) and carbonated recycled aggregate (CRA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
M. (1) brine, (2) CO₂, and (3) a recycled aggregate (RA) and a natural pozzolan;
N. (1) brine, (2) CO₂, (3) a recycled aggregate (RA) and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
O. (1) brine, (2) CO₂, and (3) a recycled aggregate (RA) and a man-made pozzolan;
P. (1) brine, (2) CO₂, (3) a recycled aggregate (RA) and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
Q. (1) brine, (2) CO₂, and (3) a recycled aggregate (RA) and a latently hydraulic material; R. (1) brine, (2) CO₂, (3) a recycled aggregate (RA) and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
S. (1) brine, (2) CO₂, and (3) a recycled aggregate (RA), a natural pozzolan, and a man-made pozzolan;
T. (1) brine, (2) CO₂, (3) a recycled aggregate (RA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
U. (1) brine, (2) CO₂, and (3) a recycled aggregate (RA), a natural pozzolan, and a latently hydraulic material;
V. (1) brine, (2) CO₂, (3) a recycled aggregate (RA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
W. (1) brine, (2) CO₂, and (3) a recycled aggregate (RA), a man-made pozzolan, and a latently hydraulic material;
X. (1) brine, (2) CO₂, (3) a recycled aggregate (RA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
Y. (1) brine, (2) CO₂, and (3) a recycled aggregate (RA), a natural pozzolan, a man-made pozzolan, and a latently hydraulic material;
Z. (1) brine, (2) CO₂, (3) a recycled aggregate (RA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).
AA. (1) brine, (2) CO₂, and (3) a carbonated recycled aggregate (CRA) and a natural pozzolan;
BB. (1) brine, (2) CO₂, (3) a carbonated recycled aggregate (CRA) and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
CC. (1) brine, (2) CO₂, and (3) a carbonated recycled aggregate (CRA) and a man-made pozzolan;
DD. (1) brine, (2) CO₂, (3) a carbonated recycled aggregate (CRA) and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
EE. (1) brine, (2) CO₂, and (3) a carbonated recycled aggregate (CRA) and a latently hydraulic material;
FF. (1) brine, (2) CO₂, (3) a carbonated recycled aggregate (CRA) and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
GG. (1) brine, (2) CO₂, and (3) a carbonated recycled aggregate (CRA), a natural pozzolan, and a man-made pozzolan;
HH. (1) brine, (2) CO₂, (3) a carbonated recycled aggregate (CRA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
II. (1) brine, (2) CO₂, and (3) a carbonated recycled aggregate (CRA), a natural pozzolan, and a latently hydraulic material;
JJ. (1) brine, (2) CO₂, (3) a carbonated recycled aggregate (CRA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
KK. (1) brine, (2) CO₂, and (3) a carbonated recycled aggregate (CRA), a man-made pozzolan, and a latently hydraulic material;
LL. (1) brine, (2) CO₂, (3) a carbonated recycled aggregate (CRA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
MM. (1) brine, (2) CO₂, and (3) a carbonated recycled aggregate (CRA), a natural pozzolan, a man-made pozzolan, and a latently hydraulic material;
NN. (1) brine, (2) CO₂, (3) a carbonated recycled aggregate (CRA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).
OO. (1) brine, (2) CO₂, and (3) a recycled aggregate (RA), a carbonated recycled aggregate (CRA), and a natural pozzolan;
PP. (1) brine, (2) CO₂, (3) a recycled aggregate (RA), a carbonated recycled aggregate (CRA), and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
QQ. (1) brine, (2) CO₂, and (3) a recycled aggregate (RA), a carbonated recycled aggregate (CRA), and a man-made pozzolan;
RR. (1) brine, (2) CO₂, (3) a recycled aggregate (RA), a carbonated recycled aggregate (CRA), and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
SS. (1) brine, (2) CO₂, and (3) a recycled aggregate (RA), a carbonated recycled aggregate (CRA), and a latently hydraulic material;
TT. (1) brine, (2) CO₂, (3) a recycled aggregate (RA), a carbonated recycled aggregate (CRA), and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
UU. (1) brine, (2) CO₂, and (3) a recycled aggregate (RA), a carbonated recycled aggregate (CRA), a natural pozzolan, and a man-made pozzolan;
VV. (1) brine, (2) CO₂, (3) a recycled aggregate (RA), a carbonated recycled aggregate (CRA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
WW. (1) brine, (2) CO₂, and (3) a recycled aggregate (RA), a carbonated recycled aggregate (CRA), a natural pozzolan, and a latently hydraulic material;
XX. (1) brine, (2) CO₂, (3) a recycled aggregate (RA), a carbonated recycled aggregate (CRA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
YY. (1) brine, (2) CO₂, and (3) a recycled aggregate (RA), a carbonated recycled aggregate (CRA), a man-made pozzolan, and a latently hydraulic material;
ZZ. (1) brine, (2) CO₂, (3) a recycled aggregate (RA), a carbonated recycled aggregate (CRA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
AAA. (1) brine, (2) CO₂, and (3) a recycled aggregate (RA), a carbonated recycled aggregate (CRA), a natural pozzolan, a man-made pozzolan, and a latently hydraulic material; and
BBB. (1) brine, (2) CO₂, (3) a recycled aggregate (RA), a carbonated recycled aggregate (CRA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).

Clause 106. The method of any one of Clauses 1 to 105, wherein the cementitious aggregate composition comprises the recycled aggregate (RA) and/or the carbonated recycled aggregate (CRA).

Clause 107. The method of any one of Clauses 1 to 106, wherein the cementitious aggregate composition comprises the recycled aggregate (RA).

Clause 108. The method of any one of Clauses 1 to 106, wherein the cementitious aggregate composition comprises the carbonated recycled aggregate (CRA).

Clause 109. The method of any one of Clauses 1 to 108, wherein the cementitious aggregate composition comprises the recycled aggregate (RA) and the carbonated recycled aggregate (CRA).

Clause 110. The method of any one of Clauses 1 to 109, wherein a cementitious aggregate composition comprises a recycled aggregate (RA) and/or a carbonated recycled aggregate (CRA) has lower porosity, smaller maximum pore volume, a greater proportion of pores smaller than 0.2 mm, is denser specimen, has a reduced likelihood of pores developing into large cracks under the same load, has enhanced elasticity and hardness in the interior segment, elevated compressive strength, and/or deeper carbonation depth when compared to a comparable cementitious aggregate comprising a natural aggregate.

Clause 111. The method of any one of Clauses 1 to 110, wherein the proportion by weight of the natural pozzolan and/or man-made pozzolan is about 30% to about 130% in relation to the proportion by weight of MgO and/or Mg(OH)₂ of the cementitious aggregate composition.

Clause 112. The method of Clause 111, wherein the proportion by weight of the natural pozzolan and/or man-made pozzolan is about 30% to about 120%, about 30% to about 110%, about 30% to about 100%, about 30% to about 95%, about 30% to about 90%, about 30% to about 85%, about 30% to about 80%, about 30% to about 75%, about 30% to about 70%, about 30% to about 65%, about 30% to about 60%, about 30% to about 55%, about 30% to about 50%, about 30% to about 45%, about 30% to about 40%, about 30% to about 35%, about 35% to about 130%, about 40% to about 130%, about 45% to about 130%, about 50% to about 130%, about 55% to about 130%, about 60% to about 130%, about 65% to about 130%, about 70% to about 130%, about 75% to about 130%, about 80% to about 130%, about 85% to about 130%, about 90% to about 130%, about 95% to about 130%, about 100% to about 130%, about 110% to about 130%, about 120% to about 130%, about 95% to about 105%, about 90% to about 110%, about 85% to about 115%, about 80% to about 120%, or about 75% to about 125% the proportion of the MgO and/or Mg(OH)₂ by percentage weight of the cementitious aggregate composition.

Clause 113. The method of any one of Clauses 1 to 112, wherein the sum of the proportions of MgO, Mg(OH)₂, natural pozzolan and/or man-made pozzolan is about 5% to about 90% by weight of the cementitious aggregate composition.

Clause 114. The method of Clause 113, wherein the sum of the proportions of the MgO, Mg(OH)₂, natural pozzolan, and/or man-made pozzolan is about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 90%, about 15% to about 90%, about 20% to about 90%, about 25% to about 90%, about 30% to about 90%, about 35% to about 90%, about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 85% to about 90%, about 45% to about 55%, about 40% to about 60%, about 35% to about 65%, about 30% to about 70%, about 25% to about 75%, about 20% to about 80%, about 15% to about 85%, about 10% to about 85%, or about 15% to about 50% by weight of the cementitious aggregate composition.

Clause 115. The method of any one of Clauses 1 to 114, wherein the man-made pozzolan comprises one or both of slag cement and fly ash.

Clause 116. The method of any one of Clauses 1 to 115, wherein the man-made pozzolan comprises one or both of slag cement and Class C fly ash.

Clause 117. The method of any one of Clauses 1 to 116, wherein the cementitious aggregate composition does not comprise Class F fly ash.

Clause 118. The method of any one of Clauses 1 to 117, wherein the cementitious aggregate composition comprises one or more accelerants and the one or more accelerants comprise an accelerant selected from magnesium chloride, magnesium sulfate, magnesium nitrate, and a phosphate-based accelerant.

Clause 119. The method of any one of Clauses 1 to 118, wherein the cementitious aggregate composition does not comprise magnesium sulfate.

Clause 120 The method of any one of Clauses 1 to 119, wherein the cementitious aggregate composition does not comprise magnesium chloride.

Clause 121. The method of any one of Clauses 1 to 120, wherein the cementitious aggregate composition does not comprise magnesium nitrate.

Clause 122. The method of any one of Clauses 1 to 121, wherein the cementitious aggregate composition does not comprise a phosphate-based accelerant.

Clause 123. The method of any one of Clauses 1 to 122, wherein the cementitious aggregate composition comprises one or more accelerants and the proportion by weight of the one or more accelerants is about 5% to about 145% the proportion of MgO and/or Mg(OH)₂ by weight of the cementitious aggregate composition.

Clause 124. The method of Clause 123, wherein the proportion by weight of the one or more accelerants is about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145% the proportion of MgO and/or Mg(OH)₂ of the cementitious aggregate composition.

Clause 125. The method of any one of Clauses 1 to 122, wherein the cementitious aggregate composition comprises one or more accelerants and the proportion by weight of the one or more accelerants is about 0.1% to about 30% of the proportion of Mg(OH)₂ and/or MgO by weight of the cementitious aggregate composition.

Clause 126. The method of Clause 125, wherein the proportion by weight of the one or more accelerants is about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25% of the proportion of Mg(OH)₂ and/or MgO by weight of the cementitious aggregate composition.

Clause 127. The method of any one of Clauses 1-126, wherein a proportion by weight of magnesium chloride is about 5% to about 145% of a proportion by weight of MgO and/or Mg(OH)₂ of the cementitious aggregate composition.

Clause 128. The method of Clause 127, wherein the proportion by weight of magnesium chloride is about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145% of the proportion by weight of MgO and/or Mg(OH)₂ of the cementitious aggregate composition.

Clause 129. The method of any one of Clauses 1-126, wherein a proportion by weight of magnesium chloride is about 0.1% to about 30% a proportion by weight of MgO and/or Mg(OH)₂ of the cementitious aggregate composition.

Clause 130. The method of Clause 129, wherein the proportion by weight of magnesium chloride is about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25% the proportion by weight of MgO and/or Mg(OH)₂ of the cementitious aggregate composition.

Clause 131. The method of any one of Clauses 1-130, wherein a proportion by weight of magnesium nitrate is about 5% to about 145% of a proportion by weight of MgO and/or Mg(OH)₂ of the cementitious aggregate composition.

Clause 132. The method of Clause 131, wherein the proportion by weight of magnesium nitrate is about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145% of the proportion by weight of MgO and/or Mg(OH)₂ of the cementitious aggregate composition.

Clause 133. The method of any one of Clauses 1-130, wherein a proportion by weight of magnesium nitrate is about 0.1% to about 30% a proportion by weight of MgO and/or Mg(OH)₂ of the cementitious aggregate composition.

Clause 134. The method of Clause 133, wherein the proportion by weight of magnesium nitrate is about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25% the proportion by weight of MgO and/or Mg(OH)₂ of the cementitious aggregate composition.

Clause 135. The method of any one of Clauses 1-134, wherein a proportion by weight of magnesium sulfate is about 5% to about 145% of a proportion by weight of MgO and/or Mg(OH)₂ of the cementitious aggregate composition.

Clause 136. The method of Clause 135, wherein the proportion by weight of magnesium sulfate is about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145% of the proportion by weight of MgO and/or Mg(OH)₂ of the cementitious aggregate composition.

Clause 137. The method of any one of Clauses 1-134, wherein a proportion by weight of magnesium sulfate is about 0.1% to about 30% a proportion by weight of MgO and/or Mg(OH)₂ of the cementitious aggregate composition.

Clause 138. The method of Clause 137, wherein the proportion by weight of magnesium sulfate is about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25% the proportion by weight of MgO and/or Mg(OH)₂ of the cementitious aggregate composition.

Clause 139. The method of any one of Clauses 1-137, wherein a proportion by weight of a phosphate-based accelerant is 0.1% to 5% of a proportion of MgO by weight of the cementitious aggregate composition.

Clause 140. The method of Clause 139, wherein a proportion by weight of the phosphate-based accelerant is 0.5%-5%, 1-5%, 1.5%-5%, 2%-5%, 2%-4.5%, 2%-4%, 2%-3.5%, 2.5%-5%, 2.5-4.5%, 2.5%-4%, 2.5%-3.5%, 2.5%-3%, 3%-3.5%, 3%-5%, or 4%-5% of the proportion of MgO by weight of the cementitious aggregate composition.

Clause 141. The method of any one of Clauses 1-140, wherein the cementitious aggregate composition comprises one or more accelerants, and wherein the one or more accelerants comprise a phosphate-based accelerant that is sodium hexametaphosphate.

Clause 142. The method of any one of Clauses 1-140, wherein the cementitious aggregate composition one or more accelerants, and wherein the one or more accelerants comprise a phosphate-based accelerant selected from sodium hexametaphosphate, any other alkali metal phosphates, and phosphoric acid.

Clause 143. A cementitious aggregate composition obtained by the method of any one of Clauses 1 to 142.

Clause 144. A method for providing substrate for aquatic flora and/or fauna attachment, the method comprising depositing the cementitious aggregate composition of Clause 143 into a natural or artificial body of water which comprises aquatic flora and/or fauna in need of an attachment.

Clause 145. A shaped cementitious composition obtained by the method of any one of Clauses 1 to 142.

Clause 146. The shaped cementitious composition of Clause 145, wherein the shape of the shaped cementitious composition is any shape capable of providing a substrate for aquatic flora and/or fauna attachment.

Clause 147. The shaped cementitious composition of Clause 145 or Clause 146, wherein the shape is planar, circular, rounded, elongated, flat, rectangular, or any combination thereof.

Clause 148. The shaped cementitious composition of any one of Clauses 145 to 147, wherein the shape is pyramidal with closed surfaces.

Clause 149. The shaped cementitious composition of any one of Clauses 145 to 148, wherein the shape is pyramidal with open surfaces such that the shape comprises four bars or cylinders that form a square base and four bars or cylinders each originating at a corner of the square and converging to form the pyramid's apex.

Clause 150. The shaped cementitious composition of any one of Clauses 145 to 149, wherein the shaped cementitious composition comprises gaps between particles of the aggregate such that the shaped cementitious composition has a more porous surface, is more porous throughout its volume, and is less dense than a standard cement.

Clause 151. The shaped cementitious composition of Clause 150, wherein the gaps of the shaped cementitious composition may be up to 500 nm in diameter.

Clause 152. The shaped cementitious composition of Clause 145 or Clause 151, wherein the shaped cementitious composition has up to 85% of the volume being void (e.g., the sum of all gaps) whereas a standard cement may have about 40% of the volume being void.

Clause 153. A method for providing substrate for aquatic flora and/or fauna attachment, the method comprising depositing the shaped cementitious composition of Clause 145 into a natural or artificial body of water which comprises aquatic flora and/or fauna in need of an attachment.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, the singular forms “a”, “an”, and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “about” or “approximately” means within an acceptable error range for the particular value as determined by one of ordinary skill in the art, which will depend in part on how the value is measured or determined, e.g., the limitations of the measurement system. For example, “about” can mean within 1 or more than 1 standard deviation, per the practice in the art. Alternatively, “about” can mean a range of up to 20%, up to 15%, up to 10%, up to 5%, or up to 1% of a given value. In some cases, the term “about” refers to +10% of a stated number or value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, “or” may refer to “and”, “or,” or “and/or” and may be used both exclusively and inclusively. For example, the term “A or B” may refer to “A or B”, “A but not B”, “B but not A”, and “A and B”. In some cases, context may dictate a particular meaning.

The terms “increased”, “increasing”, “increase”, “improved”, “improvement”, “improving” and the like, are used herein to generally means an increase by a statically significant amount.

In some aspects, the terms “increased” or “improved” means an increase or improvement of at least 10% as compared to a reference level, for example an increase or improvement of at least about 10%, at least about 20%, or at least about 30%, or at least about 40%, or at least about 50%, or at least about 60%, or at least about 70%, or at least about 80%, or at least about 90% or up to and including a 100% increase or any improvement between 10-100% as compared to a reference level, standard, or control. Other examples of “increase” or “improvement” includes an increase of at least 2-fold, at least 5-fold, at least 10-fold, at least 20-fold, at least 50-fold, at least 100-fold, at least 1000-fold or more as compared to a reference level.

The terms “decreased”, “decreasing”, “decrease”, “reduced”, “reducing”, “reduce” and the like, are used herein generally to mean a decrease or reduction by a statistically significant amount. In some aspects, “decreased” or “reduced” means a reduction by at least 10% as compared to a reference level, for example a decrease or reduction by at least about 20%, or at least about 30%, or at least about 40%, or at least about 50%, or at least about 60%, or at least about 70%, or at least about 80%, or at least about 90% or up to and including a 100% decrease or reduction (e.g., absent level or non-detectable level as compared to a reference level), or any decrease or reduction between 10-100% as compared to a reference level.

Throughout this application, various embodiments may be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Recycled aggregates are manufactured by breaking, removing, and crushing existing concrete into a material with a specified size and quality. See ACI 555 (2001) for more information on processing old concrete into recycled concrete aggregates (the contents of which is herein incorporated by reference in its entirety).

Carbonated recycled aggregates are manufactured by treating recycled aggregates with CO₂. As used herein, the term “accelerant” or “activator” is used in accordance with its plain ordinary meaning and refers a substance that improves the chemical reaction and affords a higher strength material. In embodiments, activators or accelerants contemplated in the present application include, but are not limited to, sulfates, nitrates, phosphates and chloride. In embodiments, the activator may be any sodium, lithium or potassium salt or hydroxide and any alkali or alkali earth metal ions and including Mg(OH)₂, MgO, Ca(OH)₂, CaCO₃, Al₂(SO₄)₃, and/or CaO. The amount of activator or accelerant added may vary depending on various factors. For example, more activator or accelerant may be added to large amounts of material (i.e., high mass). In addition, the lower the ambient temperature, the more activator or accelerant may be used. The amount of activator or accelerant used will vary depending on the amount of and/or type of pozzolan, MgO or Mg(OH)₂ used. The amount of activator or accelerant used will vary depending on the ratio of pozzolan, MgO or Mg(OH)₂ used. The amount of activator or accelerant used will vary based on the aqueous solution (e.g., water, non-potable water, brackish water, brine, concentrated brine, seawater) used.

As used herein, the term “aggregates”, “aggregate”, “filler material” or “other additive” is used in accordance with its plain ordinary meaning and refers to inert granular materials such as sand, gravel, lightweight aggregate, recycled aggregate (RA), carbonated recycled aggregate (CRA), or crushed stone whether normal weight and/or lightweight that, along with cementitious materials and other optional raw materials such as pigment and/or admixtures, are used in concrete. Further, the term “aggregates” as used herein can include ASTM International C 33 fine aggregates, ASTM International C 33 coarse aggregates, and other particulate materials mixed into a cementitious composition. The aggregate can be processed: crushed, screened, and washed to obtain proper cleanliness and gradation. In some cases, a beneficiation process such as jigging or heavy media separation can be used to upgrade the quality. Once processed, the aggregates can be handled and stored to minimize segregation and degradation and prevent contamination and to also protect from the weather as well as to allow to drain away and/or evaporate moisture. Aggregates, from different sources, or produced by different methods, may differ considerably in particle shape, size and texture. Shape of the aggregates of the present disclosure may be cubical and reasonably regular, essentially rounded, angular, or irregular. Surface texture may range from relatively smooth with small, exposed pores to irregular with small to large, exposed pores. Particle shape and surface texture of both fine and coarse aggregates may influence proportioning of mixtures in such factors as workability, pumpability, fine-to-coarse aggregate ratio, and water requirement.

As used herein, the term “aggregate-like, solid particle” refers to a solid particle that visually resembles sand. The particles contemplated herein range in size from about 0.0625 mm to about 40.0 mm. In embodiments, coarse aggregate sizes are larger than 4.75 mm, while fine aggregates are 4.75 mm or less. In embodiments, a maximum size up to 40 mm is used for coarse aggregate in most structural applications, while for mass concreting purposes such as dams, sizes up to 150 mm may be used. In embodiments, fine aggregates have particles up to a minimum size of 0.075 mm.

As used herein, the term “basalt” refers to a fine-grained, extrusive igneous rock formed from the rapid cooling of low-viscosity lava rich in magnesium and iron. While basalt has a relatively lower amount of SiO₂ compared to other common igneous rocks, basalt generally has a composition of 45-52 wt. % SiO₂, 2-5 wt. % total alkalis, 0.5-2.0 wt. % TiO₂, 5-14% wt. %, and 14 wt. % Al₂O₃.

As used herein, the term “brine” is used in accordance with its plain ordinary meaning, and refers to a high concentration of salt in water. In embodiments, the concentration ranges from about 3 g of salt per liter of water to 26 g of salt per liter of water. In embodiments, the salt concentration of brine exceeds that of natural seawater. In embodiments, the salt concentration of brine is at least 101% greater than the salt concentration of natural seawater. In embodiments, the salt concentration of brine ranges from about 101% greater than the salt concentration of natural seawater to about 1000% greater than the salt concentration of natural seawater. In embodiments, brine is also referred to as desalination brine effluent. In embodiments, brine may include, but is not limited to, trace metals such as iron, nickel, chromium, and molybdenum. In embodiments, the brine is not processed. In embodiments, the brine is minimally processed. In embodiments, the brine is highly concentrated. In embodiments, the brine contains one or more reactants. In embodiments, the brine contains at least 75% (by weight) of one or more reactants. In embodiments, the brine is supplemented with one or more reactants.

As used herein, “bauxite” refers to a naturally occurring, heterogeneous material composed primarily of one or more aluminum hydroxide minerals plus various mixtures of silica, iron oxide, titania, aluminosilicate, and other impurities. In embodiments, bauxite residue which is an industrial wasted generated during the processing of bauxite into alumina using the Bayer process forms what is conventionally referred to as “red mud.”

As used herein, “calcined pozzolans” is used in accordance with its plain ordinary meaning and refers to products that are derived from shales and clays.

As used herein “calcium aluminates” refers to a range of materials that are obtained by combining calcium oxide and aluminum oxide in the presence of high temperatures. Calcium aluminates include tricalcium aluminate (3CaO·Al₂O₃), dodecacalcium hepta-aluminate (12CaO·7Al₂O₃) (C₁₂A₇) (mayenite), monocalcium aluminate (CaO·Al₂O₃) (CA) (occurring in nature as krotite and dmitryivanovite as two polymorphs), monocalcium dialuminate (CaO·2Al₂O₃) (CA₂) (occurring in nature as grossite), monocalcium hexa-aluminate (CaO·6Al₂O₃) (CA₆) (occurring in nature as hibonite).

Calcium aluminate cements refer to compositions that are sulfate free and afford hydrated calcium aluminates or carboaluminates. In embodiments, the major constituent and most reactive phase of calcium aluminate cements is monocalcium aluminate (CaO·Al₂O₃), which contain other calcium aluminates as well as a variety of less reactive phases. In embodiments, calcium aluminate cements are able to obtain more strength than ordinary Portland cement. In embodiments, a retarding admixture is used.

As used herein, the term “cement” is used in accordance with its plain ordinary meaning and refers to powdery substance made for use in making mortar or concrete. For example, cement can be a material that sets, hardens, and/or adheres to other materials to bind them to together, for example to make materials such as concrete. In embodiments, concrete is a mineral binder free of any organic compounds. In embodiments, the present application contemplates a Portland-cement free product. Some embodiments contemplate a reduced Portland Cement containing material with less than 90%, 80%, 70%, 60%, 50%, 40%, 30%, 25%, 20%, 15%, 10%, or 5% of Portland Cement; or any sub value or subrange between 0% and 90%. In embodiments, Portland Cement comprises calcium, silicon, aluminum, and iron. In embodiments, Portland Cement comprises CaO, CaCO₃, SiO₂, Al₂O₃, Fe₂O₃, and CaSO₄·H₂O. In embodiments, cement may be characterized as non-hydraulic or hydraulic cement. It should further be understood that “cementitious” can mean a material, including a material according to the embodiments described herein that has one or more of the characteristics or features of cement. In some embodiments, the cementitious composition does not comprise Portland cement.

As used herein, the term “concrete” is used in accordance with its plain ordinary meaning and refers to an artificial, stonelike material used for various structural purposes, made by mixing cement and various aggregates, as sand, pebbles, gravel, or shale, with water and allowing the cementitious composition to harden. In embodiments, the term “stonelike” refers to a material that visually, functionally and/or characteristically resembles stone, including when its hardened state. In embodiments, “concrete-replacement material” is interchangeably used with “artificial, stonelike material” throughout.

As used herein, the term “artificial, stonelike material” refers to a cementitious material used for various structural purposes or non-structural purposes (such as a slab, panel, paver or tile), made by mixing a cement alternative as contemplated herein and various aggregates, as sand, pebbles, gravel, lightweight aggregate, or shale, with water and allowing the cementitious composition to harden. In embodiments, the term “stonelike” refers to a material that visually resembles stone. In embodiments, “concrete-replacement material” is interchangeably used with “artificial, stonelike material” throughout.

As used herein, the term “desalination” is used in accordance with its plain ordinary meaning and refers to the process of removing salts or other minerals and contaminants from seawater, brackish water, well water, and wastewater effluent and it is an increasingly common solution to obtain fresh water for human consumption and for domestic/industrial utilization. As used herein, the phrase “desalination wastewater” refers to reject brine from desalination. In embodiments, the process of removing salt from seawater to afford freshwater produces a highly concentrated brine as a by-product. The by-product is usually disposed of by discharging it back into the sea, a process that requires costly pumping systems and that must be managed carefully to prevent damage to marine ecosystems. This process, if not managed properly, disturbs the local water and sediment by introducing a multi-component waste and increasing temperature, which also endangers the marine organisms due to the residual chemicals mixed into the brine from the pre-treatment process.

As used herein, the term “freshwater” refers to water with a low dissolved salt concentration. In embodiments, freshwater does not include seawater and brackish water. In embodiments, freshwater may include, but is not limited to, frozen and meltwater in ice sheets, ice caps, glaciers, snowfields and icebergs, natural precipitation (e.g., rainfall, snowfall, hail, sleet). In embodiments, the salt concentration is less than 5%, less than 4%, less than 3%, less than 2%, and less than 1%, including sub-values in-between.

As used herein, the term “non-hydraulic cement” is used in accordance with its plain ordinary meaning and refers to cement that does not set in wet conditions or under water. In embodiments, non-hydraulic cement sets as it dries and reacts with CO₂ in the air. In embodiments, non-hydraulic cement is resistant to degradation by chemicals after setting.

As used herein, the term “hydraulic cement” is used in accordance with its plain ordinary meaning and refers to cement that sets in wet conditions due to a chemical reaction between the dry ingredients and water. In embodiments, the chemical reaction results in mineral hydrates that are either completely or nearly insoluble in water. In embodiments, hydraulic cement also refers to Portland Cement.

As used herein, the term “latently hydraulic material” is used in accordance with its plain ordinary meaning. In some cases, the latently hydraulic material is a slag, as used herein. In some cases, the latently hydraulic material is a natural pozzolan or a manmade pozzolan and which has latently hydraulic properties. A latently hydraulic material may be a material that will react with water to form a solid over an extended period of time.

As used herein, the term “mixing” is used in accordance with its plain ordinary meaning and refers to any form of mixing and may include milling or grinding of substances in solid form. As used herein, the term “mortar” is used in accordance with its plain ordinary meaning and refers to a material composed of binder(s).

As used herein, the term “negative carbon dioxide-emitting concrete-replacement material” refers to a material that has a net positive CO₂ absorption as opposed to having a lower carbon footprint. In embodiments, the present application contemplates a material that produces carbon credits. In embodiments, the concrete-replacement material absorbs more carbon dioxide than is emitted.

As used herein, the term “seawater” is used in accordance with its plain ordinary meaning and refers to water from the sea or ocean. In embodiments, seawater includes various salts, dissolved inorganic (e.g., minerals) and organic compounds, and other particulates.

As used herein, the term “silane” is used in accordance with its plain ordinary meaning. In embodiments, silane is used as a coupling reagent between two dissimilar materials, which creates critical surface tension.

As used herein, the term “slag” is used in accordance with its plain ordinary meaning and means any type of slag and may be used interchangeably with “ground-granulated blast-furnace slag.” Ground-granulated blast-furnace slag (“GGBFS”) refers to a composition obtained by quenching molten iron slag (a by-product of iron and steel-making) from a blast furnace in water or steam, to produce a glassy, granular product that is then dried and ground into a fine powder. In embodiments, slag includes any by-product following the separation (e.g., via smelting) of a metal from its raw ore that has cementitious components and/or characteristics. In embodiments, slag includes, but is not limited to, arc furnace slag, foundry furnace slag, induction furnace slag, and the like. In general, furnace slag is a non-metallic by-product comprising silicates, calcium-alumina-silicates. Slag may include slag from any metal, for example and without limitation steel, iron, copper, nickel, lead, aluminum, and zinc. Without being bound to any one theory, the slags contemplated herein relate to the use as a binder, which provides hydraulicity. The hydraulicity in turn may modulate the compression strength of the material. As contemplated herein, the use of ground-granulated blast-furnace slag reduces iron waste disposal in landfills. In some embodiments, the slag satisfies the ASTM requirements.

As used herein, the term “slurry” is used in accordance with its plain ordinary meaning and refers to a mixture of denser solids suspended in liquid. In embodiments, “brine slurry” refers to desalinated water waste product.

As used herein, the term “structural component” refers to any vertical or horizontal load-bearing member of a structure which supports dead or live loads in addition to its own weight and includes, but is not limited to, a foundation, an exterior or interior load-bearing wall, a column, a column beam, a floor, and a roof structure.

As used herein, the term “mold” refers to any container or form used to give shape to the material. In embodiments, a mold includes a well.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed. In addition, all sub-combinations are also specifically embraced by the present invention and are disclosed herein just as if each and every such sub-combination was individually and explicitly disclosed herein.

Any composition or method disclosed herein is applicable to any herein-disclosed composition or method. In other words, any aspect or embodiment described herein can be combined with any other aspect or embodiment as disclosed herein.

### Abbreviations

CRA: Carbonated recycled aggregate
HMCs: Hydrated magnesium carbonates
ITZ: Interfacial transition zones before carbonation
ITZ′: Improved interfacial transition zones after carbonation
NA: Natural aggregate
NAC: Natural aggregate concrete
OM: Old mortar
OPC: Ordinary Portland cement
RA: Recycled aggregate
RAC: Recycled aggregate concrete
RMC: Reactive magnesia cement
Specific surface area: SSA
I-RA, II-RA, and III-RA: Respectively, grade I RA, grade II RA, and grade III RA I-CRA, II-CRA, and III-CRA: Respectively, carbonated grade I RA, carbonated grade II RA, and carbonated grade III RA
I-CRA-C, II-CRA-C, and III-CRA-C: Respectively, CO2-cured RMC-based concrete containing I-CRA, II-CRA, and III-CRA
I-CRA-A, II-CRA-A, and III-CRA-A: Respectively, Air-cured RMC-based concrete containing I-CRA, II-CRA, and III-CRA

### REFERENCES

Y. Pu, L. Li, Q. Wang, X. Shi, C. Luan, G. Zhang, L. Fu, A. E.-F. Abomohra, Accelerated carbonation technology for enhanced treatment of recycled concrete aggregates: A state-of-the-art review, Construction and Building Materials, 282 (2021) 122671.
C. Liang, B. Pan, Z. Ma, Z. He, Z. Duan, Utilization of CO2 curing to enhance the properties of recycled aggregate and prepared concrete: A review, Cement and concrete composites, 105 (2020) 103446.
A. Mistri, N. Dhami, S. K. Bhattacharyya, S. V. Barai, A. Mukherjee, Performance of biocement treatment in improving the interfacial properties of recycled aggregate concrete, Construction and Building Materials, 369 (2023) 130509.
A. Nayana, S. Kavitha, Evaluation of CO2 emissions for green concrete with high volume slag, recycled aggregate, recycled water to build eco environment, Int. J. Civ. Eng. Technol, 8 (2017) 703-708.
GB/T 25177-2010 Recycled coarse aggregate for concrete [S], Beijing, 2010.
R. Mi, K. Liew, G. Pan, New insights into diffusion and reaction of CO2 gas in recycled aggregate concrete, Cement and Concrete Composites, (2022) 104486.
A. Eftekhari, High-Energy Aqueous Lithium Batteries, Advanced Energy Materials, 8 (2018) 1801156.
C. Shi, Y. Li, J. Zhang, W. Li, L. Chong, Z. Xie, Performance enhancement of recycled concrete aggregate—A review, Journal of Cleaner Production, 112 (2016) 466-472.
B. Wang, L. Yan, Q. Fu, B. Kasal, A comprehensive review on recycled aggregate and recycled aggregate concrete, Resources, Conservation and Recycling, 171 (2021) 105565.
B. Zhan, C. S. Poon, Q. Liu, S. Kou, C. Shi, Experimental study on CO2 curing for enhancement of recycled aggregate properties, Construction and Building Materials, 67 (2014) 3-7.
S. Kou, B. Zhan, C.-S. Poon, Use of a CO2 curing step to improve the properties of concrete prepared with recycled aggregates, Cement and Concrete Composites, 45 (2014) 22-28.
B. J. Zhan, D. X. Xuan, C. S. Poon, K. L. Scrivener, Characterization of interfacial transition zone in concrete prepared with carbonated modeled recycled concrete aggregates, Cement and Concrete Research, 136 (2020) 106175.
S. Ruan, C. Unluer, Comparative life cycle assessment of reactive MgO and Portland cement production, Journal of Cleaner Production, 137 (2016) 258-273.
L. Mo, D. K. Panesar, Effects of accelerated carbonation on the microstructure of Portland cement pastes containing reactive MgO, Cement and Concrete Research, 42 (2012) 769-777.
L. Mo, F. Zhang, M. Deng, D. K. Panesar, Effectiveness of using CO2 pressure to enhance the carbonation of Portland cement-fly ash-MgO mortars, Cement and Concrete Composites, 70 (2016) 78-85.
K. Gu, B. Chen, P. Yan, J. Wang, Recycling of phosphate tailings and acid wastewater from phosphorus chemical industrial chain to prepare a high value-added magnesium oxysulfate cement, Journal of Cleaner Production, 369 (2022) 133343.
D. Meng, C. Unluer, E.-H. Yang, S. Qian, Recent advances in magnesium-based materials: CO2 sequestration and utilization, mechanical properties and environmental impact, Cement and Concrete Composites, 138 (2023) 104983.
S. Ruan, J. Qiu, Y. Weng, Y. Yang, E.-H. Yang, J. Chu, C. Unluer, The use of microbial induced carbonate precipitation in healing cracks within reactive magnesia cement-based blends, Cement and Concrete Research, 115 (2019) 176-188.
I. Singh, R. Hay, K. Celik, Recovery and direct carbonation of brucite from desalination reject brine for use as a construction material, Cement and Concrete Research, 152 (2022) 106673.
X. Chen, T. Zhang, C. Cheeseman, W. Bi, S. Wang, Production of Rapid-Hardening Magnesium Oxysulfate Cement Containing Boric Acid, Journal of Materials in Civil Engineering, 34 (2022) 04022045.
E. G. Soares, J. Castro-Gomes, Carbonation curing Influencing factors of carbonated reactive magnesia cements (CRMC)—a review, Journal of Cleaner Production, 38 (2021) 127210.
T. Gonçalves, R. Silva, J. De Brito, J. Fernández, A. Esquinas, Mechanical and durability performance of mortars with fine recycled concrete aggregates and reactive magnesium oxide as partial cement replacement, Cement and Concrete Composites, 105 (2020) 103420.
A. Heidari, M. Hashempour, M. D. Chermahini, Influence of reactive MgO hydration and cement content on C&DW aggregate concrete characteristics, International Journal of Civil Engineering, 17 (2019) 1095-1106.
D.-H. Vo, C.-L. Hwang, K.-D. Tran Thi, M. D. Yehualaw, W.-C. Chen, Effect of fly ash and reactive MgO on the engineering properties and durability of high-performance concrete produced with alkali-activated slag and recycled aggregate, Journal of Materials in Civil Engineering, 32 (2020) 04020332.
C. Pan, Y. Song, J. Wang, S. Zhan, C. Unluer, S. Ruan, Unlocking the role of recycled aggregates in the performance enhancement and CO2 capture of reactive magnesia cement formulations, Cement and Concrete Research, 168 (2023) 107148.
C. Pan, Y. Song, Y. Zhao, T. Meng, Y. Zhang, R. Chen, X. Zhou, S. Ruan, Performance buildup of reactive magnesia cement (RMC) formulation via using CO2-strengthened recycled concrete aggregates (RCA), Journal of Building Engineering, 65 (2022) 105779.
YB/T 4019-2020 Determination of chemical activity of light calcined magnesia [S], Beijing, 2020.
GB/T 50082-2009 Standard for test methods of long-term performance and durability of ordinary concrete [S], Beijing, 2009.
GB/T14684-2022 Sand for construction [S], Beijing, 2022.
GB/T 14685-2022 Pebble and crushed stone for construction [S], Beijing, 2022.
T. Zhang, B. Ma, H. Tan, X. Liu, P. Chen, Z. Luo, Effect of TIPA on mechanical properties and hydration properties of cement-lithium slag system, Journal of Environmental Management, 276 (2020) 111274.
Z. L. Wu, Huizhen, The High Performance Concrete (in Chinese), China Railway Publishing House, Beijing, 1999.
N. Dung, C. Unluer, Influence of nucleation seeding on the performance of carbonated MgO formulations, Cement and Concrete Composites, 83 (2017) 1-9.
S. Ruan, C. Unluer, Influence of mix design on the carbonation, mechanical properties and microstructure of reactive MgO cement-based concrete, Cement and Concrete Composites, 80 (2017) 104-114.
GB/T 50081-2019 Standard for test methods of concrete physical and mechanical properties, 2019.
R. Hay, K. Celik, Accelerated carbonation of reactive magnesium oxide cement (RMC)-based composite with supercritical carbon dioxide (scCO2), Journal of Cleaner Production, 248 (2020) 119282.
Y. Song, X. Qian, D. Yan, C. Unluer, Y. Peng, D. Kong, C. Hu, S. Wang, S. Ruan, Understanding the role of seeds in reactive magnesia cement (RMC) formulations, Journal of the American Ceramic Society, 106 (2023) 3812-3831.
Y. Song, M. Dong, Z. Wang, X. Qian, D. Yan, S. Shen, L. Zhang, G. Sun, J. Lai, S. Ruan, Effects of red mud on workability and mechanical properties of autoclaved aerated concrete (AAC), Journal of Building Engineering, (2022) 105238.
R. Ma, Q. Chen, Z. Jiang, X. Qian, Y. Song, S. Ruan, Performances of UHPC bonded cementitious composite systems containing styrene-butadiene rubber latex in a chloride-rich environment, Construction and Building Materials, 353 (2022) 129126.
Q. Chen, R. Ma, H. Li, Z. Jiang, H. Zhu, Z. Yan, Effect of chloride attack on the bonded concrete system repaired by UHPC, Construction and Building Materials, 272 (2021).
Y. Xing, B. Wang, Effect of the Chemical Nature of Polyvinyl Alcohol on the Microstructure of Cement Hydration Products, Journal of Materials in Civil Engineering, 35 (2023) 04023201.
C. Unluer, A. Al-Tabbaa, Enhancing the carbonation of MgO cement porous blocks through improved curing conditions, Cement and Concrete Research, 59 (2014) 55-65.
C. Unluer, A. Al-Tabbaa, Characterization of light and heavy hydrated magnesium carbonates using thermal analysis, Journal of Thermal Analysis and calorimetry, 115 (2014) 595-607.
M. Liska, A. Al-Tabbaa, Ultra-green construction: reactive magnesia masonry products, Proceedings of the Institution of Civil Engineers-Waste and Resource Management, Thomas Telford Ltd, 2009, pp. 185-196.
S. Ruan, C. Unluer, Effect of air entrainment on the performance of reactive MgO and PC mixes, Construction and Building Materials, 142 (2017) 221-232.
Y. Kong, Y. Song, K. Kurumisawa, T. Wang, D. Yan, Q. Zeng, X. Zhou, S. Ruan, Use of hydrated cement pastes (HCP) as a CO2 sponge, Journal of CO2 Utilization, 55 (2022) 101804.
T. Zhang, J. Zhang, J. Chang, W. Bi, C. Cheeseman, X. Chen, Hydration and strength development in magnesium oxysulfate (MOS) cement incorporating silicic acid, Composites Part B: Engineering, (2023) 111081.
X. Chen, S. Wang, Y. Zhou, C. Cheeseman, W. Bi, T. Zhang, Improved low-carbon magnesium oxysulfate cement pastes containing boric acid and citric acid, Cement and Concrete Composites, 134 (2022) 104813.
C. Pan, Y. Song, Y. Zhao, T. Meng, Y. Zhang, R. Chen, X. Zhou, S. Ruan, Performance buildup of reactive magnesia cement (RMC) formulation via using CO2-strengthened recycled concrete aggregates (RCA), Journal of Building Engineering, 65 (2023) 105779.
S. Lian, T. Meng, H. Song, Z. Wang, J. Li, Relationship between percolation mechanism and pore characteristics of recycled permeable bricks based on X-ray computed tomography, Reviews on Advanced Materials Science, 60 (2021) 207-215.
S. Lian, S. Ruan, S. Zhan, C. Unluer, T. Meng, K. Qian, Unlocking the role of pores in chloride permeability of recycled concrete: A multiscale and a statistical investigation, Cement and Concrete Composites, 125 (2022) 104320.
R. Yang, Q. Zeng, Y. Peng, H. Wang, Z. Wang, Anomalous matrix and interlayer pore structure of 3D-printed fiber-reinforced cementitious composites, Cement and Concrete Research, 157 (2022) 106829.
W. Li, C. Long, V. W. Tam, C.-S. Poon, W. H. Duan, Effects of nano-particles on failure process and microstructural properties of recycled aggregate concrete, Construction and Building Materials, 142 (2017) 42-50.
R. Hay, J. Li, K. Celik, Influencing factors on micromechanical properties of calcium (alumino) silicate hydrate C-(A-) SH under nanoindentation experiment, Cement and Concrete Research, 134 (2020) 106088.
G. Fang, Q. Wang, M. Zhang, Micromechanical analysis of interfacial transition zone in alkali-activated fly ash-slag concrete, Cement and Concrete Composites, 119 (2021) 103990.
L. Vandeperre, M. Liska, A. Al-Tabbaa, Microstructures of reactive magnesia cement blends, Cement and Concrete Composites, 30 (2008) 706-714.
L. Pu, C. Unluer, Investigation of carbonation depth and its influence on the performance and microstructure of MgO cement and PC mixes, Construction and Building Materials, 120 (2016) 349-363.
R. Hay, K. Celik, Enhancing carbonation of magnesium oxide (MgO) cement (RMC)-based composites with calcined limestone, Cement, 9 (2022) 100037.
C. Kuenzel, F. Zhang, V. Ferrandiz-Mas, C. Cheeseman, E. Gartner, The mechanism of hydration of MgO-hydromagnesite blends, Cement and Concrete Research, 103 (2018) 123-129.
X. Ma, J. Liu, Z. Wu, C. Shi, Effects of SAP on the properties and pore structure of high performance cement-based materials, Construction and Building Materials, 131 (2017) 476-484.
M. El-Hawary, A. Al-Sulily, Internal curing of recycled aggregates concrete, Journal of Cleaner Production, 275 (2020) 122911.
N. Dung, A. Lesimple, R. Hay, K. Celik, C. Unluer, Formation of carbonate phases and their effect on the performance of reactive MgO cement formulations, Cement and Concrete Research, 125 (2019) 105894.
T. Kuang, Effect of carbonization on microstructure of recycled concrete, Southeast University, 2018.
S. Seraj, R. D. Ferron, M. C. Juenger, Calcining natural zeolites to improve their effect on cementitious mixture workability, Cement and Concrete Research, 85 (2016) 102-110.
D. Hou, D. Li, P. Hua, J. Jiang, G. Zhang, Statistical modelling of compressive strength controlled by porosity and pore size distribution for cementitious materials, Cement and Concrete Composites, 96 (2019) 11-20.
N. Zhang, C. Yan, L. Li, M. Khan, Assessment of fiber factor for the fracture toughness of polyethylene fiber reinforced geopolymer, Construction and Building Materials, 319 (2022) 126130.
N. Dung, R. Hay, A. Lesimple, K. Celik, C. Unluer, Influence of CO₂ concentration on the performance of MgO cement mixes, Cement and Concrete Composites, 115 (2021) 103826.
L. Korat, V. Ducman, A. Legat, B. Mirtič, Characterisation of the pore-forming process in lightweight aggregate based on silica sludge by means of X-ray micro-tomography (micro-CT) and mercury intrusion porosimetry (MIP), Ceramics International, 39 (2013) 6997-7005.
Y. Zhang, S. Xu, Y. Gao, J. Guo, Y. Cao, J. Zhang, Correlation of chloride diffusion coefficient and microstructure parameters in concrete: A comparative analysis using NMR, MIP, and X-CT, Frontiers of Structural and Civil Engineering, 14 (2020) 1509-1519.
X. Chen, S. Wu, J. Zhou, Experimental study and analytical model for pore structure of hydrated cement paste, Applied Clay Science, 101 (2014) 159-167.
R. Dodo, M. Abdulwahab, A. Abdullahi, A. Saeed, Effect of granite particle size on the properties of Al-7% Si-0.3% Mg/granite particulate composites, Silicon, 10 (2018) 2211-2217.
S. Seetharam, R. Patel, J. Perko, D. Jacques, Quantification of leaching kinetics in OPC mortars via a mesoscale model, Construction and Building Materials, 180 (2018) 614-628.
Z. Li, J. Qian, J. Qin, Y. Hua, Y. Yue, H. Tang, Cementitious and hardening properties of magnesia (MgO) under ambient curing conditions, Cement and Concrete Research, 170 (2023) 107184.
K. Gu, B. Chen, Q. Cui, Experimental research on properties of magnesium oxysulfate cement during high temperature exposure, Composites Part B: Engineering, 244 (2022) 110168.
L. Pu, S. Ruan, C. Pan, Y. Song, F. Zhou, J. Lai, K. Qian, Q. Li, Pore structures and interfacial properties between hydrated magnesia carbonates-modified recycled aggregate and reactive magnesia paste, Construction and Building Materials, 404 (2023) 133190.
S. T. Yildirim, C. Meyer, S. Herfellner, Effects of internal curing on the strength, drying shrinkage and freeze-thaw resistance of concrete containing recycled concrete aggregates, Construction and Building Materials, 91 (2015) 288-296.
G. Yang, Q. Li, Y. Guo, H. Liu, S. Zheng, M. Chen, Study on the mechanical properties and durability of recycled aggregate concrete under the internal curing condition, Materials, 15 (2022) 5914.
K. Wu, S. Luo, J. Zheng, J. Yan, J. Xiao, Influence of carbonation treatment on the properties of multiple interface transition zones and recycled aggregate concrete, Cement and Concrete Composites, 127 (2022) 104402.
Y. Xu, Y. Song, Chemical-mechanical transformation of the expansion effect for nonuniform steel corrosion and its application in predicting the concrete cover cracking time, Cement and Concrete Composites, 127 (2021) 104376.
L. Ferreira, J. De Brito, M. Barra, Influence of the pre-saturation of recycled coarse concrete aggregates on concrete properties, Magazine of Concrete Research, 63 (2011) 617-627.
H. Zhang, X. Xu, W. Liu, B. Zhao, Q. Wang, Influence of the moisture states of aggregate recycled from waste concrete on the performance of the prepared recycled aggregate concrete (RAC)—A review, Construction and Building Materials, 326 (2022) 126891.
A. S. Brand, J. R. Roesler, A. Salas, Initial moisture and mixing effects on higher quality recycled coarse aggregate concrete, Construction and Building Materials, 79 (2015) 83-89.
M. B. de Oliveira, E. Vazquez, The influence of retained moisture in aggregates from recycling on the properties of new hardened concrete, Waste management, 16 (1996) 113-117.
J. Wu, L. Zhang, Influence of initial moisture content of recycled coarse aggregates on the properties of fresh and hardened concrete, Journal of Civil Engineering and Management, 33 (2016) 97-102.
Y. Liu, P. Ren, N. Garcia-Troncoso, K. H. Mo, T.-C. Ling, Roles of enhanced ITZ in improving the mechanical properties of concrete prepared with different types of recycled aggregates, Journal of Building Engineering, 60 (2022) 105197.
Z. H. Duan, C. S. Poon, Properties of recycled aggregate concrete made with recycled aggregates with different amounts of old adhered mortars, Materials & Design, 58 (2014) 19-29.
PCT/US2020/036848, PCT/US2023/032043, PCT/US2023/085531, PCT/US2025/018367, and PCT/US2024/013143.

The entire contents of each of which is herein incorporated by reference.

### EXAMPLES

### Example 1: Materials and Methodology

### Materials and Specimen Preparation

The cement binder used in this study was calcined magnesite. Its specific surface area (SSA) obtained by Brunauer Emmett Teller testing was 29.1 m²/g and acid neutralization time (tested according to YB/T 4019-2020) was 405 seconds. Besides, its chemical composition was MgO: 94.97%; SiO₂: 2.97%; CaO: 1.25%; Fe₂O₃: 0.44%; Al₂O₃: 0.26%; SO₃: 0.12%.

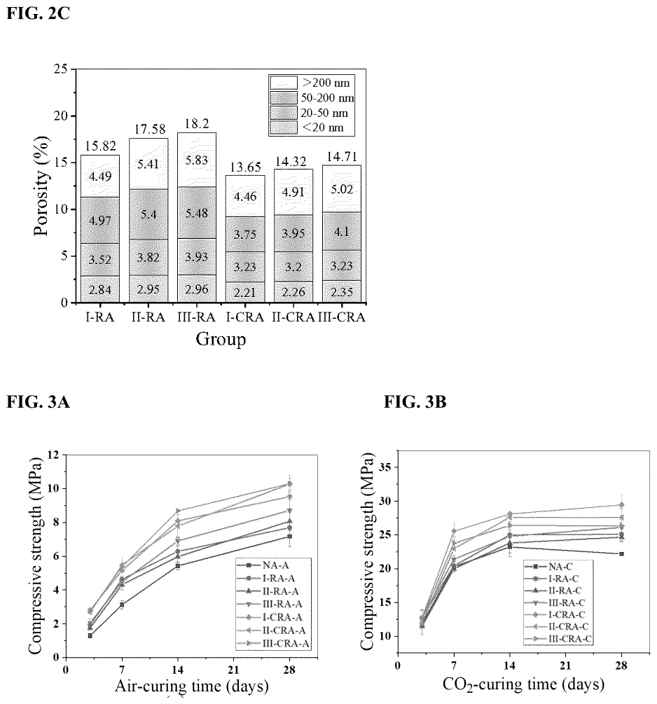

The coarse aggregates used in this study included natural aggregate (NA) and three grades of recycled aggregate (RA) (~I-RA, II-RA, and III-RA) with different qualities, and all single-size graded with a 4.75-9.5 mm diameter. The CO₂ treatment of recycled aggregate followed the standard outlined in GB/T 50082-2009 (the entire contents of which is herein incorporated by reference). The process initiated with the carbonation of recycled aggregate within an HTX-12X carbonation chamber, sustaining fixed curing conditions: a CO₂ concentration of 20±2%, a relative humidity of 70±5%, and a temperature of 20±2° C. Subsequently, 3 kg of RA was evenly dispersed in a container measuring 56 cm×37 cm×8 cm, undergoing regular stirring every 48 hours. This curing process continued for 7 days, resulting in CO₂-pretreated RA identified as I-CRA, II-CRA, and III-CRA, respectively. The impurity and chloride content of RA were tested according to the standard GB/T 25177-2010 and GB/T 14684-2022, respectively (the entire contents of each of which is herein incorporated by reference). All the key properties of recycled aggregate (RA) or carbonated recycled aggregate (CRA), that is, apparent density, water absorption and the crushing index loss, were measured in line with the standard GB/T 14685-2022 (the entire contents of which is herein incorporated by reference). FIG. 2A to FIG. 2C show the chemical composition and pore structure of mortar at recycled aggregate (RA) or carbonated recycled aggregate (CRA) surface. The CaCO₃ peak also exists in RA, as Ca(OH)₂ in RA reacted with CO₂ in air (FIG. 2A). CRA exhibited weaker Ca(OH)₂ and a stronger CaCO₃ peak than RA. Moreover, III-CRA/I-CRA revealed the greatest/smallest reduction in porosity (19.2% and 13.7%), respectively (FIG. 2B). Among them, the percentage of harmful pores (50-200 nm) and multi-harmful holes (>200 nm) decreased significantly (FIG. 2C). Overall, the pore structure of CRA is refined as CaCO₃ and silica gel fill the pores, so their properties (apparent density, water absorption and crushing index loss) are enhanced (Table 1). III-CRA/I-CRA exhibited greatest/smallest improvement degree of these indicators, consistent with their phase and pore structure changes obtained by X-ray diffraction (XRD) and mercury intrusion porosimetry (MIP) tests.

TABLE 1
Properties of recycled aggregate (RA) and carbonated recycled aggregate (CRA).

| Physical | | | | | | |
|---|---|---|---|---|---|---|
| properties | I CRA | II CRA | III CRA | I RA | II RA | III RA |
| Apparent | 2633 ± 5 | 2577 ± 7 | 2502 ± 7 | 2620 ± 6 | 2546 ± 11 | 2465 ± 8 |
| density | | | | | | |
| (kg/m3) | | | | | | |
| Water | 2.4 ± 0.04 | 3.4 ± 0.07 | 3.9 ± 0.09 | 2.8 ± 0.05 | 4.3 ± 0.11 | 5.5 ± 0.03 |
| absorption | | | | | | |
| (wt. %) | | | | | | |
| Crushing | 7.7 ± 0.29 | 8.8 ± 0.25 | 12.4 ± 0.20 | 8.1 ± 0.33 | 9.3 ± 0.19 | 17.7 ± 0.39 |
| index loss | | | | | | |
| (%) | | | | | | |

Note:
The corresponding tests were performed twice and only the average value was reported.

Besides, to avoid quartz contamination during the quantification of mineral phases formed, coarse aggregates with a particle size of 4.75-9.5 mm were involved in forming the aggregate profile in the prepared reactive magnesia cement (RMC)-based specimens. Table 2 shows the mixture formulations of RMC-based concrete.

TABLE 2
Mixture formulations of reactive magnesia cement (RMC)-
based concrete specimens prepared in this study.

| | | Mix composition (kg/m³) | | | Curing |
|---|---|---|---|---|---|
| Group | Aggregate | RMC | Aggregates | Water | regime |
| NA-A | NA | 655.7 | 983.6 | 360.7 | Air |
| I-RA-A | Grade I RA | | | | curing |
| II-RA-A | Grade II RA | | | | |
| III-RA-A | Grade III RA | | | | |
| I-CRA-A | Carbonated | | | | |
| | grade I RA | | | | |
| II-CRA-A | Carbonated | | | | |
| | grade II RA | | | | |
| III-CRA-A | Carbonated | | | | |
| | grade III RA | | | | |
| NA-C | NA | 655.7 | 983.6 | 360.7 | CO₂ |
| I-RA-C | Grade I RA | | | | curing |
| II-RA-C | Grade II RA | | | | |
| III-RA-C | Grade III RA | | | | |
| I-CRA-C | Carbonated | | | | |
| | grade I RA | | | | |
| II-CRA-C | Carbonated | | | | |
| | grade II RA | | | | |
| III-CRA-C | Carbonated | | | | |
| | grade III RA | | | | |

The concrete preparation was in line with reference: RMC and RA were mixed first, and water was then added gradually during mixing. Then the fresh slurry was cast into cubic molds with 50 mm×50 mm×50 mm, compacted with a vibrating table and levelled with a trowel. The casting and vibration were repeated twice, with one half added each time. Meanwhile, following 24 hours for concrete demolding, the specimens underwent further curing in an ambient or CO₂ environment within a curing environmental chamber (specifically: CO₂ concentration: 20±2%; Relative humidity: 60±5%; Temperature: 20±2° C.). The selected parameters for the curing regime were justified by previous work. All specimens were cured for up to 28 days prior to the test.

### Methodology; Compressive Strength

Concrete strength was evaluated using the NYL-60 pressure testing machine with a loading rate of 60 kN/min. Each group underwent tests with three specimens, and the recorded average and standard deviation were reported.

### XRD, TG-DTG, and FTIR Analyses

XRD, TG-DTG, and FTIR analyses were conducted to assess both qualitative and quantitative changes in mineral phases present in RMC formulations. The sampling strategies for different microstructural characterizations are illustrated in FIG. 1. Microstructural analysis was performed on specimens obtained at 3 and 14 days, consistent with previous references. Paste segments extracted from the surface of the concrete cubes after compression testing were employed for the microstructural analysis. Different regions of the RMC-based specimens, namely the interior (≥10 mm away from the surface) and exterior (≤5 mm away from the surface), were extracted for the investigation of hydration/carbonation behaviors and properties of aggregate/Interfacial transition zones (ITZ) in the specimens.

To prevent quartz contamination, aggregates were separated. The paste segments were immersed in ethanol for 3 days to arrest hydration, and subsequently subjected to vacuum drying (~40° C.) for an additional 3 days. Post-drying, the specimens were ground to pass through a 75 μm sieve before the microstructural analysis.

For X-ray diffraction (XRD) analysis, a Bruker D8 Advance diffractometer was used, operating at 40 kV and 40 mA, employing Cu-Kα radiation. Scanning was conducted from 5° to 90° 20 at a rate of 0.02°/step. The Relative Intensity Ratio (RIR) method (see, e.g., C. Unluer, A. and Al-Tabbaa, “Enhancing the carbonation of MgO cement porous blocks through improved curing conditions”, Cement and Concrete Research, 59 (2014) 55-65 and C. Unluer and A. Al-Tabbaa, “Characterization of light and heavy hydrated magnesium carbonates using thermal analysis”, Journal of Thermal Analysis and calorimetry, 115 (2014) 595-607, the entire contents of each of which is incorporated herein by reference) facilitated quantitative phase analysis. A fluorite internal standard material (20 wt % CaF₂) was utilized. The weight fractions of MgO and Mg(OH)₂ were calculated using the equation y=kx, where x represents the RIR of the phase being analyzed, determined by dividing the integrated intensity of the phase with the strongest line by that of fluorite, and y is the weight fraction of MgO or Mg(OH)₂. The values of k are 0.2886 for MgO and 0.3651 for Mg(OH)₂. The test was conducted twice, and the average value was calculated.

A TGA2 (Mettler Toledo Crop., Switzerland) was used for Thermogravimetric-Derivative thermogravimetric analysis (TG-DTG) measurements, involving heating the specimen from 30 to 1000° C. at a rate of 10° C./min with a nitrogen flow of 50 mL/min.

Fourier Transform Infrared (FTIR) data were obtained using a NICOLET iS50FT-IR Spectrometer (Thermo Scientific, USA). Each specimen was subjected to 32 scans within the spectral range from 4000 to 400 cm⁻¹.

### X-CT Analyses

The Nikon XTH320 facilitated X-ray Computed Tomography (X-CT) analyses with a working voltage of 180 kV and a current of 220 μA. Throughout the X-CT test, 2000 projections were gathered from diverse angles as the specimen rotated uniformly by 360°, with an exposure time of 0.5 seconds per projection. The resultant X-CT images displayed a pixel resolution of 13 μm/pixel. CTPro and VGStudio software was used for generating gray images and conducting pore analysis, and the region of interest (ROI) with 42×42×42 mm³ was chosen. As the lower grey values of the pore phase distinguished from the higher ones of the solid phase, the threshold for phase segmentation was performed based on the method of global Gaussian blur.

### MIP

The concrete (in the final setting state) was crushed to study the capillary pores parameter of Interfacial transition zones (ITZ). The aggregate (≥10 mm away from the surface) was taken and the sample was scraped, which was consistent with the reference. The scraped sample was soaked in anhydrous ethanol for two days to terminate the hydration process. After removal, it was dried at 60° C. and then subjected to mercury intrusion porosimetry (MIP) test using AutoPore 9600 automatic mercury porosimeter, with testing pressures ranging from 0.4 to 30000 psi.

### Nanoindentation

Specimens sampled from both the interior and exterior regions of the concrete (3 samples prepared in each group) were treated by impregnating them with a fast-hardening epoxy solution in cylinder molds (@25×50 mm). These molds underwent air curing (~15° C.) for 2 hours, followed by an additional 1 day in an oven (25° C.). Afterwards, the specimens were demoulded for grinding and polishing using an Ecomet 250 grinder/polisher.

The grinding and polishing steps replicated those described in reference. Initially, silicon carbide sandpaper with particle sizes of 180, 600, 1200, and 2000 were used for rough grinding, each group for 5 minutes. Subsequently, the specimens were polished sequentially using 3, 1, and 0.25 μm diamond spray polishing agents, with a duration of 15 minutes each. The turntable and base rotational speed were maintained at 30 r/min, and a loading force of 5 N was applied. The NT9100 profiler gauged the root mean square (RMS) roughness of the specimen. The selected area size was 63×47 μm, with an assessment of 5 positions in the ITZ per specimen to compute the average value. The average indentation depth (approximately 327 nm) was nearly 3 times the average RMS roughness (around 113 nm), indicating the mitigation of roughness effects on the measured properties.

In the ITZ grid nanoindentation tests, the Agilent G200 nanoindentation tester applied a maximum load of 2 mN. Loading (t_{L}), unloading (t_{U}), and maintaining maximum load (t_{H}) durations were set at 10 seconds, 10 seconds, and 5 seconds, respectively, during the indentation process. The horizontal and vertical spacing between adjacent indentation points was 20 μm, within a grid range of 100×180 μm. Considering heterogeneous microstructure of recycled aggregates, 3 samples were prepared in each group for reliable measurement on ITZ characterization. Furthermore, and the test details were detailed elsewhere; see, e.g., C. Pan, et. al., “Unlocking the role of recycled aggregates in the performance enhancement and CO₂ capture of reactive magnesia cement formulations”, Cement and Concrete Research, 168 (2023) 107148, the entire contents of which is incorporated herein by reference.

### Example 2: Results

### Compressive Strength

FIG. 3A and FIG. 3B depict the compressive strength of specimens incorporating natural aggregate (NA), recycled aggregate (RA), and carbonated recycled aggregate (CRA) with different grades after air or CO₂ curing for up to 28 days. Under air-curing conditions, the utilization of RA and CRA in reactive magnesia formulations exhibited marginally higher strength than their NA counterparts, potentially linked to the greater water absorption exhibited by RA and CRA, as mentioned previously. Studies reported that due to the high-water demand of reactive MgO, the microstructures tended to remain more open and particulate, wherein MgO particles tended to agglomerate. However, RA and CRA utilization reduced the effective water-to-cement ratio, resulting in a denser concrete microstructure, which contributes to the superior strength of specimens with recycled aggregate (RA) or carbonated recycled aggregate (CRA).

Comparatively, CO₂ curing notably enhanced the compressive strength of all groups, particularly in the early stages (i.e., 3 days). However, as the curing duration increased, the rate of strength gain diminished due to the formation of a dense carbonation layer on the specimen surface, hindering CO₂ diffusion and limiting strength enhancement. In specific instances, the strength of certain specimens decreased over time, such as in the NC—C group, likely due to cracks formed within RMC concrete caused by excessive expansion of hydrated magnesium carbonates (HMC) and Mg(OH)₂ during hydration or carbonation. Nevertheless, the strength gain rates of RA-C and CRA-C groups remained higher than the NA-C group across all curing ages, facilitated by the significantly greater channels for CO₂ diffusion within the recycled aggregate (RA) or carbonated recycled aggregate (CRA) specimens.

Regarding the advantages of employing CRA in reactive magnesia cement (RMC)-based specimens, the graphical representation of the impact of CO₂ pretreatment on recycled aggregate (RA) reveals the strength improvements in specimens containing CRA compared to those with RA, regardless of the curing age or regime, although the level of strength enhancement varies. R. Hay and K. Celik, “Enhancing carbonation of magnesium oxide (MgO) cement (RMC)-based composites with calcined limestone”, Cement, 9 (2022) 100037 (the entire contents of which is incorporated herein by reference) highlighted that CO₂ pretreatment of RA (~CRA) facilitated the formation of CaCO₃ as a crystal nucleus during RMC hydration, expediting the subsequent carbonation process in RMC-based specimens and leading to the formation of denser new interfacial transition zones (ITZs). Simultaneously, the superior strength observed in specimens with CRA might be linked to the enhanced properties of the old ITZs from RA, evident through the reduced water absorption/crushing index value and increased density of CRA in comparison to conventional RA.

When assessing the performance of reactive magnesia concrete (RMC) with different grades of RA, compared to the ITZ characteristics, the matrix microstructure compactness exhibited a greater impact on strength. Thus, III-CRA-A revealed the smallest effective w/c, contributing to its largest compressive strength. In comparison, under CO₂ curing, the paste matrix and new ITZ were enhanced as HMCs constructed a dense structure. I-CRA indicated the least adhered old mortar old ITZ and smallest porosity (e.g., less than 14%, FIG. 2B and FIG. 2C), indicating its best aggregate quality. Therefore, I-CRA-C revealed the largest compressive strength. Overall, differences in strength within RA and CRA groups were not significant. Consequently, the use of Grade III RA in RMC-based concrete production could substantially reduce material costs without compromising mechanical properties, potentially broadening the utilization of RA in practical applications of RMC-based concrete, irrespective of the RA quality. Moreover, employing recycled aggregate (RA) or carbonated recycled aggregate (CRA) is a more cost-effective and environmentally sustainable approach due to the superior strength exhibited by RMC-based specimens containing recycled aggregate (RA) or carbonated recycled aggregate (CRA) compared to natural aggregate (NA). Conversely, unlike the I-RA-C group, FIG. 3A and FIG. 3B illustrate that the 28-day strength of the II-RA-C and III-RA-C groups continued to increase compared to the 14-day values, a topic that will be elaborated further elsewhere in this disclosure.

### XRD

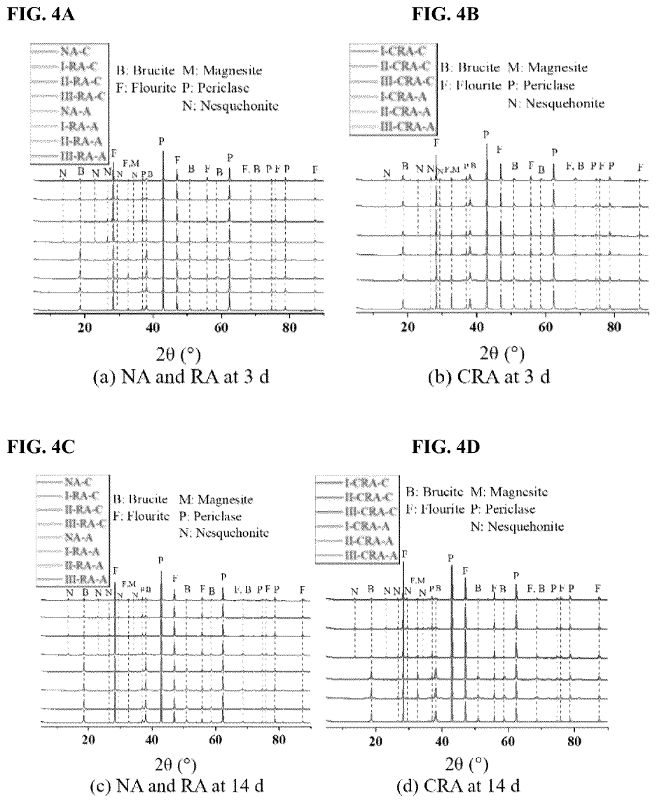

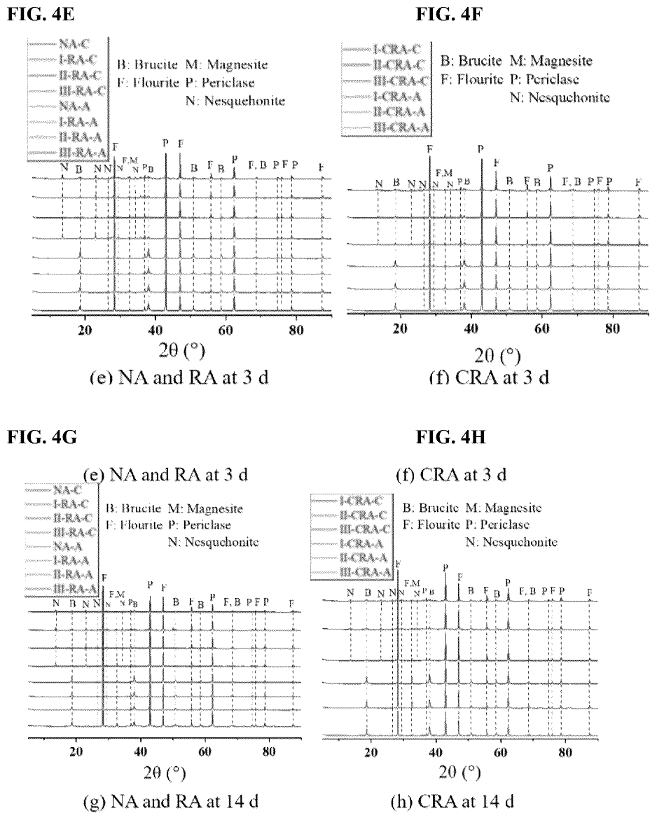

FIG. 4A to FIG. 4F show the X-ray diffraction (XRD) patterns in interior/exterior regions of all specimens at 3 and 14 days. Mg(OH)₂ reacted with CO₂ to generate HMC under CO₂ curing conditions. Therefore, compared to the air curing group, the XRD patterns clearly indicated that the brucite peak in the CO₂ curing group decreased while the nesquehonite (~a type of HMCs) peak strengthened. Moreover, as the age increased from 3 d to 14 d, the peak of periclase weakened due to hydration reaction of RMC, as expected.

A more detailed quantitative analysis in terms of the investigated mineral phases is reported in FIG. 5A to FIG. 5D, which reveals the RIR values in the interior/exterior regions of specimens. The figure reveals that as the curing age increased from 3 d to 14 d, the content of unhydrated MgO and uncarbonated Mg(OH)₂ of all groups decreased due to the continuous hydration and carbonation of RMC. Besides, the CO₂ curing groups revealed smaller unhydrated MgO contents than the air curing group, which was owing to the reduced slurry pH resulting from carbonation reaction so that RMC hydration was accelerated.

At the same time, FIG. 5A to FIG. 5D, also demonstrate that the unhydrated MgO content in the interior region of RMC-based specimens with natural aggregate (NA) was the highest, while this value was the lowest in specimens containing CRA, indicating their greatest hydration degree. This is because the interior curing effect of recycled aggregate (RA) or carbonated recycled aggregate (CRA) and more CO₂ diffusion paths provided by recycled aggregate (RA) or carbonated recycled aggregate (CRA) could enhance carbonation and lower slurry pH, which led to the promotion of reactive magnesia cement (RMC) hydration. Meanwhile, CRA exhibited smaller water absorption than RA, so more free water was available for RMC hydration. However, in exterior regions, the lower effective w/c of the slurry could hinder RMC hydration. Therefore, specimens with NA revealed the highest hydration degree. Moreover, the presence of a dense carbonation layer on the surface of RMC-based specimens impedes the diffusion of CO₂ towards the internal structure. Consequently, the porosity within the interior region was notably greater compared to that of the exterior region. In contrast, the utilization of recycled aggregate (RA) or carbonated recycled aggregate (CRA) facilitated both the hydration and carbonation processes of RMC, resulting in enhanced elasticity and hardness in the interior segment, identified as the most susceptible part of the concrete (refer to section below entitled “Nanoindentation”). Consequently, the incorporation of recycled aggregate (RA) or carbonated recycled aggregate (CRA) effectively elevated the compressive strength of the specimens.

Furthermore, the CO₂ curing group exhibited a reduced amount of un-carbonated Mg(OH)₂ compared to the air curing group. Specifically, only approximately 5% of Mg(OH)₂ in the exterior regions of the CO₂-cured group remained uncarbonated, a significantly lower percentage than observed in the air-cured counterparts. Additionally, as previously mentioned, the specimens incorporating CRA demonstrated higher free water availability for hydration due to the lower water absorption of CRA compared to RA. Consequently, the group containing CRA displayed a greater Mg(OH)₂ content than the group with RA in both interior and exterior regions, a finding corroborated by its lower unhydrated MgO content.

### TG-DTG

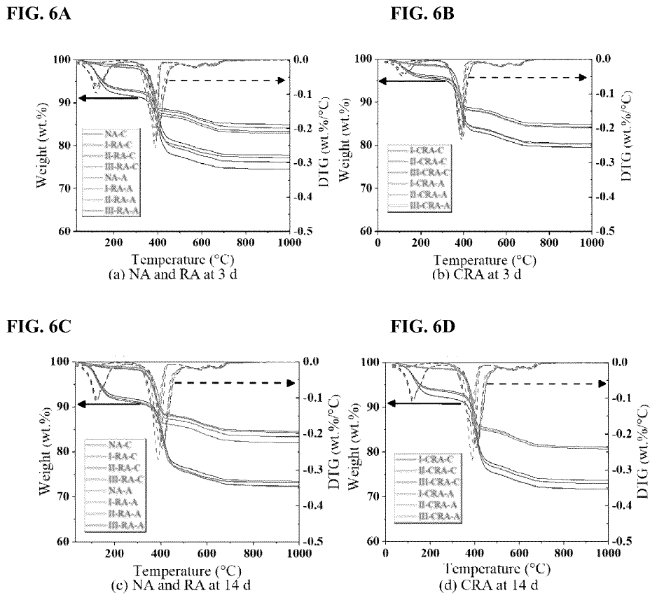

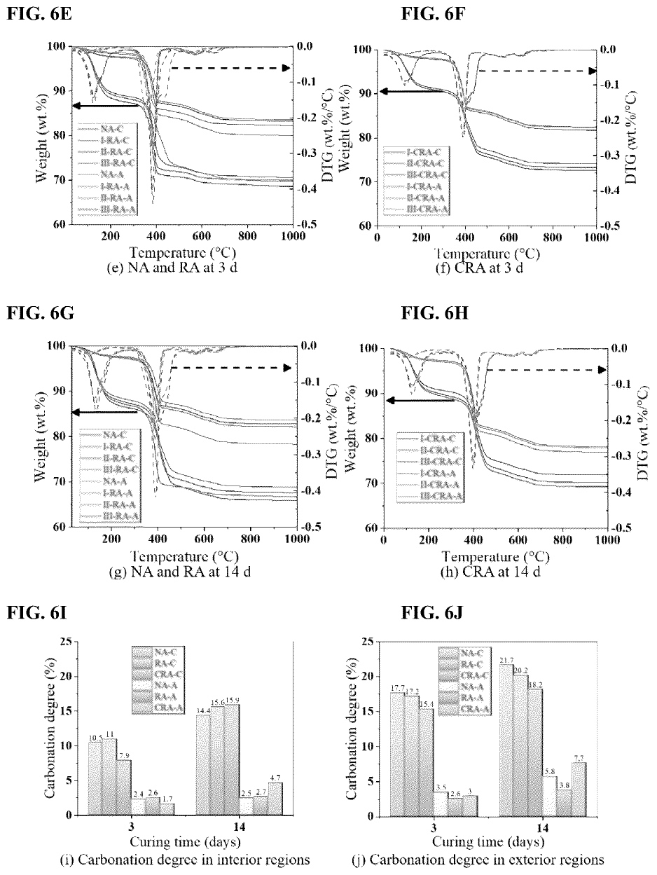

FIG. 6A to FIG. 6H show the Thermogravimetric-Derivative thermogravimetric analysis (TG-DTG) curves in interior/exterior regions of specimen at 3 d and 14 d. The three main phase decomposition stages are listed below:

50-300° C.: Dehydration of water bonded to hydrated magnesium carbonates (HMCs; (e.g., nesquehonite, hydromagnesite and dypingite).

300-500° C.: Dehydroxylation of HMCs (e.g., hydromagnesite and dypingite), decarbonation of HMCs (e.g., nesquehonite) and decomposition of uncarbonated brucite.

500-900° C.: Decarbonation of HMCs (e.g., nesquehonite, magnesite, hydromagnesite and dypingite).

The carbonation degree of RMC-based specimens could be obtained:

$${D}_{{CO}_{2}} = \frac{{P}_{{CO}_{2}}}{{P}_{R M C}} - {D}_{inherent}$$

The parameter P_{CO}_{₂}, representing the percentage of total CO₂ sequestered, is calculated by subtracting the mass loss of H₂O (resulting from the decomposition of brucite as determined by RIR analysis) from the mass loss observed during the temperature range of 300-900° C. in TG-DTG. The value is further normalized by the percentage of the final mass at 900° C. to the initial mass (PRMC). Besides, Dinherent is the percentage of CO₂ sequestered within the original RMC, as determined from TG-DTG analysis of moist-cured RMC specimens for 1 d.

The curing group exhibited a greater mass loss compared to the air curing group, attributable to the increased decomposition of Mg(OH)₂ and HMCs. FIG. 6I and FIG. 6J provide a summary of the carbonation degree in the interior and exterior regions of RMC concrete. Similar to compressive strength, no significant difference in carbonation degree was observed between RMC concrete with different grades of recycled aggregate (RA) or carbonated recycled aggregate (CRA).

In the exterior region, the specimen with NA demonstrated the highest Mg(OH)₂ content available for carbonation (see FIG. 3A and FIG. 3B), resulting in the largest carbonation degree in most cases. Conversely, in the interior region, specimens with CRA exhibited the highest carbonation degree at 14 d. This enhancement was attributed to the increased CO₂ diffusion paths facilitated by recycled aggregate (RA) or carbonated recycled aggregate (CRA), as mentioned earlier. Additionally, specimens with CRA also displayed a higher Mg(OH)₂ content available for carbonation compared to those with RA, owing to the greater involvement of free water in RMC hydration.

### X-CT

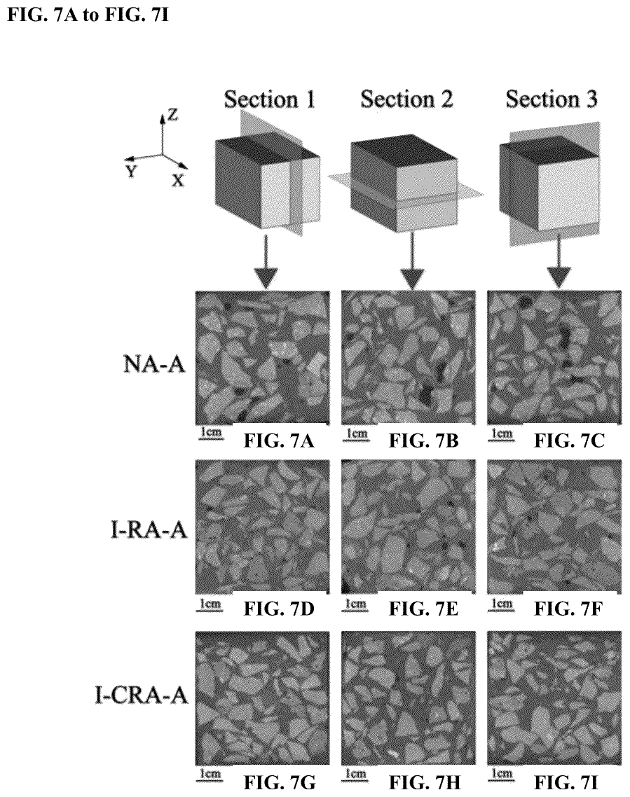

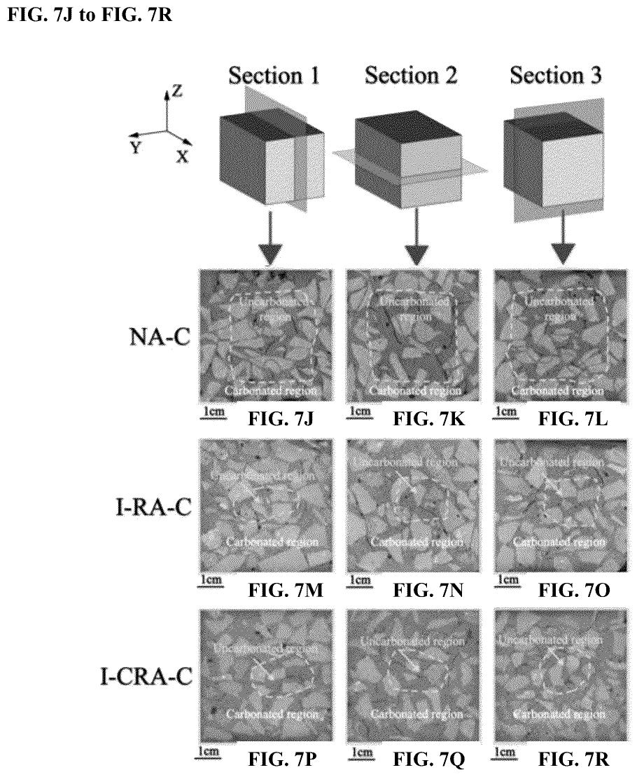

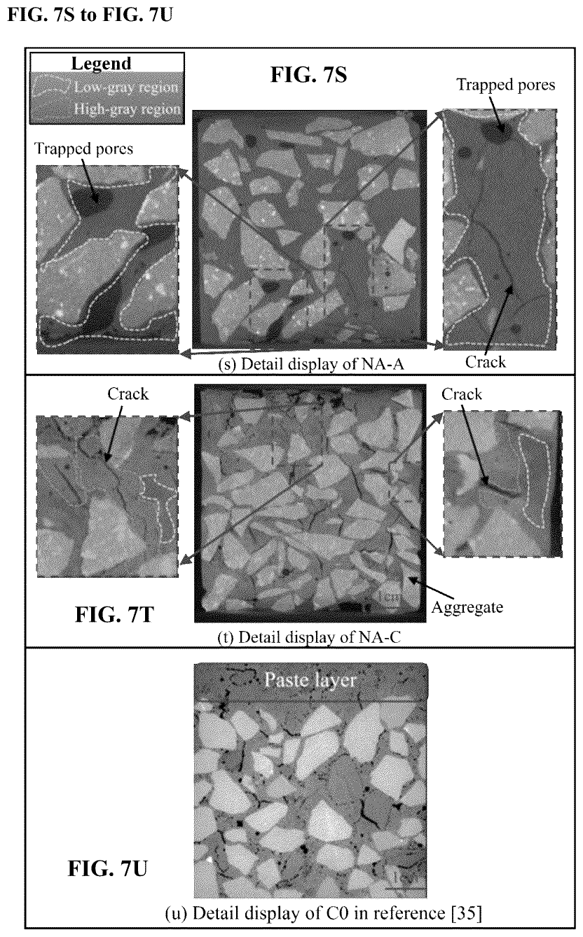

FIG. 7A to FIG. 7R present the 2D X-ray Computed Tomography (X-CT) images of selected groups after 14 days of CO₂ curing. In FIG. 7A to FIG. 7C, the NA-A group, characterized by excessive free water, experienced evaporation leading to pore formation, evident in numerous trapped pores (blue circles) and a limited number of microcracks. In contrast, the I-CRA-A and I-RA-A groups, benefiting from reduced free water and the internal curing effect of recycled aggregate (RA) or carbonated recycled aggregate (CRA), exhibited a dense structure devoid of trapped pores, corroborated by their superior strength compared to the NA-A group. A comparison between the NA-A and NA-C groups revealed that CO₂ curing led to the filling of interior pores with HMC, resulting in a denser microstructure. However, excessive HMC expansion in the NA-C group caused the formation of cracks (green circles). Conversely, the uniform distribution of carbonation products (verified by smaller uncarbonated regions) in the I-RA-C and I-CRA-C groups contributed to a denser microstructure with fewer expansion cracks than observed in the NA-C group.

FIG. 7S and FIG. 7T provide detailed 2D X-CT images of the NA-A and NA-C, with high-gray (low-gray) regions representing the region composed of high-density carbonation products (under carbonized substances), respectively. Due to the low carbonization degree of the air-cured specimen, low-gray regions (yellow dashed circles) are widely present both in the distance and vicinity of the cracks or trapped pores (FIG. 7S). Yet, a different scene is shown in FIG. 7T. High-gray region (orange dashed circles) were observed near cracks and aggregate ITZ in the NA-C group, even in the core area of concrete. In contrast, the low-gray region was further away from cracks, indicating its lower degree of carbonation degree. It indicated that cracks and ITZ offered CO₂ diffusion paths, leading to a higher carbonation degree and greater color brightness. Additionally, bright areas (HMC) near cracks in the RMC system were also reported by Dung et al, and a similar conclusion was reached in the OPC system, where tensile stress induced crack formation, promoting the concrete carbonation rate.

NA was used to prepare RMC-based concrete (CO, FIG. 7U) are detailed elsewhere; see, e.g., Y. Song, et al., “Understanding the role of seeds in reactive magnesia cement (RMC) formulations”, Journal of the American Ceramic Society, 106 (2023) 3812-3831, the entire contents of which is incorporated herein by reference. The aggregate, mix and curing conditions (20% CO₂) were the same as in this study, and the activity of RMC used in NA-C was better than that in CO. Besides, CO revealed a smaller SSA and worse activity of RMC than NA-C (i.e., SSA: 12.4 m²/g vs. 29.1 m²/g; acid neutralization times: 405 s vs. 1033 s), resulting in its smaller water demand. Therefore, during the specimen vibration compaction process, a portion of the excess slurry floated due to low density, forming a paste layer on the specimen surface (FIG. 7R). Moreover, the porosity of the paste layer was significantly higher than in other areas, harming the concrete mechanical properties. In contrast, the paste layer was not observed in NA-C due to higher SSA of RMC (FIG. 7Q). The pore structure was consistent with their mechanical property: NA-C indicated faster compressive strength development than CO (e.g., 28 d strength of 22.2±0.21 MPa vs. 19.4±1.16 MPa, respectively).

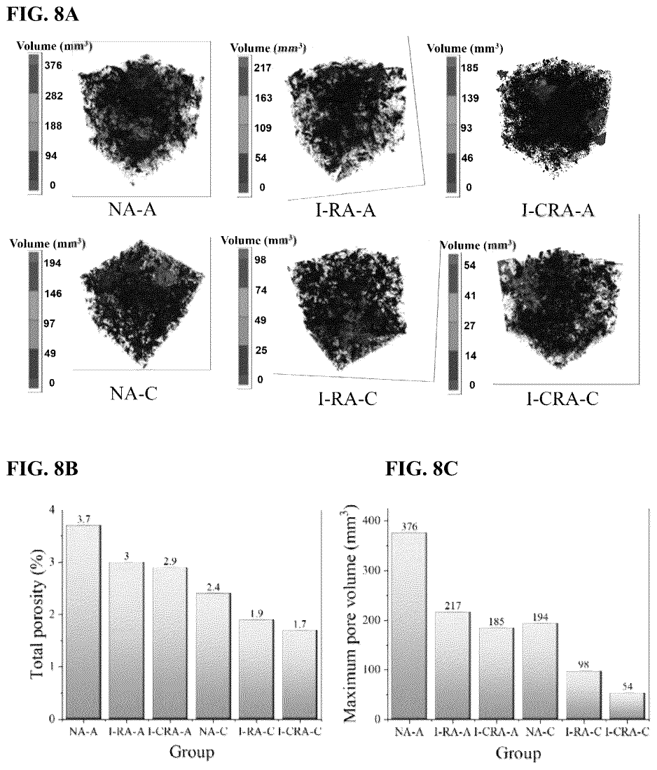

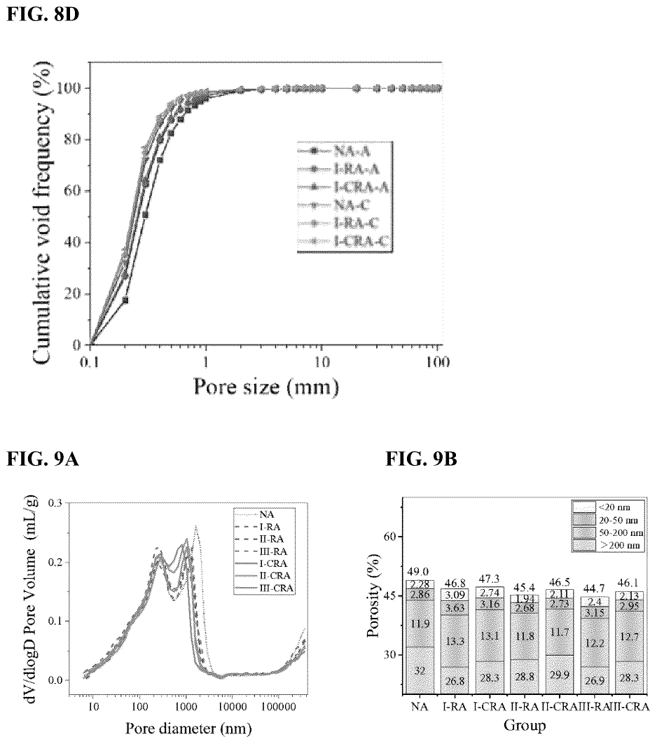

FIG. 8A to FIG. 8D display the pore structural parameters arranged according to their strength. Lower porosity (FIG. 8B), smaller maximum pore volume (FIG. 8C) and more proportion of pores smaller than 0.2 mm (FIG. 8D) indicative of a denser specimen, reduces the likelihood of pores developing into large cracks under the same load, emphasizing the significant contribution of a dense pore structure to high compressive strength in concrete. Consequently, the I-CRA-C and NA-A exhibited the optimum/worst pore structure features. Further, the porosity obtained by X-CT was much smaller than that obtained by MIP. It was because the aperture ranges obtained by MIP are 5.5 nm-360 μm, and that of X-CT are >0.104 mm (8 voxels) in the tests, respectively. therefore, a large number of small pores are not detected by X-CT, leading to a smaller porosity obtained by CT than by MIP. Nonetheless, CT indicated an advantage over MIP in detecting the non-connected holes existing in concrete and obtaining the distribution of carbonates without causing internal cracks during sample preparation.

### MIP

FIG. 9A and FIG. 9B show pore size and frequency distribution of new ITZ of groups containing NA, RA and CRA in the final setting. NA revealed the lowest water absorption rate, leading to largest effective w/c near new ITZ. Thus, new ITZ of group containing NA exhibited the largest porosity/most probable pore size (1625 nm), respectively. It is consistent with the OPC system (see X. Chen, et al., “Experimental study and analytical model for pore structure of hydrated cement paste”, Applied Clay Science, 101 (2014) 159-167; the entire contents of each of which is incorporated herein by reference) that larger w/c (0.3-0.7) led to larger porosity/most probable pore size in OPC system from 1 to 28 days.

Besides, new ITZ of groups containing CRA revealed larger porosity than that containing RA, verifying existence of more free water, consistent with CRA′ smaller water absorption. Besides, calcite on CRA surface acted as a nucleation site and promoted hydration. Meanwhile, more free water also increased hydration degree. Therefore, the pore parameters of new ITZ in final setting is consistent with hydration/carbonization degree. Air/CO₂ cured group containing RA (with smallest capillary porosity) revealed the smallest hydration production and carbonation degree in the interior region at 3 and 14 d.

### Nanoindentation

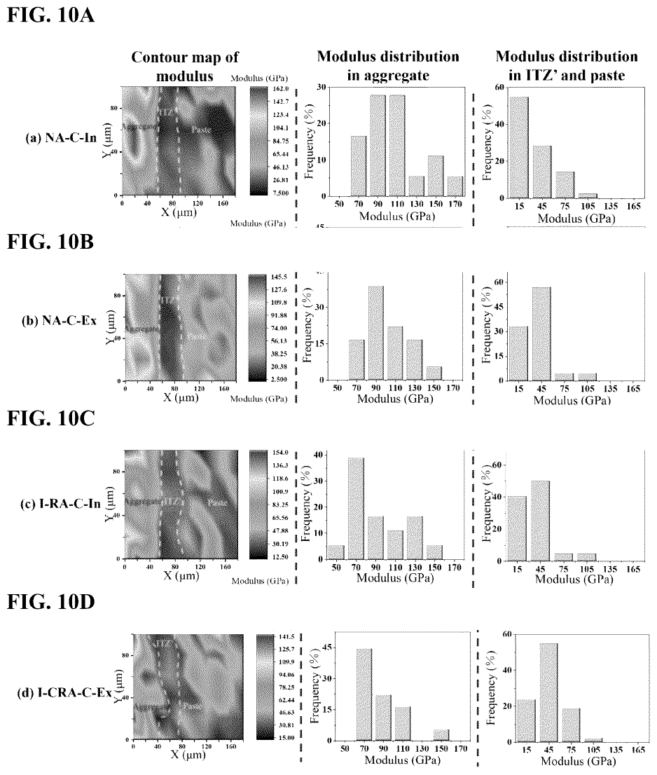

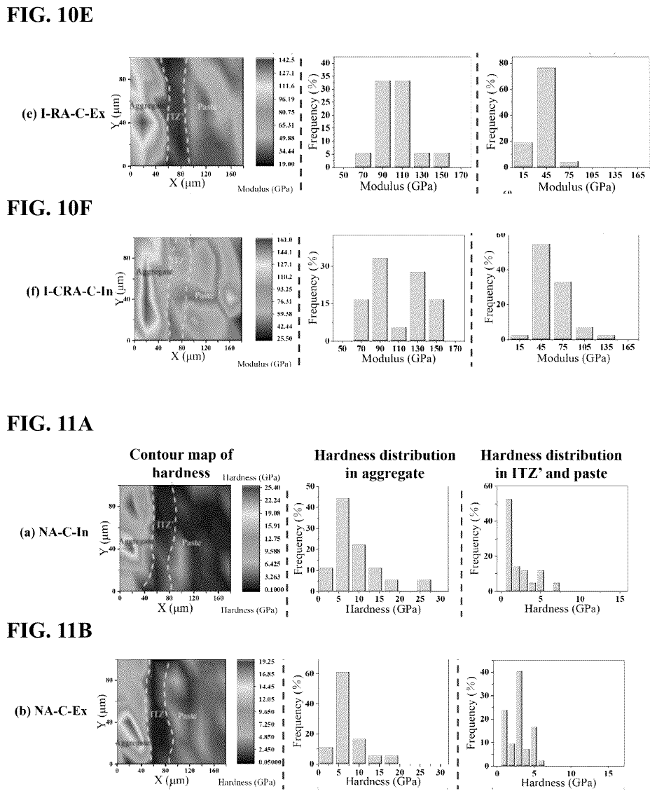

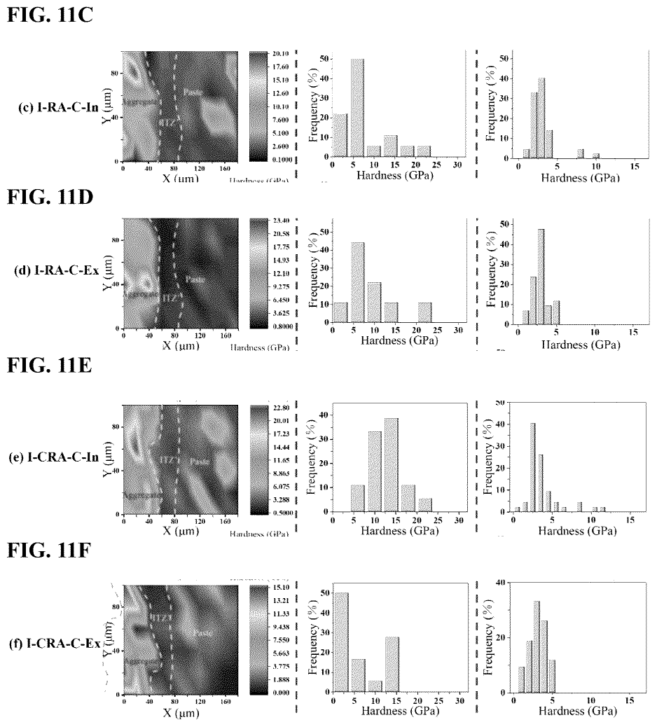

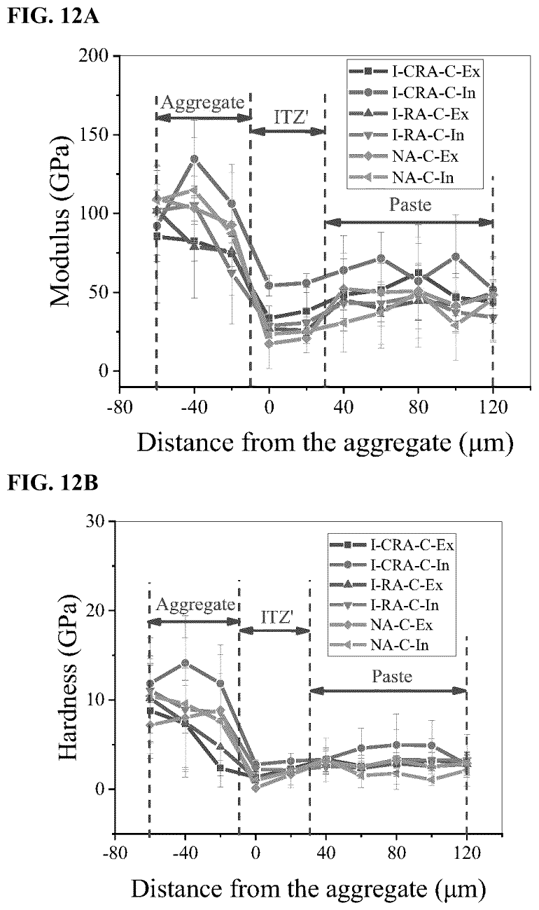

FIG. 10A to FIG. 10F and FIG. 11A to FIG. 11F depict contour maps and frequency distributions of moduli/hardness in aggregates, improved interfacial transition zones after carbonation (ITZ′), and paste for the NA-C and I-CRA-C groups. The color differences in the contour map facilitated the division of the area into aggregates, ITZ′, and paste. The color of ITZ′ tended to light blue in the I-RA-C/I-CRA-C groups and dark blue in the NA-C group, with a notably significant difference in the interior regions. Moreover, compared to the NA-C group, the distribution of modulus and hardness at ITZ′ and paste in the I-CRA-C groups was skewed towards higher numerical values, indicating the generation of more high-density HMC. FIG. 12A and FIG. 12B and Table 3 provide additional details on the distribution of elastic modulus and hardness along the X-axis in the NA-C and I-CRA-C groups, along with the modulus and hardness values for each phase in the interior and exterior regions of the I-CRA-C and NA-C groups after 14 days of CO₂ curing. Table 3 also highlights the lowest modulus/hardness values in aggregate for the I-CRA-C-Ex group, attributed to the presence of loose and porous old mortar. In contrast, the I-CRA-C-In group exhibited contrasting data, as CRA consisted of aggregates from various lithologies, including granite with high modulus/hardness values.

TABLE 3
The modulus and hardness of each phase in the interior/exterior
regions of I-CRA-C and NA-C after being CO₂-cured for 14 days

| | Modulus (GPa) | | | Hardness (GPa) | | |
|---|---|---|---|---|---|---|
| Group | Aggregate | Paste | ITZ′ | Aggregate | Paste | ITZ′ |
| I-CRA-C-Ex | 80.8 ± 26.5 | 50.6 ± 19.8 | 35.8 ± 12.3 | 6.2 ± 5.1 | 3 ± 1.1 | 1.8 ± 0.8 |
| I-CRA-C-In | 110.9 ± 29.9 | 63.3 ± 21.7 | 55.1 ± 6.3 | 12.6 ± 4.3 | 4.3 ± 2.5 | 2.9 ± 0.7 |
| I-RA-C-Ex | 92.0 ± 29.1 | 44.1 ± 9.1 | 27.6 ± 5.1 | 9.5 ± 5.4 | 2.6 ± 0.9 | 1.6 ± 0.6 |
| I-RA-C-In | 89.2 ± 32.8 | 41.4 ± 19.2 | 28.9 ± 5.5 | 7.5 ± 5.3 | 3.0 ± 2.1 | 2.2 ± 0.4 |
| NA-C-Ex | 101.8 ± 20.6 | 48.6 ± 21.6 | 19.0 ± 10.6 | 7.1 ± 4.6 | 2.8 ± 1.1 | 0.9 ± 0.8 |
| NA-C-In | 103.4 ± 32.5 | 38.5 ± 23.3 | 24.2 ± 7.6 | 9.2 ± 5.6 | 1.6 ± 1.4 | 1.5 ± 1.3 |

The observed modulus/hardness values in ITZ′ and paste of the I-CRA-C and NA-C groups aligned with their mechanical properties. CO₂ pretreatment enhanced the strength of RA, with the generated CaCO₃ acting as nucleation sites for RMC hydration and reinforcing matrix adhesion. Consequently, in comparison to the NA-C-In and NA-C-Ex groups, the modulus in ITZ′ of the I-CRA-C-In and I-CRA-C-Ex groups increased by 128% and 88%, respectively, while the modulus in paste increased by 64% and 4%. This trend was similarly reflected in the hardness outcomes. That is, the degree of improvement in the interior regions surpassed that in the exterior regions, confirming that the use of RA in the RMC system contributed to the strengthening of the microstructure in its interior regions.

The disparity between the ITZ in RMC and OPC-based system was substantial. Specifically, the ITZ in OPC-based concrete predominantly consisted of larger crystals of calcium hydroxide (CH) and ettringite, with a lower volume fraction of calcium silicate hydrate (C-S-H) gel compared to the bulk cement paste. In contrast, the ITZ in air-cured RMC-based concrete primarily comprised brucite, arranged in a random stack and interconnected by hydrogen bonds, indicating a low degree of cohesive binding. Brucite exhibited limited effectiveness in reducing porosity, resulting in a poorly connected network and, consequently, a restricted contribution to strength. However, in CO₂-cured RMC-based concrete, the higher carbonation degrees played a significant role in strength enhancement. Interconnected and well-developed hydrated magnesium carbonates (HMCs) reduced porosity in the ITZ′ of RMC-based specimens, contributing to improved strength. Hence, the efficiency of carbonation, influenced by CO₂ diffusion, and the distribution of the carbonation phase in ITZ both played crucial roles in determining the strength of RMC-based concrete.

When using recycled aggregate (RA) or carbonated recycled aggregate (CRA) in concrete, ITZ quality was influenced by three factors: (a) ITZ was weakened due the porous old mortar and old ITZ on RA surface; (2) ITZ was strengthened as unsaturated RA decreased effective w/c; (3) ITZ was strengthened due to the internal curing effects of RA. As shown in Table 3, under different boundary conditions (same initial w/c or effective w/c), the dominant factors (factor (a) or factors (b)+ (c)) that influence ITZ quality differed, which led to a difference of concrete strength development. Moreover, internal curing effects (factors (c)) mainly play a role in the later stage.

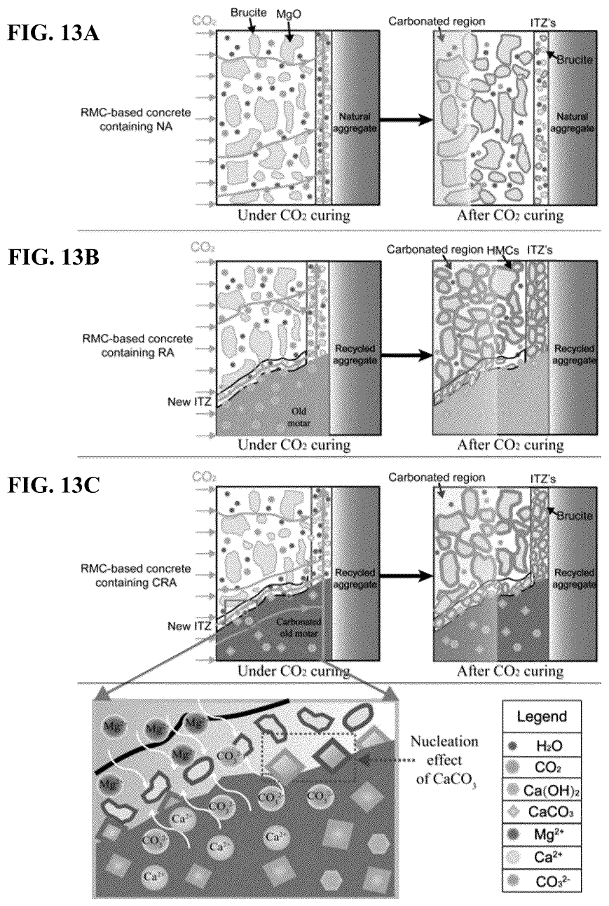

In addition to the difference in the alteration of ITZ features, the typical CO₂ diffusion paths in recycled concrete prepared by OPC and RMC also exhibit distinctions. While recycled concrete with OPC had only five typical CO₂ diffusion paths, the RMC system builds upon the multi-path model (See, e.g., R. Mi, et al., “New insights into diffusion and reaction of CO2 gas in recycled aggregate concrete”, Cement and Concrete Composites, (2022) 10448; the entire contents of which is incorporated herein by reference) posits the existence of six distinct CO₂ diffusion paths. This contrasts with RMC-based concrete containing NA, which only had three diffusion paths, leading to a considerably slower CO₂ diffusion speed compared to RMC-based concrete containing recycled aggregate (RA) or carbonated recycled aggregate (CRA). Furthermore, as depicted in FIG. 13A to FIG. 13C, numerous old and new ITZs in RMC-based concrete containing recycled aggregate (RA) or carbonated recycled aggregate (CRA) facilitated accelerated CO₂ penetration from the exterior. Consequently, the increased formation of a substantial amount of HMC reduced porosity, elevating the elastic modulus and hardness of ITZ′ and paste. Additionally, the carbonation portion (FIG. 13B and FIG. 13C) in RMC-based concrete containing recycled aggregate (RA) or carbonated recycled aggregate (CRA) exhibited a much greater depth compared to that containing NA (FIG. 13A), signifying a widespread and consistent distribution of HMCs formed with a deeper carbonation depth in the specimens. In contrast, RMC-based concrete containing NA displayed more uncarbonated brucite in ITZs, resulting in inferior ITZ features. Consequently, the mechanical properties of RMC-based concrete containing recycled aggregate (RA) or carbonated recycled aggregate (CRA) showed improvement compared to that containing NA.

Group containing CRA exhibited better ITZ characteristics and mechanical properties through the following mechanisms: (1) old ITZ and old adhered mortar were enhanced, verified by their better pore parameters (FIG. 2B and FIG. 2C); (2) CaCO₃ provided additional nucleation sites and the binding force within ITZ; (3) CRA surface dissolve slowly releasing CO₃²⁻, which may react with Mg²⁺ to form carbonate and enhance the CRA-paste interface bond in a physical interlocking way.

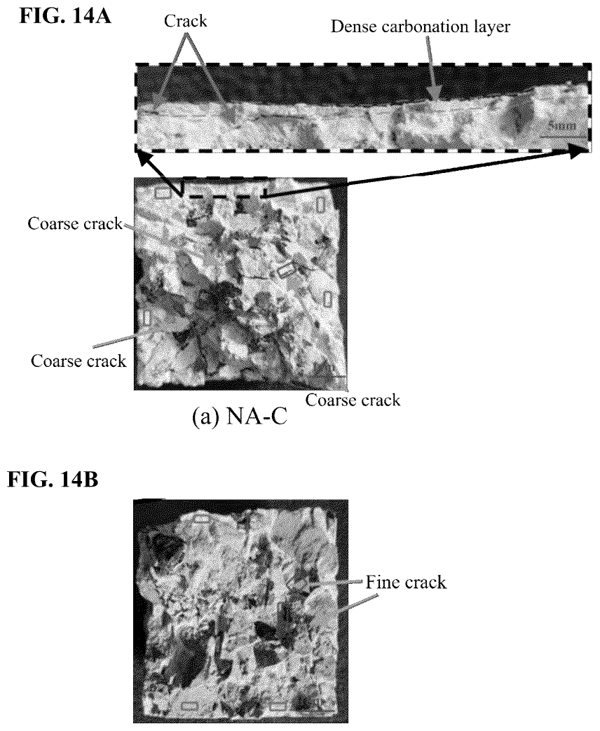

This perspective is substantiated by FIG. 14A and FIG. 14B, and the figure displays the cross-sectional morphology of the NA-C and I-CRA-C groups after a compression test, without any cutting or polishing to prevent further crack development. RMC-based concrete containing recycled aggregate (RA) or carbonated recycled aggregate (CRA), benefiting from more diffusion paths, exhibited faster CO₂ diffusion and a more uniform distribution of carbonation products. Consequently, the I-CRA-C group displayed fewer and finer cracks compared to the NA-C group. A dense carbonation layer (~1 mm thick, indicated by the blue dashed line) was observed at the surface of RMC-based concrete containing NA, with cracks (green arrows) concentrated at the junction of the dense carbonation layer and the paste. Importantly, these cracks did not penetrate the carbonation layer, confirming its high hardness. Previous studies have also emphasized the significant contribution of the dense carbonation layer to specimen strength (see, e.g., E.G. Soares, J. Castro-Gomes, “Carbonation curing Influencing factors of carbonated reactive magnesia cements (CRMC)—a review”, Journal of Cleaner Production, 38 (2021) 127210 and S. Ruan, C. Unluer, “Influence of mix design on the carbonation, mechanical properties and microstructure of reactive MgO cement-based concrete”, Cement and Concrete Composites, 80 (2017) 104-114, the entire contents of each of which is incorporated herein by reference) and its inhibitory effect on subsequent CO₂ diffusion. Therefore, the modulus and hardness of ITZ′ in the interior regions were presumed to be weaker than those in the exterior regions.

Nanoindentation results, however, indicated that the modulus/hardness of ITZ in the interior regions was higher than in the exterior regions. This discrepancy could be attributed to the sampling location. If the aggregate sampled was near the crack (red boxs in FIG. 14A and FIG. 14B), the ITZ would undergo carbonation and strengthening. Conversely, the exterior regions (green boxs in FIG. 14A and FIG. 14B) may not be effectively enhanced due to the lack of an efficient CO₂ diffusion pathway.

Considering these observations, along with differences in RIR and carbonation degree results in the interior/exterior regions, it is imperative to discuss the correlation between the properties of the interior/exterior region and the mechanical strength of RMC-based specimens. While some studies have quantitatively linked the micro- and macro-properties of OPC-based recycled concrete, such quantitative analysis has been lacking for RMC-based recycled concrete. Additionally, there is a gap in providing explanations regarding the strength source of RMC-based concrete at the micro- and nano-levels. Consequently, the correlation between the specimen's 28-day strength and various factors (including ITZ characteristics, porosity, and the degree of hydration/carbonation) was analyzed. Given the limited growth of hydration/carbonation degree and strength from 14 days to 28 days, microscopic test results at 14 days were selected. Moreover, insights from previous studies (see, e.g., C. Pan, et. al., “Unlocking the role of recycled aggregates in the performance enhancement and CO₂ capture of reactive magnesia cement formulations”, Cement and Concrete Research, 168 (2023) 107148 and C. Pan, et al., “Performance buildup of reactive magnesia cement (RMC) formulation via using CO₂-strengthened recycled concrete aggregates (RCA)”, Journal of Building Engineering, 65 (2022) 105779, the entire contents of each of which is incorporated herein by reference) were incorporated to broaden the research scope.

### ITZ Characteristics and Porosity

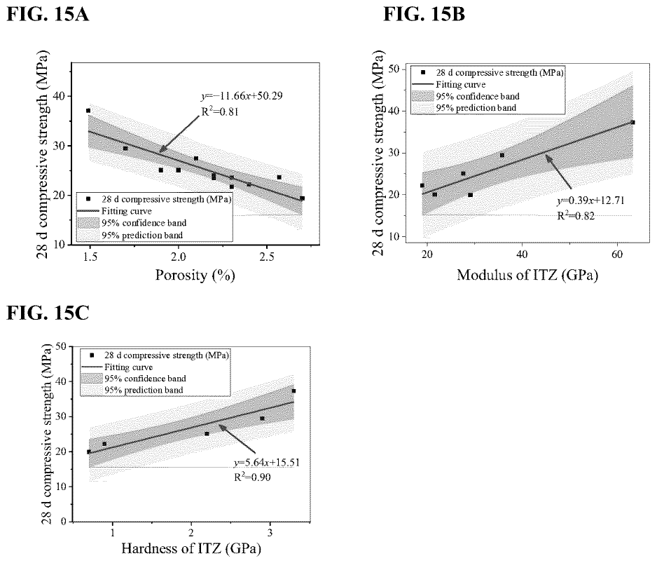

FIG. 15A to FIG. 15C illustrates that under CO₂ curing conditions, the 28-day compressive strength demonstrates a significant correlation with the elastic modulus/hardness of ITZ and specimen porosity. When the specimen's porosity is lower, the likelihood of pores evolving into large cracks due to stress concentration decreases. Consequently, within the 1.5-2.7% porosity range, strength exhibits a linear increase with decreasing porosity.

Moreover, superior ITZ characteristics contribute to enhanced mechanical properties of the specimen. This is attributed to the fact that, under the same loading rate, higher elastic modulus and hardness of ITZ result in slower crack development at ITZ and a reduced number of cracks, thereby leading to a slower decline in specimen stiffness.

### Degree of Hydration and Carbonation

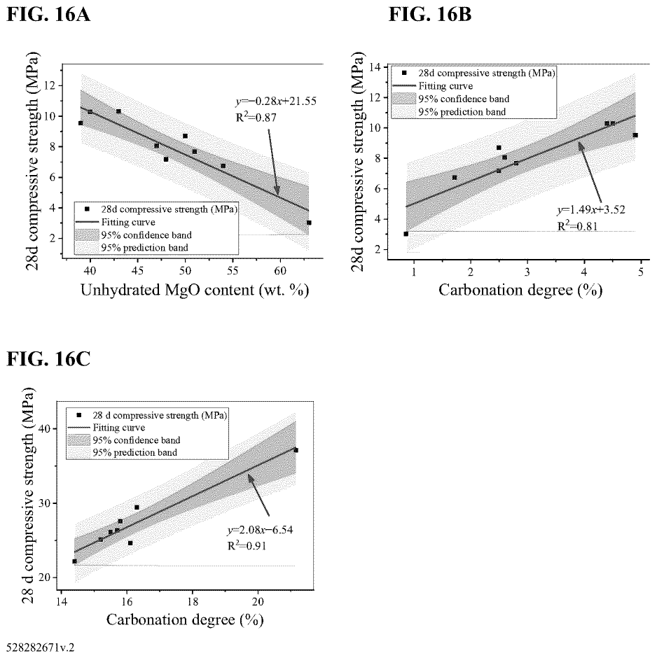

Table 4 summarizes the R2 values of linear fitting between 28-day strength and various variables, with FIG. 16A to FIG. 16C presenting the optimal fitting results for simplicity. Among these variables, the hydration degree is represented by the unhydrated MgO content.

TABLE 4
Compressive strength comparison and ITZ influencing
factors of RMC(OPC)-based concrete.

| | Boundary | Compressive | Main influencing |
|---|---|---|---|
| Category | condition | strength comparison | factors of ITZ |
| RMC-based | Same initial | Concrete with CRA > that | Factors (b) + (c) |
| concrete | w/c^{#} | with RA > that with NA | outweighed factor (a) |
| | Same effective | — | — |
| | w/c^{‡} | | |
| OPC-based | Same initial | The results are influenced by | — |
| concrete | w/c^{#} | RA quality, mix (cement content, | |
| | | w/c), etc; Concrete with CRA > | |
| | | that with RA in most case | |
| | Same effective | Concrete with NA ≥ that with | Factors (a) outweighed |
| | w/c^{‡} | CRA > that with RA in most cases; | factor (b) + (c) |
| | | opposite situation: with high RA | |
| | | quality and large cement content, | |
| | | strength of concrete with RA > | |
| | | that with NA | |

Note:
“^{#}”indicated using naturally air-dried (partially saturated) recycled aggregate (RA) or carbonated recycled aggregate (CRA) without adding additional water;
“^{‡}” included using additional water in group containing recycled aggregate (RA) or carbonated recycled aggregate (CRA) or using saturated surface dry recycled aggregate (RA) or carbonated recycled aggregate (CRA);
“—” represents a lack of research data or universal conclusions.

As depicted in FIG. 16A to FIG. 16C, the 28-day strength of air-cured specimens exhibits a strong correlation with unhydrated MgO content and carbonation degree. The presence of more free water in CRA-A promotes RMC hydration, resulting in a smaller unhydrated MgO content compared to the RA-A group. Simultaneously, the carbonation degree of CRA-A surpasses that of RA-A, given that more hydration products can undergo carbonation. The increased products of hydration/carbonation contribute to the formation of dense microstructures, thereby elevating 28-day compressive strength.

Additionally, as indicated in Table 5, the correlation between strength and the carbonation degree in the interior region is stronger than in the exterior region. This discrepancy arises from the fact that, compared to NA, the promoting effect of RA and CRA on carbonation predominates in the interior region (as discussed in above in “TG-DTG”). Conversely, in the exterior region, despite NA-C showing lower strength, its degree of hydration/carbonation surpasses that of the RA-C and CRA-C groups due to the presence of more free water.

TABLE 5
The correlation coefficient R² between specimen
28 d strength and unhydrated MgO content/carbonation
degree under air/CO₂ curing conditions.

| | | Unhydrated MgO content | | Carbonation degree | |
|---|---|---|---|---|---|
| Curing | | Interior | Exterior | Interior | Exterior |
| conditions | Category | region | region | region | region |
| Air | Same w/c | 0.87* | 0.52* | 0.81* | 0.69* |
| curing | Different w/c | 0.06 | 0.03 | 0.08 | 0.11 |
| CO₂ | Same w/c | 0.16 | 0.19 | 0.91* | 0.54* |
| curing | Different w/c | 0.20 | 0.39 | 0.13 | 0.42 |

Note:
(1)* indicates that the correlation between variables is statistically significant at the 0.05 level; (w/c = 0.55, 0.6, and 0.65, with recycled aggregates being NA and RBC.

### Example 3

In this example, a method for manufacturing a cementitious aggregate composition and a reduced salinity water component is described.

The method includes steps of: (a) combining (i) a high salinity brine, (ii) CO₂, and (iii) a pozzolan and/or a latently hydraulic material, and/or a recycled aggregate (RA) or a carbonated recycled aggregate (CRA); and (b) permitting the combination obtained in step (a) to persist under conditions sufficient to transform the combination into a cementitious aggregate composition and a reduced salinity water component.

The conditions sufficient to transform the combination into a cementitious aggregate composition and a reduced salinity water component in step (b) comprise time and applied pressure.

The high salinity brine, CO₂, and the pozzolan and/or the latently hydraulic material and/or the recycled aggregate (RA) or the carbonated recycled aggregate (CRA) are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility. These steps can occur in a pipeline, a tank, or basin. When step (b) occurs in a pipeline, pressure applied to the pipeline utilizing a series of pipe reducers, which are mechanical devices used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

In some cases, step (a) further comprises an activator; the activator may be any sodium, lithium or potassium salt or hydroxide and any alkali or alkali earth metal ions and including one or more of Mg(OH)₂, MgO, Ca(OH)₂, CaCO₃, Al₂(SO₄)₃, and CaO.

Step (b) produces exothermic heat and this exothermic heat is transformable from thermal energy into electrical energy.

The pressure in step (b) is from about ambient (1 bar) to about 250 bar, e.g., from about 100 bar to about 250 bar or from about ambient (1 bar) to about 100 bar, and any range or value therebetween. The pressure in step (b) may be greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to the pozzolan and/or the latently hydraulic material and/or the recycled aggregate (RA) or the carbonated recycled aggregate (CRA) varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the pozzolan and/or the latently hydraulic material and/or the recycled aggregate (RA) or the carbonated recycled aggregate (CRA) to CO₂ varies from 1:100 to 100:1, and any range or value therebetween.

In some cases, an aggregate is added to the combination of step (a). The aggregate may comprise sand, gravel, lightweight aggregate, recycled aggregate (RA), carbonated recycled aggregate (CRA), or crushed stone, and a combination thereof.

In various cases, the latently hydraulic material is a slag. The slag may be added in step (a) in addition to the added pozzolan or the slag is added in step (a) instead of pozzolan. The slag may be added in step (a) instead of an activator.

At least one filler material or other additive, may be added to the cementitious aggregate composition. Examples of a filler or another additive: pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise Isolating the cementitious aggregate composition from the reduced salinity water component or other liquid components. The isolating may comprise straining to capture the cementitious aggregate composition.

When forming cementitious aggregate composition, the CO₂ is chemically reacted to form a crystalline form of carbon and this crystalline form is absorbed into the cementitious aggregate composition.

The cementitious aggregate composition formed by the above-described method will have features as disclosed elsewhere herein, e.g., particle size, pore size, pore number, and so forth.

### Example 4

In this example, another method for manufacturing a cementitious aggregate composition and a reduced salinity water component is described, here, using an in-line conversion method. The includes steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA), and/or a recycled aggregate (RA) or a carbonated recycled aggregate (CRA); and, optionally, an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO) and (b) permitting the combination obtained in step (a) to persist under conditions sufficient to transform the combination into a cementitious aggregate composition and a reduced salinity water component, wherein the conditions in step (b) preferably comprises applied pressure and wherein steps (a) and/or (b) occur in a pipeline.

The high salinity brine, CO₂, and the natural pozzolan, the man-made pozzolan, the latently hydraulic material, and/or the recycled aggregate (RA) or the carbonated recycled aggregate (CRA) are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility. These steps can occur in a pipeline. When step (b) occurs in a pipeline, pressure applied to the pipeline utilizing a series of pipe reducers, which are mechanical devices used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

In some cases, step (a) further comprises an activator; the activator may be any sodium, lithium or potassium salt or hydroxide and any alkali or alkali earth metal ions and including one or more of Mg(OH)₂, MgO, Ca(OH)₂, CaCO₃, Al₂(SO₄)₃, and CaO.

Step (b) produces exothermic heat and this exothermic heat is transformable from thermal energy into electrical energy.

The pressure in step (b) is from about ambient (1 bar) to about 250 bar, e.g., from about 100 bar to about 250 bar or from about ambient (1 bar) to about 100 bar, and any range or value therebetween. The pressure in step (b) may be greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to the natural pozzolan, the man-made pozzolan, the latently hydraulic material, and/or the recycled aggregate (RA) or the carbonated recycled aggregate (CRA) varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the natural pozzolan, the man-made pozzolan, the latently hydraulic material, and/or the recycled aggregate (RA) or the carbonated recycled aggregate (CRA) to CO₂ varies from 1:100 to 100:1, and any range or value therebetween.

In some cases, an aggregate is added to the combination of step (a). The aggregate may comprise sand, gravel, lightweight aggregate, recycled aggregate (RA), carbonated recycled aggregate (CRA), or crushed stone, and a combination thereof.

In various cases, the latently hydraulic material is a slag. The slag may be added in step (a) in addition to the added pozzolan or the slag is added in step (a) instead of pozzolan. The slag may be added in step (a) instead of an activator.

At least one filler material or other additive, may be added to the cementitious aggregate composition. Examples of a filler or another additive: pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise Isolating the cementitious aggregate composition from the reduced salinity water component or other liquid components. The isolating may comprise straining to capture the cementitious aggregate composition.

When forming cementitious aggregate composition, the CO₂ is chemically reacted to form a crystalline form of carbon and this crystalline form is absorbed into the cementitious aggregate composition.

The cementitious aggregate composition formed by the above-described method will have features as disclosed elsewhere herein, e.g., particle size, pore size, pore number, and so forth.

### Example 5

In this example, a further method for manufacturing a cementitious aggregate composition and a reduced salinity water component is described, here, using an in-line conversion method. The method includes steps of: (a) combining (i) a high salinity brine, (ii) CO₂, and (iii) a pozzolan, a latently hydraulic material, and/or a recycled aggregate (RA) or a carbonated recycled aggregate (CRA); and (b) applying pressure to the combination obtained in step (a) for an amount and duration sufficient to transform the combination into a cementitious aggregate composition and a reduced salinity water component, wherein the conditions in step (b) comprise applied pressure and wherein steps (a) and/or (b) occur in a pipeline.

The high salinity brine, CO₂, and the natural pozzolan, the man-made pozzolan, the latently hydraulic material, and/or the recycled aggregate (RA) or the carbonated recycled aggregate (CRA) are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium, sulphates, and/or chlorides and produces additional fresh water. The extracted sodium may be isolated into a pure sodium product. The extraction of sodium from the reduced salinity water component is more efficient since the sodium and chloride have substantially already been removed.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility. These steps can occur in a pipeline. When step (b) occurs in a pipeline, pressure applied to the pipeline utilizing a series of pipe reducers, which are mechanical devices used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

Step (b) produces exothermic heat and this exothermic heat is transformable from thermal energy into electrical energy.

The pressure in step (b) is from about ambient (1 bar) to about 250 bar, e.g., from about 100 bar to about 250 bar or from about ambient (1 bar) to about 100 bar, and any range or value therebetween. The pressure in step (b) may be greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to the natural pozzolan, the man-made pozzolan, the latently hydraulic material, and/or the recycled aggregate (RA) or the carbonated recycled aggregate (CRA) varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the natural pozzolan, the man-made pozzolan, the latently hydraulic material, and/or the recycled aggregate (RA) or the carbonated recycled aggregate (CRA) to CO₂ varies from 1:100 to 100:1, and any range or value therebetween.

In some cases, an aggregate is added to the combination of step (a). The aggregate may comprise sand, gravel, lightweight aggregate, recycled aggregate (RA), carbonated recycled aggregate (CRA), or crushed stone, and a combination thereof.

In various cases, the latently hydraulic material is a slag. The slag may be added in step (a) in addition to the added pozzolan or the slag is added in step (a) instead of pozzolan.

At least one filler material or other additive, may be added to the cementitious aggregate composition. Examples of a filler or another additive: pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise Isolating the cementitious aggregate composition from the reduced salinity water component or other liquid components. The isolating may comprise straining to capture the cementitious aggregate composition.

When forming cementitious aggregate composition, the CO₂ is chemically reacted to form a crystalline form of carbon and this crystalline form is absorbed into the cementitious aggregate composition.

The cementitious aggregate composition formed by the above-described method will have features as disclosed elsewhere herein, e.g., particle size, pore size, pore number, and so forth.

### Example 6

In this example, a further method for manufacturing a cementitious aggregate composition and a reduced salinity water component is described, here, using an in-line conversion method. An additional aspect of the present disclosure is an in-line conversion method comprising steps of: (a) combining (i) a high salinity brine, (ii) CO₂, and (iii) a pozzolan, a latently hydraulic material, and/or a recycled aggregate (RA) or a carbonated recycled aggregate (CRA); (b) allowing the combination obtained in step (a) to persist for duration sufficient to transform the combination into a cementitious aggregate composition and a reduced salinity water component, wherein steps (a) and/or (b) occur in a pipeline.

The conditions sufficient to transform the combination into a cementitious aggregate composition and a reduced salinity water component in step (b) comprise time and applied pressure.

The high salinity brine, CO₂, and the natural pozzolan, the man-made pozzolan, the latently hydraulic material, and/or the recycled aggregate (RA) or the carbonated recycled aggregate (CRA) are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water.

Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility. These steps can occur in a pipeline. When step (b) occurs in a pipeline, pressure applied to the pipeline utilizing a series of pipe reducers, which are mechanical devices used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

Step (b) produces exothermic heat and this exothermic heat is transformable from thermal energy into electrical energy.

The pressure in step (b) is from about ambient (1 bar) to about 250 bar, e.g., from about 100 bar to about 250 bar or from about ambient (1 bar) to about 100 bar, and any range or value therebetween. The pressure in step (b) may be greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to the natural pozzolan, the man-made pozzolan, the latently hydraulic material, and/or the recycled aggregate (RA) or the carbonated recycled aggregate (CRA) varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the a natural pozzolan, a man-made pozzolan, a latently hydraulic material, and/or a recycled aggregate (RA) or a carbonated recycled aggregate (CRA) to CO₂ varies from 1:100 to 100:1, and any range or value therebetween.

In some cases, an aggregate is added to the combination of step (a). The aggregate may comprise sand, gravel, lightweight aggregate, recycled aggregate (RA), carbonated recycled aggregate (CRA), or crushed stone, and a combination thereof.

In various cases, the latently hydraulic material is a slag. The slag may be added in step (a) in addition to the added pozzolan or the slag is added in step (a) instead of pozzolan. The slag may be added in step (a) instead of an activator.

At least one filler material or other additive, may be added to the cementitious aggregate composition. Examples of a filler or another additive: pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise Isolating the cementitious aggregate composition from the reduced salinity water component or other liquid components. The isolating may comprise straining to capture the cementitious aggregate composition.

When forming cementitious aggregate composition, the CO₂ is chemically reacted to form a crystalline form of carbon and this crystalline form is absorbed into the cementitious aggregate composition.

The cementitious aggregate composition formed by the above-described method will have features as disclosed elsewhere herein, e.g., particle size, pore size, pore number, and so forth.

### Example 7

In this example, yet another method for manufacturing a cementitious aggregate composition and a reduced salinity water component is described, here, using an in-line conversion method. The method includes steps of: (a) combining (i) a high salinity brine, (ii) CO₂, (iii) a pozzolan, a latently hydraulic material, and/or a recycled aggregate (RA) or a carbonated recycled aggregate (CRA), and (iv) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO); and (b) applying pressure to the combination obtained in step (a) for an amount and duration sufficient to transform the combination into a cementitious aggregate composition and a reduced salinity water component, wherein the conditions in step (b) comprise applied pressure and wherein steps (a) and/or (b) occur in a pipeline.

The high salinity brine, CO₂, and the natural pozzolan, the man-made pozzolan, the latently hydraulic material, and/or the recycled aggregate (RA) or the carbonated recycled aggregate (CRA) are combined simultaneously or are combined sequentially and in any order. The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility. These steps can occur in a pipeline. When step (b) occurs in a pipeline, pressure applied to the pipeline utilizing a series of pipe reducers, which are mechanical devices used to reduce the diameter of a pipe, which creates pressure by restricting the flow of a fluid. In other cases, the pressure in step (b) is applied using another method which creates pressure sufficient to make the conversion process (e.g., chemical reactions) more efficient. In numerous cases, the applied pressure further reduces the amount of energy required and/or waste CO₂ produced.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

In some cases, step (a) further comprises an activator; the activator may be any sodium, lithium or potassium salt or hydroxide and any alkali or alkali earth metal ions and including one or more of Mg(OH)₂, MgO, Ca(OH)₂, CaCO₃, Al₂(SO₄)₃, and CaO.

Step (b) produces exothermic heat and this exothermic heat is transformable from thermal energy into electrical energy.

The pressure in step (b) is from about ambient (1 bar) to about 250 bar, e.g., from about 100 bar to about 250 bar or from about ambient (1 bar) to about 100 bar, and any range or value therebetween. The pressure in step (b) may be greater than about 250 bar. For example, the pressure in step (b) is greater than, 250 bar, 500 bar, 750 bar, 1000 bar, 1250 bar, 1500 bar, 1750 bar, 2000 bar, 2250 bar, 2500 bar, 2750 bar, 3000 bar, 3250 bar, 3500 bar, 3750 bar, 4000 bar, 4250 bar, 4500 bar, 4750 bar, 5000 bar and any range or value therebetween. The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to the natural pozzolan, the man-made pozzolan, the latently hydraulic material, and/or the recycled aggregate (RA) or the carbonated recycled aggregate (CRA) varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the pozzolan, the latently hydraulic material, and/or the recycled aggregate (RA) or the carbonated recycled aggregate (CRA) to CO₂ varies from 1:100 to 100:1, and any range or value therebetween.

In some cases, an aggregate is added to the combination of step (a). The aggregate may comprise sand, gravel, lightweight aggregate, recycled aggregate (RA), carbonated recycled aggregate (CRA), or crushed stone, and a combination thereof.

In various cases, the latently hydraulic material is a slag. The slag may be added in step (a) in addition to the added pozzolan or the slag is added in step (a) instead of pozzolan. The slag may be added in step (a) instead of an activator.

At least one filler material or other additive, may be added to the cementitious aggregate composition. Examples of a filler or another additive: pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise Isolating the cementitious aggregate composition from the reduced salinity water component or other liquid components. The isolating may comprise straining to capture the cementitious aggregate composition.

When forming cementitious aggregate composition, the CO₂ is chemically reacted to form a crystalline form of carbon and this crystalline form is absorbed into the cementitious aggregate composition.

The cementitious aggregate composition formed by the above-described method will have features as disclosed elsewhere herein, e.g., particle size, pore size, pore number, and so forth.

### Example 8

In this example, yet another method for manufacturing a cementitious aggregate composition and a reduced salinity water component is described, here, using a tank precipitation method. The method including steps of: (a) combining (i) a high salinity brine, (ii) CO₂, and (iii) a pozzolan, a latently hydraulic material, and/or a recycled aggregate (RA) or a carbonated recycled aggregate (CRA); and (b) permitting the combination obtained in step (a) to persist under conditions sufficient to transform the combination into a cementitious aggregate composition and a reduced salinity water component, wherein the conditions in step (b) does not comprise applied pressure and wherein steps (a) and/or (b) occur in a tank or basin.

The conditions sufficient to transform the combination into a cementitious aggregate composition and a reduced salinity water component in step (b) comprise time and heat.

The high salinity brine, CO₂, and the natural pozzolan, the man-made pozzolan, the latently hydraulic material, and/or the recycled aggregate (RA) or the carbonated recycled aggregate (CRA) are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

Step (b) produces exothermic heat and this exothermic heat is transformable from thermal energy into electrical energy.

The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to the pozzolan, the latently hydraulic material, and/or a recycled aggregate (RA) or the carbonated recycled aggregate (CRA) varies from 1:100 to 100:1, and any range or value therebetween. The ratio (weight to weight or weight to volume or volume to volume) of the high salinity brine to CO₂ varies from 1:100 to 100:1, and any range or value therebetween.

The ratio (weight to weight or weight to volume or volume to volume) of the pozzolan, the latently hydraulic material, and/or the recycled aggregate (RA) or the carbonated recycled aggregate (CRA) to CO₂ varies from 1:100 to 100:1, and any range or value therebetween.

In some cases, an aggregate is added to the combination of step (a). The aggregate may comprise sand, gravel, lightweight aggregate, recycled aggregate (RA), carbonated recycled aggregate (CRA), or crushed stone, and a combination thereof.

In various cases, the latently hydraulic material is a slag. The slag may be added in step (a) in addition to the added pozzolan or the slag is added in step (a) instead of pozzolan.

At least one filler material or other additive, may be added to the cementitious aggregate composition. Examples of a filler or another additive: pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise Isolating the cementitious aggregate composition from the reduced salinity water component or other liquid components. The isolating may comprise straining to capture the cementitious aggregate composition.

When forming cementitious aggregate composition, the CO₂ is chemically reacted to form a crystalline form of carbon and this crystalline form is absorbed into the cementitious aggregate composition.

The cementitious aggregate composition formed by the above-described method will have features as disclosed elsewhere herein, e.g., particle size, pore size, pore number, and so forth.

### Example 9

In this example, yet another method for manufacturing a cementitious aggregate composition and a reduced salinity water component is described, here, using a tank precipitation method. The method includes steps of: (a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and, optionally, an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO) and (b) permitting the combination obtained in step (a) to persist under conditions sufficient to transform the combination into a cementitious aggregate composition and a reduced salinity water component, wherein the conditions in step (b) does not comprise applied pressure and wherein steps (a) and/or (b) occur in a tank or basin.

The conditions sufficient to transform the combination into a cementitious aggregate composition and a reduced salinity water component in step (b) comprise time and heat.

The high salinity brine, CO₂, and a natural pozzolan, a man-made pozzolan, a latently hydraulic material, and/or a recycled aggregate (RA) or a carbonated recycled aggregate (CRA) are combined simultaneously or are combined sequentially and in any order.

The high salinity brine may be obtained from a desalination facility, is natural seawater, or an industrial brine.

A benefit of the present method is that the reduced salinity water component can be added to a natural or artificial body of water. The reduced salinity water component does less harm to flora and/or fauna present in the natural or artificial body of water relative to the harm that would be caused when the high salinity brine is added to a natural or artificial body of water. Without wising to be bound by theory, the reduced salinity water comprises less sulphates and chlorides than high salinity brine, which also are harmful to flora and/or fauna present in the natural or artificial body of water.

In some cases, the reduced salinity water component is returned to the desalination plant for a further round of desalination into fresh water.

In some embodiments, the reduced salinity water component is further processed to extract sodium to produce additional fresh water. In addition to or in combination with or after the above-described processes, a chloralkali process can more efficiently be performed, since, at least in part, because the sulphates and chlorides have already been removed. The extracted sodium may be isolated into a pure sodium product.

The salt concentration of the high salinity brine is greater than or about equal to the salt concentration of seawater, whereas the salt concentration of the reduced salinity water component is less than or about equal to the salt concentration of seawater. Notably, the salt concentration of the reduced salinity water component is less than the high salinity brine. In various cases, the high salinity brine comprises water with a salt concentration (e.g., chloride, sulphate, and sodium) higher than 50 parts per thousand.

Steps (a) and/or (b) occurs in a location within the desalination facility, adjacent to the desalination facility, or downstream from the desalination facility.

The pozzolan combined in step (a) comprises silica (SiO₂), alumina (Al₂O₃), and/or iron oxide (Fe₂O₃). The pozzolan may be a natural pozzolan or a man-made pozzolan. The pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

The CO₂ of step (a) is from industrial waste, from environmental sources, or from molecular capture. In some cases, the industrial waste relates to alcoholic fermentation or the burning of fossil fuels. The CO₂ of step (a) is provided in gaseous, solid, and/or as a supercritical fluid form or as a dissolved gas.

In some cases, step (a) further comprises an activator; the activator may be any sodium, lithium or potassium salt or hydroxide and any alkali or alkali earth metal ions and including one or more of Mg(OH)₂, MgO, Ca(OH)₂, CaCO₃, Al₂(SO₄)₃, and CaO.

Step (b) produces exothermic heat and this exothermic heat is transformable from thermal energy into electrical energy.

The temperature of step (a) and/or step (b) is from about 1° C. to about 100° C., and any range or value therebetween. The duration of step (b) is from about 1 minute to about 10 hours, and any range or value therebetween.

The ratio (weight to weight or weight to volume or volume to volume) of the high salinity brine to a natural pozzolan, a man-made pozzolan, a latently hydraulic material, and/or a recycled aggregate (RA) or a carbonated recycled aggregate (CRA) varies from 1:100 to 100:1, and any range or value therebetween. The ratio (weight to weight or weight to volume or volume to volume) of the high salinity brine to CO₂ varies from 1:100 to 100:1, and any range or value therebetween. The ratio (weight to weight or weight to volume or volume to volume) of the natural pozzolan, the man-made pozzolan, the latently hydraulic material, and/or the recycled aggregate (RA) or the carbonated recycled aggregate (CRA) to CO₂ varies from 1:100 to 100:1, and any range or value therebetween.

In some cases, an aggregate is added to the combination of step (a). The aggregate may comprise sand, gravel, lightweight aggregate, recycled aggregate (RA), carbonated recycled aggregate (CRA), or crushed stone, and a combination thereof.

In various cases, the latently hydraulic material is a slag. The slag may be added in step (a) in addition to the added pozzolan or the slag is added in step (a) instead of pozzolan. The slag may be added in step (a) instead of an activator.

At least one filler material or other additive, may be added to the cementitious aggregate composition. Examples of a filler or another additive: pumice or other volcanic rock or material, sand, gravel, crushed stone, aggregate (e.g., fine aggregate, coarse aggregate, intermediate aggregate, recycled aggregate (RA), carbonated recycled aggregate (CRA), other types of aggregate, etc.), lightweight aggregate, talc, other clay material, fibers (e.g., steel and/or other metallic fibers, polypropylene and/or other polymeric fibers, glass fibers, asbestos fibers, carbon fibers, organic fibers, etc.), glass fiber reinforced plastic (GFRP), other reinforced polymers, admixtures or other additives that facilitate with fire protection, water protection, corrosion resistance/inhibition, workability, and/or one more other properties of the final cured product (e.g., MasterPel, RheoCell, MasterCell, etc.), sodium naphthalene sulfonate formaldehyde (SNF) and/or other surfactants, plasticizers, pigments, dyes and other color additives, titanium dioxide, other minerals, other natural or synthetic materials, other filler materials and/or the like.

The method may further comprise Isolating the cementitious aggregate composition from the reduced salinity water component or other liquid components. The isolating may comprise straining to capture the cementitious aggregate composition.

When forming cementitious aggregate composition, the CO₂ is chemically reacted to form a crystalline form of carbon and this crystalline form is absorbed into the cementitious aggregate composition.

The cementitious aggregate composition formed by the above-described method will have features as disclosed elsewhere herein, e.g., particle size, pore size, pore number, and so forth.

### Example 10

In this example, cementitious aggregate composition deposited into a natural or artificial body of water.

The method comprises obtaining a cementitious aggregate composition formed by a herein-disclosed method, e.g., from Example 3 to Example 9.

The cementitious aggregate composition may be filtered from the reduced salinity water component or allowed to sediment. The cementitious aggregate composition may be isolated on land and transported to a natural or artificial body of water.

The cementitious aggregate composition is deposited into natural or artificial body of water. There, the cementitious aggregate composition remains where deposited or a portion of the cementitious aggregate composition is distributed away from the deposit site, e.g., by water movement or currents, erosion, or animal activity.

Once deposited, the cementitious aggregate composition permits attachment by flora, e.g., algae, and/or fauna, e.g., coral. In many cases, the cementitious aggregate composition permits a preferred level of colonization by flora and/or fauna relative to a standard cement and/or the cementitious aggregate composition permits more plentiful attachment by flora and/or fauna relative to a standard cement.

### Example 11

In this example, a cementitious aggregate composition is molded into a shaped cementitious composition.

The method comprises obtaining a cementitious aggregate composition formed by a herein-disclosed method, e.g., from Example 1 to Example 9.

The cementitious aggregate composition is molded into a shaped cementitious composition. Particles of the cementitious aggregate composition can stick to each other, thereby permitting the molding of the composition into shapes. In some case, molding may not require an additional binder to keep the molded shape and in other cases, molding may require an additional binder to keep the molded shape. In some cases, the shaped cementitious composition, when deposited into a natural or artificial body of water, permits attachment by flora, e.g., algae, and/or fauna, e.g., coral, relative to a standard cement. In various cases, the shaped cementitious composition permits stronger attachment by flora and/or fauna relative to a standard cement and/or the shaped cementitious composition permits more plentiful attachment by flora and/or fauna relative to a standard cement. When molded, the shaped cementitious composition comprises gaps between particles of the aggregate such that the shaped cementitious composition has a more porous surface, is more porous throughout its volume, and is less dense than a standard cement. The gaps of a shaped cementitious composition may be up to 500 nm in diameter. Additionally, a shaped cementitious composition may have up to 85% of the volume being void (e.g., the sum of all gaps) whereas a standard cement may have about 40% of the volume being void.

The shape of the shaped cementitious composition may be any shape capable of providing a substrate for aquatic flora and/or fauna attachment. The shape could be planar, circular, rounded, elongated, flat, rectangular, or any combination thereof. In some embodiments, the shape is pyramidal with closed surfaces. In other embodiments, the shape is pyramidal with open surfaces such that the shape comprises four bars or cylinders that form a square base and four bars or cylinders each originating at a corner of the square and converging to form the pyramid's apex.

Although the foregoing embodiments have been described in some detail by way of illustration and Example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A method comprising steps of:
(a) combining (i) a high salinity brine, (ii) CO₂, and (iii) a natural pozzolan, a man-made pozzolan, a latently hydraulic material, and/or a recycled aggregate (RA) or a carbonated recycled aggregate (CRA); and
(b) permitting the combination obtained in step (a) to persist under conditions sufficient to transform the combination into a cementitious aggregate composition and a reduced salinity water component.

2. The method of claim 1, wherein the conditions sufficient to transform the combination into a cementitious aggregate composition and a reduced salinity water component in step (b) comprise time and applied pressure.

3. The method of claim 1, wherein the high salinity brine, CO₂, and the natural pozzolan, the man-made pozzolan, the latently hydraulic material, and/or the recycled aggregate (RA) or the carbonated recycled aggregate (CRA) are combined simultaneously.

4. The method of claim 1, wherein the high salinity brine, CO₂, and the natural pozzolan, the man-made pozzolan, the latently hydraulic material, and/or the recycled aggregate (RA) or the carbonated recycled aggregate (CRA) are combined sequentially with the high salinity brine and CO₂ combined first.

5. The method of claim 1, wherein the high salinity brine, CO₂, the natural pozzolan, the man-made pozzolan, the latently hydraulic material, and/or the recycled aggregate (RA) or the carbonated recycled aggregate (CRA) are combined sequentially with the CO₂ and the pozzolan combined first.

6. The method of claim 1, wherein the high salinity brine, CO₂, and the natural pozzolan, the man-made pozzolan, the latently hydraulic material, and/or the recycled aggregate (RA) or the carbonated recycled aggregate (CRA) are combined sequentially with the high salinity brine and the pozzolan combined first.

7. The method of any one of claims 1 to 6, wherein the high salinity brine is obtained from a desalination facility, is natural seawater, or an industrial brine.

8. The method of any one of claims 1 to 7, wherein the salt concentration of the high salinity brine is greater than or about equal to the salt concentration of seawater.

9. The method of any one of claims 1 to 8, wherein the salt concentration of the reduced salinity water component is less than or about equal to the salt concentration of seawater.

10. The method of any one of claims 1 to 9, wherein the salt concentration of the reduced salinity water component is less than the high salinity brine.

11. The method of any one of claims 1 to 10, wherein the high salinity brine comprises water with a salt concentration (e.g., chloride, sulphate, and sodium) higher than 50 parts per thousand.

12. The method of any one of claims 1 to 11, wherein the method further comprises further adding an activator in step (a).

13. The method of claim 12, wherein the activator is any sodium, lithium or potassium salt or hydroxide and any alkali or alkali earth metal ions.

14. The method of claim 12 or claim 13, wherein the activator is one or more of Mg(OH)₂, MgO, Ca(OH)₂, CaCO₃, Al₂(SO₄)₃, and CaO.

15. The method of any one of claims 1 to 12, wherein the brine of step (a) has reduced amounts of sodium, potassium, chloride, sulphate, magnesium, and/or calcium ions via chemical precipitation, electrochemical methods, ion selective membranes, reverse osmosis, and/or selective precipitation by pH.

16. The method of claim 15, wherein the chemical precipitation comprises contacting the sodium, potassium, chloride, sulphate, magnesium, and/or calcium ions with lime (calcium hydroxide, Ca(OH)₂) or alum (aluminum sulfate, Al₂(SO₄)₃) which forms insoluble precipitates with the sodium, potassium, chloride, sulphate, magnesium, and/or calcium ions.

17. The method of claim 15 or claim 16, wherein the chemical precipitation occurs before step (a) and/or during step (a).

18. The method of any one of claims 1 to 12, wherein the reduced salinity water component is added to a natural or artificial body of water.

19. The method of claim 18, wherein the reduced salinity water component does less harm to flora and/or fauna present in the natural or artificial body of water relative to the harm that would be caused when the high salinity brine is added to a natural or artificial body of water.

20. The method of claim 19, wherein the reduced salinity water comprises less sulphates and chlorides than high salinity brine, which also are harmful to flora and/or fauna present in the natural or artificial body of water.

21. The method of any one of claims 1 to 19, wherein the reduced salinity water component is returned to the desalination plant for a further round of desalination into fresh water.

22. The method of any one of claims 1 to 19, wherein the reduced salinity water component is further processed to extract sodium and produce additional fresh water.

23. The method of claim 22, wherein the process is more efficient since the sodium and chloride has substantially already been removed.

24. The method of any one of claims 7 to 21, wherein the method permits production by a desalination facility of a brine having a higher salt concentration relative to a method where the desalination facility produces brine as wastewater to be added to a natural or artificial body of water.

25. The method of claim 24, wherein the relative salt concentration is up to 5-fold higher.

26. The method of any one of claims 7 to 24, wherein the method permits production of more fresh water by a desalination facility relative to a method where the desalination facility produces brine as wastewater to be added to a natural or artificial body of water.

27. The method of claim 26, wherein the amount of fresh water produced is up to 5-fold higher.

28. The method of any one of claims 1 to 26, wherein the steps (a) and/or (b) occurs in a location within the desalination facility, adjacent to the desalination facility, or downstream from the desalination facility.

29. The method of any one of claims 1 to 26, wherein the steps (a) and/or (b) occurs in a location distant from the desalination facility.

30. The method of claim 28 or claim 29, wherein step (a) and/or step (b) occurs in a pipeline within the desalination facility, adjacent to the desalination facility, or downstream from the desalination facility.

31. The method of claim 30, wherein the pressure in step (b) is applied to the pipeline utilizing a series of pipe reducers or another method, each of which creates pressure sufficient to make the conversion process (e.g., chemical reactions) more efficient.

32. The method of claim 31, wherein a pipe reducer is a mechanical device used to reduce the diameter of a pipe, which creates pressure by restricting the flow of a fluid.

33. The method of claim 31 or claim 32, wherein the applied pressure further reduces the amount of energy required and/or waste CO₂ produced.

34. The method of claim 28 or claim 29, wherein steps (a) and/or (b) occurs in a tank or basin.

35. The method of claim 34, wherein step (a) further comprises adding an activator.

36. The method of claim 35, wherein the activator is any sodium, lithium or potassium salt or hydroxide and any alkali or alkali earth metal ions.

37. The method of claim 35 or claim 36, wherein the activator is one or more of Mg(OH)₂, MgO, Ca(OH)₂, CaCO₃, Al₂(SO₄)₃, and CaO.

38. The method of any one of claims 1 to 30, wherein the pozzolan comprises silica (SiO₂), alumina (Al₂O₃), and/or iron oxide (Fe₂O₃).

39. The method of any one of claims 1 to 38, wherein the pozzolan is a natural pozzolan or a man-made pozzolan.

40. The method of any one of claims 1 to 38, wherein the pozzolan comprises or is obtained from one or more of volcanic rock (e.g., rhyolite, obsidian, pitchstone, pumice, basalt or trap, or andesite); volcanic ash; sedimentary clays or shales' calcined clays; rice husk ash; diatomaceous earth; metakaolin; and olivine.

41. The method of any one of claims 1 to 40, wherein use of pozzolan avoids the problem of sourcing cementitious material that is used in standard concrete manufacturing.

42. The method of claim 41, wherein avoiding the problem of sourcing cementitious material further reduces the amount of energy required and/or waste CO₂ produced relative to standard concrete manufacturing.

43. The method of any one of claims 1 to 42, wherein the cementitious aggregate composition absorbs more carbon dioxide during its manufacture than is emitted.

44. The method of any one of claims 1 to 43, wherein the cementitious aggregate composition absorbs and/or retains at least 0.04 kg CO₂ per kg of composition.

45. The method of any one of claims 1 to 44, wherein the CO₂ is chemically reacted to form a crystalline form of carbon.

46. The method of any one of claims 1 to 44, wherein the CO₂ is absorbed into the cementitious aggregate composition as a crystalline form of carbon.

47. The method of any one of 1 to 44, wherein the CO₂ of step (a) is from industrial waste, from environmental sources, or from molecular capture.

48. The method of claim 47, wherein the industrial waste relates to alcoholic fermentation or the burning of fossil fuels.

49. The method of any one of claims 1 to 48, wherein the CO₂ of step (a) is provided in gaseous, solid, and/or as a supercritical fluid form or as a dissolved gas.

50. The method of any one of claims 1 to 49, wherein the CO₂ of step (a) is incorporated into the cementitious aggregate composition as a carbonate.

51. The method of any one of claims 1 to 50, wherein step (a) further comprises adding an activator that is any sodium, lithium or potassium salt or hydroxide and any alkali or alkali earth metal ions.

52. The method of any one of claims 1 to 51, wherein step (a) further comprises adding Mg(OH)₂, MgO, Ca(OH)₂, and/or CaO.

53. The method of any one of claims 1 to 48, wherein the cementitious aggregate composition forms particles of various shapes, sizes, and textures.

54. The method of claim 53, wherein the particles have average sizes ranging from 0.0625 mm to about 40.0 mm in diameter.

55. The method of claim 53 or 54, wherein the particles have generally rounded or oval shape.

56. The method of claim 55, wherein the particles are less dense per unit volume than a standard cement.

57. The method of any one of claims 41 to 56, wherein the cementitious aggregate composition comprises more CO₂ per gram than a standard cement.

58. The method of claim 57, wherein the cementitious aggregate composition comprises up to 50% more CO₂ per gram than a standard cement.

59. The method of any one of claims 41 to 56, wherein the cementitious aggregate composition comprises more calcium, silicon, aluminum, magnesium and/or iron per gram than a standard cement.

60. The method of claim 59, wherein the cementitious aggregate composition comprises up to 50% more calcium, silicon, aluminum, magnesium and/or iron per gram than a standard cement.

61. The method of any one of claims 41 to 60, wherein the standard cement comprises CaO, CaCO₃, SiO₂, Al₂O₃, Fe₂O₃, and CaSO₄·H₂O.

62. The method of any one of claims 41 to 61, wherein the standard cement comprises a slaked or hydraulic dolomitic or calcareous lime blended with a natural or man-made pozzolanic or latently hydraulic material.

63. The method of any one of claims 41 to 61, wherein the standard cement, e.g., a standard hydrated cement, is a Portland Cement comprising cement clinker rather than pozzolan.

64. The method of any one of claims 41 to 63, wherein the cementitious aggregate composition is deposited into a natural or artificial body of water.

65. The method of claim 64, wherein when deposited into the natural or artificial body of water, the cementitious aggregate composition remains where deposited.

66. The method of claim 64 or 65, wherein when deposited into the natural or artificial body of water, a portion of the cementitious aggregate composition is distributed away from the deposit site.

67. The method of claim 66, wherein the cementitious aggregate composition is distributed away from the deposit site by water movement or currents, erosion, or animal activity.

68. The method of any one of claims 64 to 66, wherein the cementitious aggregate composition permits attachment by flora and/or fauna.

69. The method of claim 68, where the fauna comprises coral.

70. The method of claim 68, where the flora comprises algae.

71. The method of any one of claims 68 to 70, wherein the cementitious aggregate composition permits a preferred level of colonization by flora and/or fauna relative to a standard cement.

72. The method of any one of claims 68 to 70, wherein the cementitious aggregate composition permits more plentiful attachment by flora and/or fauna relative to a standard cement.

73. The method of any one of claims 1 to 72, wherein the cementitious aggregate composition comprises any sodium, lithium or potassium salt or hydroxide and any alkali or alkali earth metal ions and including Mg(OH)₂, MgO, Ca(OH)₂, CaCO₃, Al₂(SO₄)₃, CaO, CaSO₄·H₂O, SiO₂, Fe₂O₃, Al₂O₃ and/or Brucite.

74. The method of any one of claims 1 to 73, wherein the cementitious aggregate composition comprises MgO.

75. The method of any one of claims 1 to 73, wherein the cementitious aggregate composition does not substantially comprise MgO obtained from a calcination reaction.

76. The method of any one of claims 1 to 74, wherein step (b) produces exothermic heat.

77. The method of claim 75, wherein the exothermic heat is transformable from thermal energy into electrical energy.

78. The method of any one of claims 2 to 77, wherein the pressure in step (b) is from about ambient (1 bar) to about 250 bar.

79. The method of any one of claims 2 to 78, wherein the pressure in step (b) is from about 100 bar to about 250 bar.

80. The method of any one of claims 2 to 78, wherein the pressure in step (b) is from about ambient (1 bar) bar to about 100 bar.

81. The method of any one of claims 2 to 80, wherein the temperature of step (a) and/or step (b) is from about 1° C. to about 100° C.

82. The method of any one of claims 2 to 80, wherein the duration of step (b) is from about 1 minute to about 10 hours.

83. The method of any one of claims 2 to 81, wherein the duration of step (b) is from about 1 minute to about 10 minutes.

84. The method of any one of claims 1 to 83, wherein an aggregate is added to the combination of step (a).

85. The method of claim 84, wherein the aggregate comprises sand, gravel, lightweight aggregate, recycled aggregate (RA), carbonated recycled aggregate (CRA), or crushed stone, and a combination thereof.

86. The method of any one of claims 1 to 85, wherein the latently hydraulic material is a slag.

87. The method of claim 86, wherein the slag is added in step (a) in addition to the added pozzolan.

88. The method of claim 86, wherein the slag is added in step (a) instead of the activator.

89. The method of any one of claims 1 to 88, wherein the method further comprises isolating the cementitious aggregate composition from the reduced salinity water component or other liquid components.

90. The method of claim 89, wherein the isolating comprises straining to capture the cementitious aggregate composition.

91. The method of any one of claims 1 to 53 or 84 to 90, wherein the cementitious aggregate composition is molded into a shaped cementitious composition.

92. The method of claim 91, wherein the shaped cementitious composition permits more plentiful and/or stronger attachment by flora and/or fauna relative to a standard cement.

93. The method of claim 92, where the fauna comprises coral.

94. The method of claim 92, where the flora comprises algae.

95. The method of any one of claims 92 to 94, wherein the shaped cementitious composition permits stronger attachment by flora and/or fauna relative to a standard cement.

96. The method of any one of claims 91 to 94 wherein the shaped cementitious composition permits more plentiful attachment by flora and/or fauna relative to a standard cement.

97. The method of any one of claims 92 to 96, wherein the shape of the shaped cementitious composition is any shape capable of providing a substrate for aquatic flora and/or fauna attachment.

98. The method of any one of claims 92 to 97, wherein the shape is planar, circular, rounded, elongated, flat, rectangular, or any combination thereof.

99. The method of any one of claims 92 to 97, wherein the shape is pyramidal with closed surfaces.

100. The method of any one of claims 92 to 99, wherein the shape is pyramidal with open surfaces such that the shape comprises four bars or cylinders that form a square base and four bars or cylinders each originating at a corner of the square and converging to form the pyramid's apex.

101. The method of any one of claims 1 to 100, wherein heat is applied to the mixture.

102. The method of claim 101, wherein the heat increases the rate of reaction and/or the extent of reaction.

103. The method of claim 101 or 102, wherein the heat activates the latent hydraulic nature of some components.

104. The method of any one of claims 101 to 103, wherein the heat provides a temperature of greater than 100° C. and up to 3000° C.

105. The method of any one of claims 1 to 100, wherein the combination obtained in step (a) is selected from the group consisting of:
A. (1) brine, (2) CO₂, and (3) a recycled aggregate (RA);
B. (1) brine, (2) CO₂, (3) a recycled aggregate (RA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
C. (1) brine, (2) CO₂, and (3) a carbonated recycled aggregate (CRA);
D. (1) brine, (2) CO₂, (3) carbonated recycled aggregate (CRA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
E. (1) brine, (2) CO₂, and (3) a natural pozzolan;
F. (1) brine, (2) CO₂, (3) a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
G. (1) brine, (2) CO₂, and (3) a man-made pozzolan;
H. (1) brine, (2) CO₂, (3) a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
I. (1) brine, (2) CO₂, and (3) a latently hydraulic material;
J. (1) brine, (2) CO₂, (3) a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
K. (1) brine, (2) CO₂, and (3) a recycled aggregate (RA) and a carbonated recycled aggregate (CRA);
L. (1) brine, (2) CO₂, (3) a recycled aggregate (RA) and carbonated recycled aggregate (CRA), and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
M. (1) brine, (2) CO₂, and (3) a recycled aggregate (RA) and a natural pozzolan;
N. (1) brine, (2) CO₂, (3) a recycled aggregate (RA) and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
O. (1) brine, (2) CO₂, and (3) a recycled aggregate (RA) and a man-made pozzolan;
P. (1) brine, (2) CO₂, (3) a recycled aggregate (RA) and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
Q. (1) brine, (2) CO₂, and (3) a recycled aggregate (RA) and a latently hydraulic material;
R. (1) brine, (2) CO₂, (3) a recycled aggregate (RA) and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
S. (1) brine, (2) CO₂, and (3) a recycled aggregate (RA), a natural pozzolan, and a man-made pozzolan;
T. (1) brine, (2) CO₂, (3) a recycled aggregate (RA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
U. (1) brine, (2) CO₂, and (3) a recycled aggregate (RA), a natural pozzolan, and a latently hydraulic material;
V. (1) brine, (2) CO₂, (3) a recycled aggregate (RA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
W. (1) brine, (2) CO₂, and (3) a recycled aggregate (RA), a man-made pozzolan, and a latently hydraulic material;
X. (1) brine, (2) CO₂, (3) a recycled aggregate (RA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
Y. (1) brine, (2) CO₂, and (3) a recycled aggregate (RA), a natural pozzolan, a man-made pozzolan, and a latently hydraulic material;
Z. (1) brine, (2) CO₂, (3) a recycled aggregate (RA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).
AA. (1) brine, (2) CO₂, and (3) a carbonated recycled aggregate (CRA) and a natural pozzolan;
BB. (1) brine, (2) CO₂, (3) a carbonated recycled aggregate (CRA) and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
CC. (1) brine, (2) CO₂, and (3) a carbonated recycled aggregate (CRA) and a man-made pozzolan;
DD. (1) brine, (2) CO₂, (3) a carbonated recycled aggregate (CRA) and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
EE. (1) brine, (2) CO₂, and (3) a carbonated recycled aggregate (CRA) and a latently hydraulic material;
FF. (1) brine, (2) CO₂, (3) a carbonated recycled aggregate (CRA) and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
GG. (1) brine, (2) CO₂, and (3) a carbonated recycled aggregate (CRA), a natural pozzolan, and a man-made pozzolan;
HH. (1) brine, (2) CO₂, (3) a carbonated recycled aggregate (CRA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
II. (1) brine, (2) CO₂, and (3) a carbonated recycled aggregate (CRA), a natural pozzolan, and a latently hydraulic material;
JJ. (1) brine, (2) CO₂, (3) a carbonated recycled aggregate (CRA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
KK. (1) brine, (2) CO₂, and (3) a carbonated recycled aggregate (CRA), a man-made pozzolan, and a latently hydraulic material;
LL. (1) brine, (2) CO₂, (3) a carbonated recycled aggregate (CRA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
MM. (1) brine, (2) CO₂, and (3) a carbonated recycled aggregate (CRA), a natural pozzolan, a man-made pozzolan, and a latently hydraulic material;
NN. (1) brine, (2) CO₂, (3) a carbonated recycled aggregate (CRA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).
OO. (1) brine, (2) CO₂, and (3) a recycled aggregate (RA), a carbonated recycled aggregate (CRA), and a natural pozzolan;
PP. (1) brine, (2) CO₂, (3) a recycled aggregate (RA), a carbonated recycled aggregate (CRA), and a natural pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
QQ. (1) brine, (2) CO₂, and (3) a recycled aggregate (RA), a carbonated recycled aggregate (CRA), and a man-made pozzolan;
RR. (1) brine, (2) CO₂, (3) a recycled aggregate (RA), a carbonated recycled aggregate (CRA), and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
SS. (1) brine, (2) CO₂, and (3) a recycled aggregate (RA), a carbonated recycled aggregate (CRA), and a latently hydraulic material;
TT. (1) brine, (2) CO₂, (3) a recycled aggregate (RA), a carbonated recycled aggregate (CRA), and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
UU. (1) brine, (2) CO₂, and (3) a recycled aggregate (RA), a carbonated recycled aggregate (CRA), a natural pozzolan, and a man-made pozzolan;
VV. (1) brine, (2) CO₂, (3) a recycled aggregate (RA), a carbonated recycled aggregate (CRA), a natural pozzolan, and a man-made pozzolan, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
WW. (1) brine, (2) CO₂, and (3) a recycled aggregate (RA), a carbonated recycled aggregate (CRA), a natural pozzolan, and a latently hydraulic material;
XX. (1) brine, (2) CO₂, (3) a recycled aggregate (RA), a carbonated recycled aggregate (CRA), a natural pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
YY. (1) brine, (2) CO₂, and (3) a recycled aggregate (RA), a carbonated recycled aggregate (CRA), a man-made pozzolan, and a latently hydraulic material;
ZZ. (1) brine, (2) CO₂, (3) a recycled aggregate (RA), a carbonated recycled aggregate (CRA), a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO);
AAA. (1) brine, (2) CO₂, and (3) a recycled aggregate (RA), a carbonated recycled aggregate (CRA), a natural pozzolan, a man-made pozzolan, and a latently hydraulic material; and
BBB. (1) brine, (2) CO₂, (3) a recycled aggregate (RA), a carbonated recycled aggregate (CRA), a natural pozzolan, a man-made pozzolan, and a latently hydraulic material, and (4) an activator (which may be any sodium, lithium or potassium salt or hydroxide and any alkali or alkali earth metal ions and including Mg(OH)₂, MgO, Ca(OH)₂, CaCO₃, Al₂(SO₄)₃, and/or CaO).

106. The method of any one of claims 1 to 105, wherein the cementitious aggregate composition comprises the recycled aggregate (RA) and/or the carbonated recycled aggregate (CRA).

107. The method of any one of claims 1 to 106, wherein the cementitious aggregate composition comprises the recycled aggregate (RA).

108. The method of any one of claims 1 to 106, wherein the cementitious aggregate composition comprises the carbonated recycled aggregate (CRA).

109. The method of any one of claims 1 to 108, wherein the cementitious aggregate composition comprises the recycled aggregate (RA) and the carbonated recycled aggregate (CRA).

110. The method of any one of claims 1 to 109, wherein a cementitious aggregate composition comprises a recycled aggregate (RA) and/or a carbonated recycled aggregate (CRA) has lower porosity, smaller maximum pore volume, a greater proportion of pores smaller than 0.2 mm, is denser specimen, has a reduced likelihood of pores developing into large cracks under the same load, has enhanced elasticity and hardness in the interior segment, elevated compressive strength, and/or deeper carbonation depth when compared to a comparable cementitious aggregate comprising a natural aggregate.

111. The method of any one of claims 1 to 110, wherein the proportion by weight of the natural pozzolan and/or man-made pozzolan is about 30% to about 130% in relation to the proportion by weight of MgO and/or Mg(OH)₂ of the cementitious aggregate composition.

112. The method of claim 111, wherein the proportion by weight of the natural pozzolan and/or man-made pozzolan is about 30% to about 120%, about 30% to about 110%, about 30% to about 100%, about 30% to about 95%, about 30% to about 90%, about 30% to about 85%, about 30% to about 80%, about 30% to about 75%, about 30% to about 70%, about 30% to about 65%, about 30% to about 60%, about 30% to about 55%, about 30% to about 50%, about 30% to about 45%, about 30% to about 40%, about 30% to about 35%, about 35% to about 130%, about 40% to about 130%, about 45% to about 130%, about 50% to about 130%, about 55% to about 130%, about 60% to about 130%, about 65% to about 130%, about 70% to about 130%, about 75% to about 130%, about 80% to about 130%, about 85% to about 130%, about 90% to about 130%, about 95% to about 130%, about 100% to about 130%, about 110% to about 130%, about 120% to about 130%, about 95% to about 105%, about 90% to about 110%, about 85% to about 115%, about 80% to about 120%, or about 75% to about 125% the proportion of the MgO and/or Mg(OH)₂ by percentage weight of the cementitious aggregate composition.

113. The method of any one of claims 1 to 112, wherein the sum of the proportions of MgO, Mg(OH)₂, natural pozzolan and/or man-made pozzolan is about 5% to about 90% by weight of the cementitious aggregate composition.

114. The method of claim 113, wherein the sum of the proportions of the MgO, Mg(OH)₂, natural pozzolan, and/or man-made pozzolan is about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 90%, about 15% to about 90%, about 20% to about 90%, about 25% to about 90%, about 30% to about 90%, about 35% to about 90%, about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 85% to about 90%, about 45% to about 55%, about 40% to about 60%, about 35% to about 65%, about 30% to about 70%, about 25% to about 75%, about 20% to about 80%, about 15% to about 85%, about 10% to about 85%, or about 15% to about 50% by weight of the cementitious aggregate composition.

115. The method of any one of claims 1 to 114, wherein the man-made pozzolan comprises one or both of slag cement and fly ash.

116. The method of any one of claims 1 to 115, wherein the man-made pozzolan comprises one or both of slag cement and Class C fly ash.

117. The method of any one of claims 1 to 116, wherein the cementitious aggregate composition does not comprise Class F fly ash.

118. The method of any one of claims 1 to 117, wherein the cementitious aggregate composition comprises one or more accelerants and the one or more accelerants comprise an accelerant selected from magnesium chloride, magnesium sulfate, magnesium nitrate, and a phosphate-based accelerant.

119. The method of any one of claims 1 to 118, wherein the cementitious aggregate composition does not comprise magnesium sulfate.

120. The method of any one of claims 1 to 119, wherein the cementitious aggregate composition does not comprise magnesium chloride.

121. The method of any one of claims 1 to 120, wherein the cementitious aggregate composition does not comprise magnesium nitrate.

122. The method of any one of claims 1 to 121, wherein the cementitious aggregate composition does not comprise a phosphate-based accelerant.

123. The method of any one of claims 1 to 122, wherein the cementitious aggregate composition comprises one or more accelerants and the proportion by weight of the one or more accelerants is about 5% to about 145% the proportion of MgO and/or Mg(OH)₂ by weight of the cementitious aggregate composition.

124. The method of claim 123, wherein the proportion by weight of the one or more accelerants is about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145% the proportion of MgO and/or Mg(OH)₂ of the cementitious aggregate composition.

125. The method of any one of claims 1 to 122, wherein the cementitious aggregate composition comprises one or more accelerants and the proportion by weight of the one or more accelerants is about 0.1% to about 30% of the proportion of Mg(OH)₂ and/or MgO by weight of the cementitious aggregate composition.

126. The method of claim 125, wherein the proportion by weight of the one or more accelerants is about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25% of the proportion of Mg(OH)₂ and/or MgO by weight of the cementitious aggregate composition.

127. The method of any one of claims 1-126, wherein a proportion by weight of magnesium chloride is about 5% to about 145% of a proportion by weight of MgO and/or Mg(OH)₂ of the cementitious aggregate composition.

128. The method of claim 127, wherein the proportion by weight of magnesium chloride is about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145% of the proportion by weight of MgO and/or Mg(OH)₂ of the cementitious aggregate composition.

129. The method of any one of claims 1-126, wherein a proportion by weight of magnesium chloride is about 0.1% to about 30% a proportion by weight of MgO and/or Mg(OH)₂ of the cementitious aggregate composition.

130. The method of claim 129, wherein the proportion by weight of magnesium chloride is about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25% the proportion by weight of MgO and/or Mg(OH)₂ of the cementitious aggregate composition.

131. The method of any one of claims 1-130, wherein a proportion by weight of magnesium nitrate is about 5% to about 145% of a proportion by weight of MgO and/or Mg(OH)₂ of the cementitious aggregate composition.

132. The method of claim 131, wherein the proportion by weight of magnesium nitrate is about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145% of the proportion by weight of MgO and/or Mg(OH)₂ of the cementitious aggregate composition.

133. The method of any one of claims 1-130, wherein a proportion by weight of magnesium nitrate is about 0.1% to about 30% a proportion by weight of MgO and/or Mg(OH)₂ of the cementitious aggregate composition.

134. The method of claim 133, wherein the proportion by weight of magnesium nitrate is about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25% the proportion by weight of MgO and/or Mg(OH)₂ of the cementitious aggregate composition.

135. The method of any one of claims 1-134, wherein a proportion by weight of magnesium sulfate is about 5% to about 145% of a proportion by weight of MgO and/or Mg(OH)₂ of the cementitious aggregate composition.

136. The method of claim 135, wherein the proportion by weight of magnesium sulfate is about 5% to about 140%, about 5% to about 135%, about 5% to about 130%, about 5% to about 125%, about 5% to about 120%, about 5% to about 115%, about 5% to about 110%, about 5% to about 105%, about 5% to about 100%, about 5% to about 95%, about 5% to about 90%, about 5% to about 85%, about 5% to about 80%, about 5% to about 75%, about 5% to about 70%, about 5% to about 65%, about 5% to about 60%, about 5% to about 55%, about 5% to about 50%, about 5% to about 45%, about 5% to about 40%, about 5% to about 35%, about 5% to about 30%, about 5% to about 25%, about 5% to about 20%, about 5% to about 15%, about 5% to about 10%, about 10% to about 145%, about 15% to about 145%, about 20% to about 145%, about 25% to about 145%, about 30% to about 145%, about 35% to about 145%, about 40% to about 145%, about 45% to about 145%, about 50% to about 145%, about 55% to about 145%, about 60% to about 145%, about 65% to about 145%, about 70% to about 145%, about 75% to about 145%, about 80% to about 145%, about 85% to about 145%, about 90% to about 145%, about 95% to about 145%, about 100% to about 145%, about 105% to about 145%, about 110% to about 145%, about 115% to about 145%, about 120% to about 145%, about 125% to about 145%, about 130% to about 145%, about 135% to about 145%, about 140% to about 145%, about 65% to about 75%, about 60% to about 80%, about 55% to about 85%, about 50% to about 90%, about 45% to about 95%, about 40% to about 100%, about 35% to about 105%, about 30% to about 110%, about 25% to about 115%, about 20% to about 120%, about 15% to about 125%, about 10% to about 130%, about 15% to about 50%, about 80% to about 120%, about 70% to about 120%, or about 80% to about 145% of the proportion by weight of MgO and/or Mg(OH)₂ of the cementitious aggregate composition.

137. The method of any one of claims 1-134, wherein a proportion by weight of magnesium sulfate is about 0.1% to about 30% a proportion by weight of MgO and/or Mg(OH)₂ of the cementitious aggregate composition.

138. The method of claim 137, wherein the proportion by weight of magnesium sulfate is about 0.1% to about 30%, about 0.5% to about 30%, about 1% to about 30%, about 2% to about 30%, about 4% to about 30%, about 6% to about 30%, about 8% to about 30%, about 10% to about 30%, about 15% to about 30%, about 20% to about 30%, about 25% to about 30%, about 0.1% to about 25%, about 0.1% to about 20%, about 0.1% to about 15%, about 0.1% to about 10%, about 0.1% to about 8%, about 0.1% to about 6%, about 0.1% to about 4%, about 0.1% to about 2%, about 0.1% to about 1%, about 0.1% to about 0.5%, about 6% to about 10%, about 4% to about 15%, about 2% to about 20%, or about 1% to about 25% the proportion by weight of MgO and/or Mg(OH)₂ of the cementitious aggregate composition.

139. The method of any one of claims 1-137, wherein a proportion by weight of a phosphate-based accelerant is 0.1% to 5% of a proportion of MgO by weight of the cementitious aggregate composition.

140. The method of claim 139, wherein a proportion by weight of the phosphate-based accelerant is 0.5%-5%, 1-5%, 1.5%-5%, 2%-5%, 2%-4.5%, 2%-4%, 2%-3.5%, 2.5%-5%, 2.5-4.5%, 2.5%-4%, 2.5%-3.5%, 2.5%-3%, 3%-3.5%, 3%-5%, or 4%-5% of the proportion of MgO by weight of the cementitious aggregate composition.

141. The method of any one of claims 1-140, wherein the cementitious aggregate composition comprises one or more accelerants, and wherein the one or more accelerants comprise a phosphate-based accelerant that is sodium hexametaphosphate.

142. The method of any one of claims 1-140, wherein the cementitious aggregate composition one or more accelerants, and wherein the one or more accelerants comprise a phosphate-based accelerant selected from sodium hexametaphosphate, any other alkali metal phosphates, and phosphoric acid.

143. A cementitious aggregate composition obtained by the method of any one of claims 1 to 142.

144. A method for providing substrate for aquatic flora and/or fauna attachment, the method comprising depositing the cementitious aggregate composition of claim 143 into a natural or artificial body of water which comprises aquatic flora and/or fauna in need of an attachment.

145. A shaped cementitious composition obtained by the method of any one of claims 1 to 142.

146. The shaped cementitious composition of claim 145, wherein the shape of the shaped cementitious composition is any shape capable of providing a substrate for aquatic flora and/or fauna attachment.

147. The shaped cementitious composition of claim 145 or claim 146, wherein the shape is planar, circular, rounded, elongated, flat, rectangular, or any combination thereof.

148. The shaped cementitious composition of any one of claims 145 to 147, wherein the shape is pyramidal with closed surfaces.

149. The shaped cementitious composition of any one of claims 145 to 148, wherein the shape is pyramidal with open surfaces such that the shape comprises four bars or cylinders that form a square base and four bars or cylinders each originating at a corner of the square and converging to form the pyramid's apex.

150. The shaped cementitious composition of any one of claims 145 to 149, wherein the shaped cementitious composition comprises gaps between particles of the aggregate such that the shaped cementitious composition has a more porous surface, is more porous throughout its volume, and is less dense than a standard cement.

151. The shaped cementitious composition of claim 150, wherein the gaps of the shaped cementitious composition may be up to 500 nm in diameter.

152. The shaped cementitious composition of claim 145 or claim 151, wherein the shaped cementitious composition has up to 85% of the volume being void (e.g., the sum of all gaps) whereas a standard cement may have about 40% of the volume being void.

153. A method for providing substrate for aquatic flora and/or fauna attachment, the method comprising depositing the shaped cementitious composition of claim 145 into a natural or artificial body of water which comprises aquatic flora and/or fauna in need of an attachment.
